(19) United States
(12) Patent Application Publication
(10) Pub. No.: US 2003/0149578 A1
(43) Pub. Date: Aug. 7, 2003

(54) Intelligent procurement agent

(75) Inventor: Yek-Meng Wong, Singapore (SG)

Correspondence Address: SUGHRUE MION, PLLC, 2100 PENNSYLVANIA AVENUE, N.W., WASHINGTON, DC, 20037, US

(73) Assignee: VIENTITY PRIVATE LIMITED

(21) Appl. No.: 10/157,989

(22) Filed: May 31, 2002

Related U.S. Application Data
(60) Provisional application No. 60/294,564, filed on Jun. 1, 2001.

(51) Int. Cl. G06F 17/60

(52) U.S. Cl. 705/1

(57) ABSTRACT

A system for managing a supply of a good based on a request for the good includes a decision support module that evaluates the request against a plurality of indicators. The decision support system also determines whether the request involves an exception in accordance with exception data. The system further includes an execution module that receives the determination from the decision support module, triggers an action that is corrective and generates an interactive output. The exception is incorporated into the exception data if the exception is of a new type, and the exception data is modified if the exception is not of the new type and has changed, to dynamically adjust the at least one of the indicators in real-time. As a result, the exception is processed and corrected to prevent interruptions in the supply chain.

### BACKGROUND OF THE INVENTION

1. Field of the Invention

The present invention relates to a system that manages exceptions to normal operating situations in procurement of supplies. More specifically, the present invention applies a decision support system to determine whether a supply request involves an exception event, and then employs an execution system to perform a corresponding action based on exception event data.

2. Background of the Related Art

In the related art, software solutions deliver resource planning, workflow automation, decision support and business collaboration within the supply chain. However, these related art systems deliver quantitative recommendations without properly considering the risks associated with supply management. For example, but not by way of limitation, risks such as imbalanced market conditions, a deteriorating relationship with suppliers or over-extended supply pipeline that affect the reliability of supply, are not considered in the computations performed in the related art system.

Various related art systems focus on event-triggered problem detection and recommendation. When supply issues are encountered, this related art system alerts users and activates predefined problem resolution processes. However, the related art systems are not adaptive and closed loop (i.e., they do not provide for feedback). Further, there is no related art system that detects and resolves problems according to type of commodity or the changing state of an exception event (i.e., an event that requires a corrective action due to a corresponding condition in the procurement process, as detailed below).

While collaboration has been touted in the related art as the preferred method of problem resolution, there are limitations in its effectiveness. For example, but not by way of limitation, the collaborative approach cannot resolve conflicting priorities or mismatches in supply and demand.

FIG. 1 illustrates the related art process for managing an exception to the normal procurement process. In this case, the exception is a supply shortage. In a first step S1, the shortage report is read by a buyer (i.e., after the shortage has occurred). Next, at step S2, the impact of the shortage is evaluated, and at step S3, the supplier is queried for additional procurement. At step S4, the user then monitors responses from the supplier based on the query of step S3.

At step S5, it is determined whether the response received from the supplier is acceptable. If so, the process is completed as the shortage is overcome, and no further analysis is conducted to prevent such an event in the future. However, if the supplier's response is not acceptable, then in step S6, other solutions are formulated. For example, the possibility of using other suppliers is considered. Other suppliers are contacted at step S7, and the responses from the other suppliers are monitored in step S8.

If the other suppliers provide acceptable responses to the shortage, as determined at step S9, the process is completed. However, if these responses are not acceptable, and the shortage cannot be corrected within the required constraints (e.g., time, money), then at step S10, the causes of the shortage are analyzed, and at step S11, the production and management teams are informed that they will have to alter their processes due to a failure in the supply chain.

The related art process illustrated in FIG. 1 is conducted in a sequential manner, and further, this process is conducted along with the management activities at the commodity unit level, which are voluminous, as each product or finished good may include hundreds or thousands or more of different unit level components (e.g., resistors). As a result, the voluminous unit-level part responsibilities assigned to each purchaser of a component overwhelms even the most experienced purchasers and their related art procurement systems, as the supply chain becomes more volatile and unpredictable.

As a result, it is a problem of the related art that existing supply chain software solutions do not focus on retaining procurement knowledge, such as problem management considerations and activities. Further, the related art solutions do not resolve human related issues such as lost of procurement experience or occurrences of human error.

The related art system and method focuses primarily on sharing information and automating transactions. For example, but not by way of limitation, for a trained practitioner managing the exception events, there are no consistent and repeatable processes. The related art approach depends disparate and non-integrated system-generated reports to detect specific problems. Also, the evaluation methods deployed in the report are static and limited to a fixed collection of key performance indicators (KPI), regardless of changing external environment.

Therefore, the related art approach has various problems and disadvantages. For example, but not by way of limitation, data used in the related art is typically based on a ‘snapshot’ of current and future information, and is not extracted and applied in a standardized manner. Further, there is an inconsistency in the amount of data that are used in each time frame, thus resulting in non-standardized solutions to the exceptions to normal supply procurement.

Additionally, the related art methods of evaluating and managing procurement are typically standard across all type of commodities, regardless of the environmental conditions. Despite the different commodity characteristics (e.g., semi-conductor component versus stamped metal part), and regardless of whether market conditions are over or under capacity, the related art evaluation methods cannot be varied to incorporate the effects of the above-mentioned changes in the procurement environment.

Further, as a result of the inability to adapt to varying conditions in the procurement environment, and as illustrated in FIG. 1 and discussed above, the related art process applies a sequential process. As a result, problem detection and execution (i.e., taking corrective action) is non-standardized and substantially dependent on the experience, knowledge and approaches of the manager or user of the related system. Further, the related art system does not provide any method of creating, storing and updating data on exception events, and applying that data based on the procurement conditions, in real-time.

Therefore, there is an unmet need in the related art for an adaptive system that differentiates the type of commodity and severity of a problem prior to resolution. In addition, an adaptive system would monitor and administer further corrective actions when the problematic situation degrades and/or does not improve.

### SUMMARY OF THE PRESENT INVENTION

It is an object of the present invention to overcome the aforementioned problems and advantages of the related art system.

It is another object of the present invention to provide a framework of data extraction, analysis, action trigger and response in the software architecture to effectively manage exceptions in the goods procurement process.

It is another object of the present invention to provide a user interface that engages the Monitor-Analyze-Act framework to report events, to activate actions, and to customize rules and logic.

It is yet another object of the present invention to provide a system that emulates the intelligence and administrative capabilities of an experienced procurement/purchasing officer, and cascades management goals to individual part level to facilitate control.

It is also an object of the present invention to track performance with reference to management goals as defined by parent product demand signals and life cycle.

It is also an object of the present invention to enable real-time customization based on commodity type, and to incorporate adaptive capabilities in the present invention to read and apply the appropriate logic and actions by commodity type and situation.

It is also an object of the present invention to provide problem resolution capabilities in the form of action modules that can be activated to resolve an identified problem, and to ensure real-time management intervention based on feedback from management of the exception.

It is a further object of the present invention to allow the user to specify data and access rights that limits the data use for a specific function or part association.

It is still another object of the present invention to operate in an interactive and dynamic environment, providing multi-channel information notification to all users.

To achieve at least the above objects, a system for managing a supply of a good based on a request for said good, comprising a decision support module that evaluates said request against a plurality of indicators and determines whether said request involves an exception that is indicative of a procurement problem in accordance with exception data, and an execution module that, if said request involves said exception, receives said determination from said decision support module, triggers an action that is configured to correct said exception and generates an interactive output to an external entity, wherein said exception is incorporated into said exception data if said exception is of a new type, and said exception data is modified if said exception is not of said new type and has changed, to adjust said exception data in real-time to incorporate said exception.

Additionally, a method for managing a supply of a good based on a request for the good is also provided, including the steps of (a) evaluating said request against a plurality of indicators and determining whether said request involves an exception, said exception being indicative of a procurement problem, in accordance with exception data, in a decision support module, (b) if said request involves an exception, receiving said determination from said decision support module, triggering an action that is configured to resolve that exception, and generating an interactive output to an external entity, in an execution module, and (c) incorporating said exception into said exception data if said exception is of a new type and modifying said exception data if said exception is not of said new type and has changed, to adjust said exception data in real-time.

Further, a computer program product for enabling a computer to operate is provided, the computer program product including software instructions for enabling the computer to perform predetermined operations, and a computer readable medium bearing the software instructions. More specifically, the predetermined operations comprise the steps of (a) evaluating said request against a plurality of indicators and determining whether said request involves an exception, said exception being indicative of a procurement problem, in accordance with exception data, in a decision support module, (b) if said request involves said exception, receiving said determination from said decision support module, triggering an action that is configured to correct said exception, and generating an interactive output to an external entity, in an execution module, and (c) incorporating said exception into said exception data if said exception is of a new type and modifying said exception data if said exception is not of said new type and has changed, to adjust said exception data in real-time.

Also, a system for managing a supply of a good based on a request for the good is provided, the system including means for evaluating said request against a plurality of indicators and determining whether said request involves an exception that is indicative of a procurement problem in accordance with exception data, and means for receiving said determination from said decision support module, triggering an action that is configured to resolve said exception and generating an interactive messaging means to an external entity, wherein said exception is incorporated into said exception data if said exception is of a new type, and said exception data is modified if said exception is not of said new type and has changed, to adjust said exception data in real-time.

### BRIEF DESCRIPTION OF THE FIGURES

The accompanying drawings, which are included to provide a further understanding of preferred embodiments of the present invention and are incorporated in and constitute a part of this specification, illustrate embodiments of the invention and together with the description serve to explain the principles of the drawings.

FIG. 1 illustrates a related art process for managing a supply shortage;

FIG. 2 illustrates an architecture of an exemplary embodiment of the system of the present invention;

FIGS. 3(a) and 3(b) illustrate a process flowchart of the method according to an exemplary description of the present invention;

FIG. 4 illustrates a process flowchart of an event categorization phase of the method according to the exemplary description of the present invention;

FIG. 5 illustrates a process flowchart of an adaptive execution phase of the method according to the exemplary description of the present invention;

FIG. 6 illustrates data flow of the rules and logic metadata according to an exemplary description of the present invention;

FIG. 7 illustrates an exemplary description of a correction of a supply shortage according to the present invention;

FIG. 8 illustrates an exemplary description of a correction of an excess supply according to the present invention;

FIGS. 9(a) and 9(b) illustrate a calculation of ongoing and EOL (End of Life) obsolescence calculation according to an exemplary description of the present invention;

FIG. 10 illustrates a response agent process in an exemplary description of the present invention;

FIG. 11 illustrates a quality agent process in an exemplary description of the present invention; and

FIG. 12 illustrates an exemplary embodiment of a networked system according to the present invention.

### DETAILED DESCRIPTION OF THE PRESENT INVENTION

Reference will now be made in detail to the preferred embodiment of the present invention, examples of which are illustrated in the accompanying drawings. In the present invention, the terms are meant to have the definition provided in the specification, and are otherwise not limited by the specification. Further, advantages of these and the stated objects reside in the details of construction and operation as more fully hereinafter described and claimed, reference being made to the accompanying drawings forming a part hereof, wherein like numerals refer to like parts throughout.

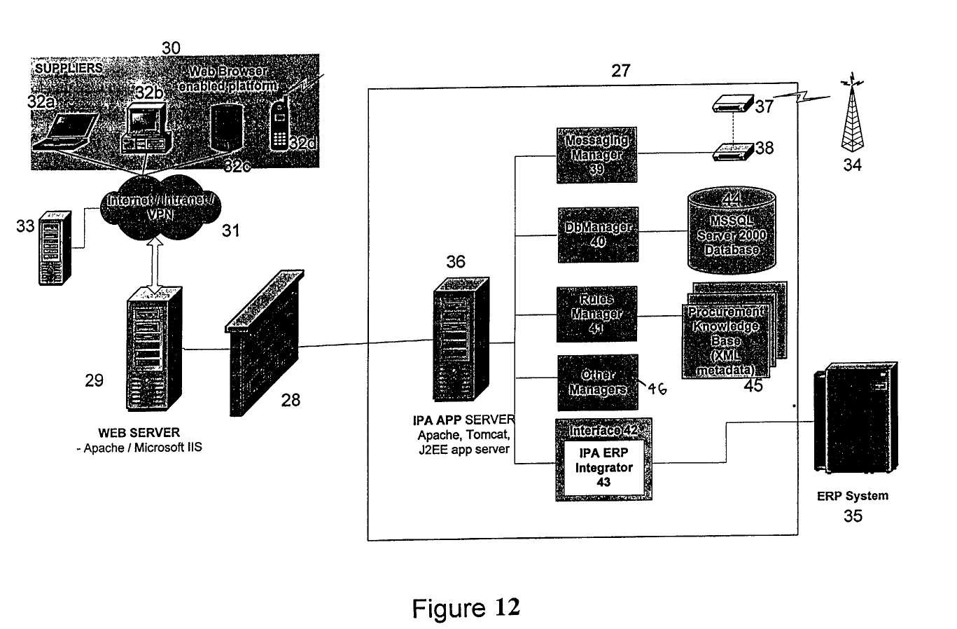

The present includes an intelligent procurement agent (IPA) that analyzes data hosted by back-end office systems, including (but not limited to) Enterprise Resource Planning (ERP), to expose selected information to the trading parties. A networked implementation of the present invention is illustrated in FIG. 12, as described below. The present invention uses web based messaging with hosted content as the current system of communication in the exemplary embodiment. However, the present invention is not limited thereto, and other communication systems may also be employed. In the communication (i.e., engagement) process, the IPA deploys intelligent business decision tools to increase the success rate of problem (i.e., exception) resolution. For example, but not by way of limitation, the IPA deploys a singular track of corrective action to solve a problem, while concurrently triggering multiple corrective actions to reduce the likelihood of other (e.g., high risk or complicated) problems. Further, the IPA processes exception events using methods disclosed in greater detail below to manage procurement situations that would require additional analysis and decision-making in the related art.

The IPA according to the present invention also creates a system that encapsulates domain knowledge (i.e., the knowledge of managing exception events) with the ability to deploy appropriate corrective actions in the form of interactive messaging with external entities such as suppliers. Further, the IPA can alter its evaluation criteria by analyzing changes in commodity (i.e., internal characteristics) and environmental conditions (i.e., external influential factors) to support decision making.

The database of the present invention is built around the individual commodity type (e.g., water pump as a type of commodity), where the lowest denominator of the commodity type is a unique part (e.g., a resistor or a screw). Each commodity type possesses unique rules and logic for different supply situation such as shortage, excess or risky in various market conditions. The aggregate of the customized system for all commodity types forms the basis of a commodity knowledge repository. In the present invention, the terms “commodity” and “good” or “goods” are used interchangably.

The IPA of the present invention also performs evaluation of multiple key performance indicators (KPIs) across different time periods, including (but not limited to) direct (e.g., quantitative) and indirect (e.g., qualitative) components. The different time periods may include past, current and future, such that the IPA can perform forecasting of future events, management of present events, and incorporation of analysis of past events to improve the accuracy of managing the exceptions. The approach of the present invention is to deploy a forward-looking solution instead of the related art discrete instant fixes. The forward-looking solution smoothens the fluctuation as future considerations are taken in the computation. On the other hand, the related art discrete fixes disregard future implications.

For example, but not by way of limitation, in the case of Assurance of Supply (AOS), the direct Multi-KPIs include, but are not limited to, supply and demand quantities, magnitude of forecast change within the lead-time (or commitment) window, magnitude of historical demand change within the lead-time window, and/or buffer inventory. The indirect multi-KPI includes, but is not limited to, information on the historical support level of supplier, market supply conditions (e.g., excessive or shortage conditions), balance of buyer power versus seller power, and the relationship between people in the buying and selling organization.

The IPA of the present invention employs a first group of the KPIs to categorize the environment, and then uses a second group of the KPIs to further analyze conditions and to assign risk. A plurality of agents, as described in greater detail below, perform a series of operations to select KPIs based on the exception and/or categorization as determined by the present invention. Additionally, the method of the present invention applies business logic rules, as discussed in greater detail below, to deploy appropriate actions to pre-empt risk.

Once the categorization has been performed, the present invention deploys actions that are selected based on business rules (e.g., the interactive output). As a result, the present invention is capable of reassessing influential factors and risk based on responses from the interacting parties that receive the interactive message.

As a result, the present invention provides a framework for multi-stage determination of the type of problem in the procurement process and categorization of the problem type based on various rules stored in a rule processor, followed by execution of actions designed to alleviate the identified category of problems. Because the process is multi-stage (i.e. iterative), the present invention is unique to particular sets of characteristics and situations. The processing of the exception events is incorporated into a knowledge base (i.e., a set of rules, from which a subset of rules are selected, depending on the specific type of commodity and category of exception). The present invention can process many such problems (i.e., exception events) simultaneously, and uses a database containing stored data to recognize similar types of problems, and take corrective action whenever a similar situation is encountered, and in real-time.

The IPA architecture includes an adaptive decision support system and an execution engine, which can be executed as software in a processor at a manufacturing facility, which utilize quantitative and Boolean analysis routines to detect and resolve various categories of exception events. Additionally, unique sets of rules and logic are provided in the present invention for different category of exceptions, along with a collection of functional managers and a library of corrective actions, which can be embodied as routines in software and/or hardware at a manufacturing facility, but are not limited thereto.

The library of corrective actions may be stored in a database, rule base and/or a similar processor. To support the above-described exception management process, the present invention determines the appropriate matching set of rules and logic based on commodity type and situation specific data. Additionally, the present invention enables user to customize, scale or upgrade the rules and logic and/or action library.

FIG. 12 is described below. While the present invention includes an exemplary description in a system and a method, the present invention is not limited thereto. For example, but not by way of limitation, the present invention can include a physical infrastructure, as illustrated in FIG. 12. The IPA may be located in any manufacturing facility, such as a factory, a packaging plant, or an assembly plant. However, the present invention is not limited thereto.

The IPA is located in a server box 27. The IPA communicates with a vendor 30 that is remotely located, as represented by a barrier 28, and that communicates with a webserver 29 (e.g., Apache/Microsoft IIS) via a network 31 (e.g., Internet, Intranet, or Virtual Private Network (VPN)). The vendor 30 may communicate with the network 31 by one of a plurality of communication devices, including, but not limited to, a portable computing device 32a (e.g., laptop), a stationary computing device 32b (e.g., personal computer), a hand-held personal computing device 32c, or a mobile telecommunications device (e.g., mobile phone) 32d.

Additionally, an application service provider (ASP) 33 communicates with the networks 31, and may be a business to business (B2B) ASP, but is not limited thereto. As described in greater detail below, the ISP communicates with the B2B environment through a formatter and a message translator in the IPA.

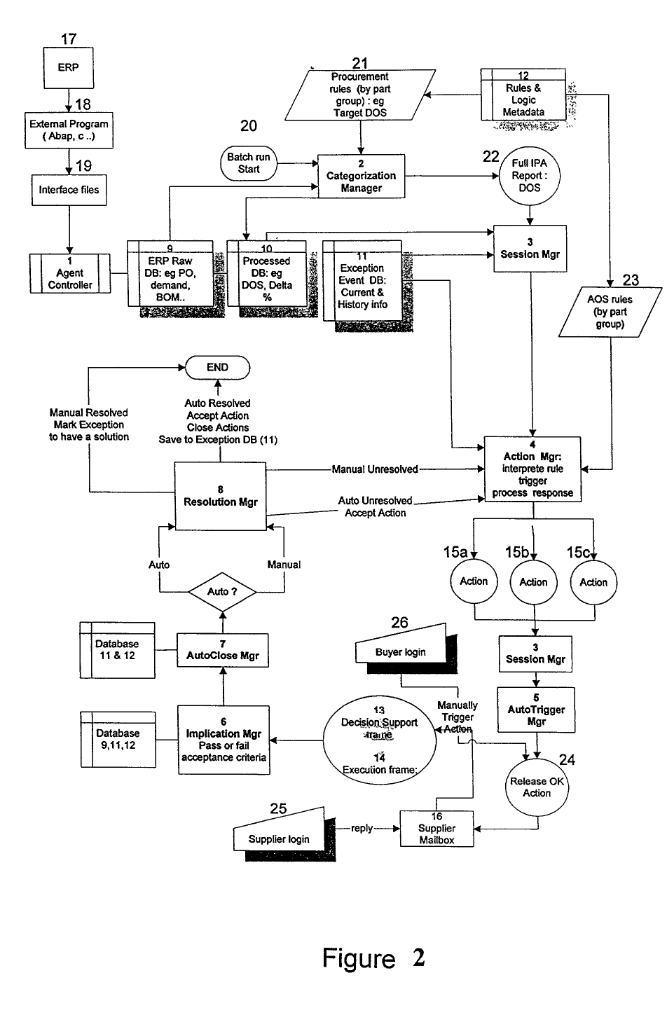

In the present invention, the server box 27 includes an IPA application server (e.g., Apache, Tomcat, J2EE) that is controls operation of the present invention. As discussed below with respect to FIG. 2, several managers 1-8 are operated from the IPA server 36. Further, various agents that perform functions for the managers 1-8 are also included in the IPA server 36.

A messaging manager 39 is attached to the IPA server 36. The messaging manager 39 that sends and receives messages from buyers and/or suppliers (e.g., 30). Therefore, the IPA may communicate wirelessly via a remote wireless communication station 34 (e.g., cellular network) via a modem 37 and/or 38, positioned in the server box 27. The messaging manager 39 is connected to a processor 36 in the IPA 27. The messaging manager 39 performs the communication of the interactive messages of the present invention. Additional managers 46 may also be included, and connected to the IPA server 36.

The processor 36 is also commonly connected to a database manager 40, which is connected to a database 44 (e.g., MSSQL Server 2000 Database), and a rules manager 41 that is connected to a procurement knowledge base 45. The database manager 40 stores the data and performs the data processing for the ERP raw data database 9, the processed data database 10 and the exception event database 11, described in greater detail below.

For example, but not by way of limitation, the procurement knowledge base 45 may include XML metadata. The rules manager 41 provides the rules and logic metadata 12 and the AOS rules 23, as well as other rules of the present invention, described in greater detail below.

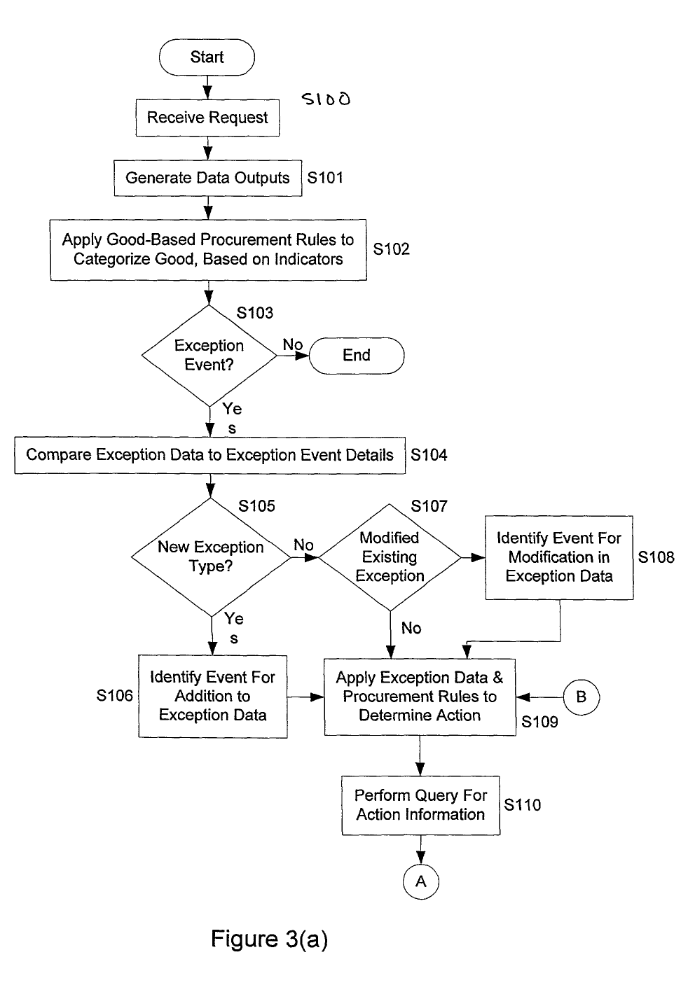

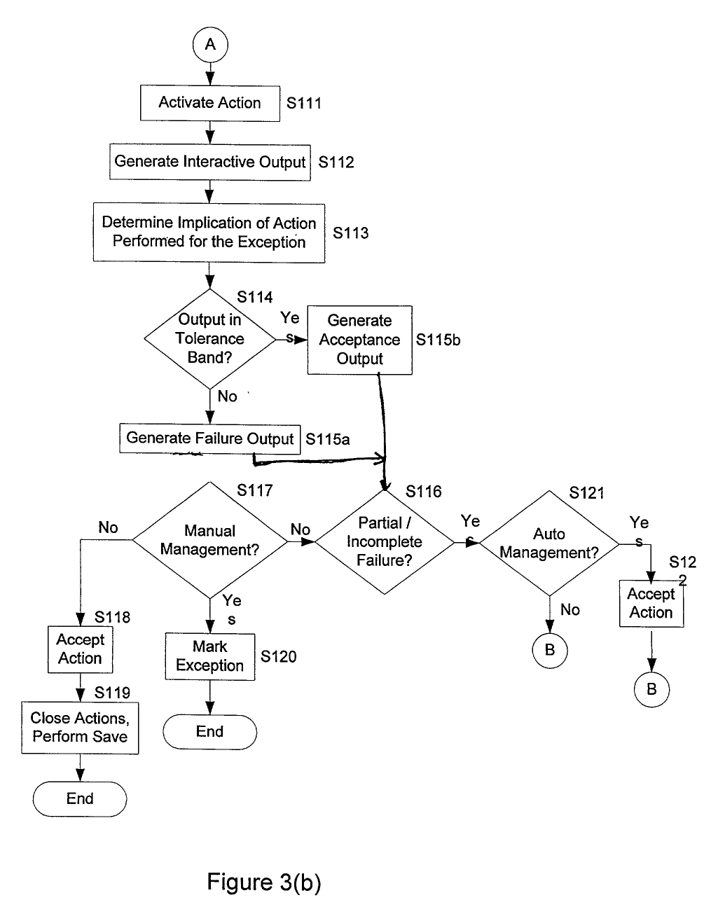

The processor 36, the database manager 39 and rules manager 41 are also commonly connected to an interface 42 that includes an IPA ERP integrator 43. The interface is connected to an ERP system 35, and can be used by a user at the manufacturing facility. The IPA ERP integrator 43 may be embodied as a software program and extract data received from the ERP system 35, or a program in a hardware medium (e.g., EEPROM). The processor 36 may be used by the IPA ERP integrator 43 to operate the various managers of the present invention, described in greater detail below. Further, the software may be stored on a computer readable medium, and include instructions to perform the steps illustrated in FIGS. 3(a) and 3(b).

With respect to the ASP 33, while the underlying application server such as weblogic or websphere provides for connectivity to B2Bs, in the present invention, the IPA sends appropriate action messages to the B2B environment 33. Further, the web server 29 supports various aspects of the connectivity issue. Amongst the key features key are:

1. Actual connection layer

2. Business Protocols (support for xocp, rosettanet, cxml, ebxml)

3. Messaging APIs

4. Transaction Management

5. Security

6. Configuration models (P2P, Hub and Spoke)

The IPA contains a message formatting component that is capable of mapping actions generated with a relevant B2B compliant process message. IPA also contains a listener to enable the system to understand and translate incoming messages as well.

FIG. 2 illustrates the system architecture of the above-described present invention. The adaptive decision support system of the present invention includes an agent controller 1 (i.e., extractor component) that receives a request, and generates an output to the database manager 39 that includes a series of databases, stored on a data server. The agent controller 1 is a series of steps that may be stored in a computer readable medium of a processor, either as hardware or software. In the present invention, the agent controller 1 may receive the request from the ERP 17 (Enterprise Resource Planner).

The ERP 17 is a planning program for a manufacturing facility that performs resource management. For example, but not by way of limitation, the ERP 17 may determine that due to additional output required by a buyer, production needs to be increased at a manufacturing facility. As a result, additional supplies may be required from a supplier. To procure the required goods from the supplier, the ERP 17 generates a request to the IPA. The request from the ERP 17 is received and extracted by an external program 18. The data extraction is performed to place the data in a format readable by the IPA. The external program 18 then forwards the extracted information to at least one interface file 19. At this point, the data has been extracted, but has not been processed. Therefore, the IPA receives raw ERP data that has been extracted.

The data module includes an ERP raw data database 9, a processed data database 10 and an exception event database 11. The ERP raw database 9 stores the extracted ERP data, as well as data regarding various other external supply chain information sources. For example, but not by way of limitation, the ERP raw data database 9 may store purchase order (PO), demand, or Bill of Material (BOM) information.

The processed data database 10 stores data processed by the present invention, as described in greater detail below. For example, but no by way of limitation, the processed data database 10 may store information on remaining days of supply (DOS) or a difference between the target DOS and the actual remaining supply (i.e., delta % of DOS). Additionally, the exception event database 11 stores all current and historical corrective action details for the entire life cycle of the exception management process (i.e., initiation to closure of the exception event).

Additionally, the rules manager 41 includes rules and logic metadata 12, which provides situational procurement knowledge to activate and close appropriate corrective actions, as well as various rule bases (i.e., systems for storing rules in a manner analogous to storage of data in a database). The rules module manages the rules and logic metadata 12, which is used by a procurement rule base 21, and an Assurance of Supply (AOS) rule base 23, which contains rules to assure that supplies from vendors are maintained, as explained in greater detail below. For example, but not by way of limitation, the AOS rule base may include a rule that, when applied based on the type of good and category of exception, requires that a specific corrective action be chosen and implemented.

The above-described data manager 39 and rule manager 41 provide data and rules, respectively, to a categorization manager 2 that receives the extracted ERP raw data from the ERP raw data database 9. The categorization manager 2 applies procurement rules on the extracted ERP data to segregate the data by exception categories. More specifically, in accordance with a command signal (e.g., a batch run start command 20) that may be issued manually by a user or automatically on a timed, periodic interval as a batch process by a processor, the categorization manager 2 applies the rules from the procurement rules base 21 to the ERP raw data. Accordingly, indicators (e.g., type of good and environmental/external factors) are used by the categorization manager 2 to process the data and provide processed data to the processed data database 10. Examples of the processed data are provided in greater detail below.

The categorization manager 2 also generates a categorization output that identifies the goods based on a category of exception, such as a supply shortage or excess inventory for a particular good. A full IPA report is produced by a reporting function 22 based on the categorization output. The reports may be used to assess performance of vendors, reveal bottlenecks in the manufacturing process, or perform additional analysis (e.g., forecasting of supply requirements during peak and low demand periods).

A session manager 3 uses the full IPA report, along with data from the processed data database 10 and the exception event database 11. The session manager 3 ensures logical administration of corrective actions without duplicating efforts. Based on that information, the session manager 3 compares the IPA report 22 and the exception event database 11 and determines whether the current exception is of a new type. For example, the session manager 3 may determine whether an excess in supply of a good due to decreased demand or extra delivery from a vendor has been previously encountered for that good and stored in the exception event database 11.

If the exception is a new exception that has not been previously stored in the exception event database 11, the session manager 3 identifies the exception category to be added to the exception event database 11 once the exception event has been corrected by a corrective action, as discussed below. The session manager 3 generates a first output to an action manager 4 and a second output to an auto trigger manager 5, as described in greater detail below.

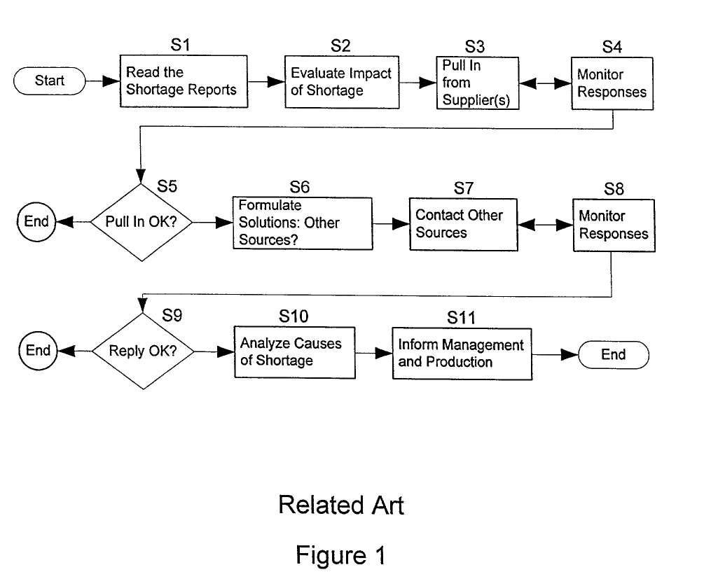

The foregoing description of FIG. 1 includes, but does not limit, the description of the features of the adaptive decision support system. However, the present invention is not limited to that structure, and may be modified. For example, but not by way of limitation, the session manager 3 may be positioned in the adaptive decision support system, the execution module, or therebetween.

Further, the execution module receives the determination of the above-described decision support module, and generates an interactive output. Further, as described below, the resolution manager 8 of the execution module modifies data in the exception event database 11 if the execution event has changed from its previous incorporation in the exception event database 11, or if the data is new and has not been incorporated into the exception event database 11. Because multiple events can be processed concurrently, the adjustment of the exception event database 11 can occur in real time. Further, because the IPA can handle many exceptions simultaneously, the KPIs can be adjusted in real time. Additional details of the execution module are described in greater detail below, but are not limited thereto.

The action manager 4 receives an output generated by the session manager 3 (i.e., the determination from the decision support module) based on the foregoing comparison, as well as data from the exception event database (i.e., exception data) and rules from the Assurance of Supply (AOS) rule base 23. As noted above, the rules in the AOS rule base 23, which is a part of the rule module, can be sorted by part type. The action manager 4 uses the foregoing data inputs and exception category to interpret the rule base and determine a corrective action to be taken. Because the IPA operates in a multi-cycle (i.e., iterative) manner, the if the corrective action does not resolve the exception event on a first iteration, then the process may be repeated several time, with different actions being taken each time. For example, but not by way of limitation, when a vendor is late in delivery the first time, the action may involve a reminder, whereas on subsequent occurrences of tardiness, the action may involve a warning, searching for additional vendors, or even switching vendors. Various action module details are discussed in greater detail below.

The action determined by the action manager 4 is sent to a plurality of action libraries 15a . . . 15n, that match the identified exception with a corrective action. The session manager 3 then receives an input that correlates the rule with the exception from the one of the action libraries 15a . . . 15n, and the corrective action is identified for storage in the data module, for use with future exceptions. Thus, the exception event is incorporated into the IPA for all current and future exception events to be processed.

The session manager 3 also removes redundant actions. For example, if an exception is already being processed, the session manager 3 prevents that same exception from being entered into the IPA a second time for corrective action. For example, but not by way of limitation, if the exception involves excess supply and vendors have been notified to reduce the subsequent delivery as a corrective action, then the session manager 3 ensures that the excess does not re-enter the IPA as a new, previously unprocessed event. In this case, the session manager 3 would prevent the vendor from receiving duplicate messages for the same surplus of supply, thus preventing confusion as to whether the second message was redundant or a request for a second reduction in delivery.

After the redundancy check, the results (i.e., the second output of the session manager 3) are submitted to the auto trigger manager 5, as described below. The auto trigger manager 5 activates the action and generates the above-described interactive output, and ensures that all automatically triggered corrective actions belonging to a given part are activated without further human intervention. An action release 24 is generated, and the action is completed. For example, but not by way of limitation, if a vendor is late in delivery, the action may be to remind or warn the vendor or the tardy delivery via an interaction message (e.g., “We have not yet received your delivery of bolts scheduled for Jan. 1, 2000. Please confirm whether this delivery has been initiated.”), and then await a response from the vendor. Alternatively, the action release 24 may be triggered manually, based on a buyer login 26, instead of automatically from the auto trigger 5.

Once the action has occurred and the interactive message is sent e.g., to a supplier mailbox 16, the recipient 25 of the message can login and reply. Then, in accordance with a decision support frame 13 and an execution frame 14, which are described in greater detail below, an implication manager 6 receives an input depending on the action chosen (e.g., message from vendor indicating that delivery will arrive one day later than scheduled).

The implication manager 6 then determines whether the implications of the corrective action have been conducted in accordance with the procurement rules applied to choose the action for the exception, wherein the procurement rules define at least one band of tolerance that is specific to the category of the execution event. The implication manager 6 evaluates collective impact of acknowledged corrective actions, and can reactivate the action manager 4, via the auto close manager 7 and the resolution manager 8, if the exception remained unresolved.

Accordingly, the implication manager 6 generates an output that is indicative of whether the action has results within the tolerance band. For example, a tolerance band may be whether a shipment of supplies will arrive from a vendor within a certain amount of time, such as two to four hours. If more than four hours is requires, then the results are outside of the tolerance band.

An auto close manager 7 then receives the output of the implication manager 6, and determines whether a resolution action is required. The auto close manager 7 channels ‘accepted’ outputs (i.e., the corrective action resolved the problem identified in the exception) from the implication manager 6 to the resolution manager 8. All ‘failed’ outputs (i.e., the corrective action did not resolve the problem identified in the exception) are subsequently forwarded to the action manager 4 for additional corrective attention. The auto close manager 7 then generates an auto close message, which is output to a resolution manager 8. The resolution manager 8 confirms acceptance for corrective actions that have been accepted (i.e., are appropriate), and terminates all unselected acknowledged, not acknowledged or not triggered corrective actions.

The resolution manager 8 receives the auto close message, and performs an appropriate task to complete the exception event processing (i.e., to close the event). If the process has been manually triggered and has failed, then the action manager 4 is reactivated for additional processing (e.g., more corrective action is required). Because no action has yet been determined by the action manager 4 due to the manual nature of the trigger (i.e., buyer login 26), there is no need for the resolution manager 8 to accept any action, and the action manager 4 is thus activated without assistance from the resolution manager 8.

However, if the process was triggered by the auto trigger manager 5 and has failed, the resolution manager 8 accepts the action as having been completed (which prevents the action from being repeated on the second iteration of the process), and then reactivates the action manager 4 for further processing to manage the exception event.

If the exception event is resolved based on the action triggered by the auto trigger manager 5, then the resolution manager 8 accepts the action, and closes actions for the exception event. Additionally, the exception event data is saved into the exception event database 11, so that if a similar exception event occurs, the IPA will be able to use previous exception event information to improve the accuracy of exception event processing, and choose more effective corrective actions based on past performance. If the exception event is resolved successfully based on a manually triggered process, then the exception event is marked as having been solved.

Additional details of the above-described components are described below. The agent controller 1, which synchronizes the behavior and events based on the received inputs to the IPA (i.e., the agent controller 1 processes the request from the ERP 17), stores that enables a good-based management of events. When the IPA is run, the agent controller 1 manages the process flow from an agent-specific calculation of KPIs in the categorization manager 2, to the operation of action manager 4. As noted above, the IPA receives an initiation signal (e.g., from the ERP 17 or the batch run start 20), and is driven by the availability of refreshed ERP raw database 9, processed database 10, rules and logic metadata 12.

The ERP Raw database 9 comprises structural information (information such as parent association, qualified vendor, business allocation etc.) and process information (dynamic information related to demand, request acknowledgement, etc.).

A change in any of the above-described modules that would impact on the exception event management scenario would warrant an update by the agent controller 1. For example, but not by way of limitation, a refreshed ERP Raw database 9 might imply that the demand-supply balance of inventory at a factory might have changed, which would be relevant to the management of any exception event based on the exception event database 11, because the resulting required supply would also have changed. Therefore, it would be necessary for the agent controller 1 to perform an update.

The agent controller 1 initiates data input into the ERP raw data database 9, which in turn drives the individual business components (e.g., KPI calculations and action library 15a . . . 15n). The business components (as described in greater detail below) are defined such that they generate synthesized information that is subsequently stored in the processed database 10.

The agent controller 1 operates according to the following algorithm. Initially, all records generated in the agent report from the previous IPA run are archived. Then, for each part requested, e.g., in a Bill of Materials, the following steps are performed. First, the rules and logic metadata 12 is defined by the rules manager 41, based on the requested part. Then, agent-specific KPI computations are performed in the categorization manager 2, followed by initiating the session manager 3. Further, for each exception event processed by the IPA, the action manager 4 is used, and any exception event qualified by the agent-specific action manager 4 as not having any corrective actions that can solve the exception is removed from the final exception report listing, to indicate that none of the actions can correct the exception.

With respect to the categorization manager 2, exception events that have not been previously processed by the IPA (i.e., new exception events) are identified, based on distinct groupings of customizable indicators. For example, each individual part that is derived from the Bill of Materials for a product is subjected to this process as a matter of preliminary identification of a new procurement exception event and filtering process. The categorization process performs an exhaustive methodology for each good to be tagged as an exception event. If an event is not tagged as an exception event, then no further processing is necessary by the IPA (e.g., goods have been delivered, so there is no problem with goods delivery).

The categorization manager 2 receives the unique part identifier (i.e., part number) from the ERP Raw database 9, calculates the relevant KPI specific to the agent used in this categorization process, and receives the procurement rules 21 from the Rules and Logic Metadata 12 specific to the respective part. The part-specific procurement rule from the Rules and Logic Metadata 12 provides an exhaustive list of categories that a part might fall under. Each of these categories are pre-defined by a set of customizable indicators, typically represented in the form of relevant KPIs that are used by agents, as described in greater detail below. The above-mentioned exhaustive list of categories covers the entire range of defined indicators.

As an output, the categorization manager 2 generates a definitive identification of the categorization of a part. This derived information is then used to perform an update (based on the part identifier) of the processed data database 10.

To perform the process in the categorization manager 2, the relevant KPIs are used as a comparative benchmark against the categorization definitions as provided in the categorization manager 2. As an exact match of these KPIs is discovered, the part passes this process, and is definitively identified to be of a specific category.

The session manager 3 operates to ensure consistent management of exception events from the part level. However, an exception event should not be treated as a new exception event in the following and subsequent IPA runs. The session manager 3 receives the unique part identifier and performs categorization of the part for the exception event database 11, as managed by the agent controller 1. Further, with respect to the action library 15a . . . 15n, the session manager 3 provides the part identifier to the exception event database 11, including the identified event and the corrective action administered.

To perform the above-described action, the session manager 3 takes the following steps. To update the exception event database 11, the session manager 3 uses the unique part identifier and categorization identification is used to match against existing records in the exception event database 11. A successful match of both part and categorization identifier indicates that the part is currently being managed by the system, and no further attention by session manager 3 is required.

If a part identifier does not have a corresponding match from exception event database 11, the session manager 3 identifies the part as a record to be stored into the exception event database 11.

With respect to the action library 15, the unique part identifier and message identification is used to match against existing records in exception event database 11. A successful match of both part identifier and message identification would indicate that the part is being managed by the system with this specific message (i.e., action). Therefore, no further action is required by the session manager 3.

If a part identifier and message identification do not have a corresponding match from exception event database 11, the session manager 3 identifies this part as the subject of a new record that should be stored into the exception event database 11.

Additionally, the session manager 3 may perform evaluation and contextual analysis, possibly based on the functionality of implication manager 6, of the content of these matched messages to ensure relevance and consistency. Further, resolution manager 8 may optionally be invoked in certain circumstances to retract an earlier message if an updated version of the message is available in a component of action library 15a . . . 15n, and then send the updated message instead of the previous version of the message.

The action manager 4 derives the correct application of business components specified in action library 15a . . . 15n based on part characteristics. The action manager 4 includes interpretation and processing capabilities of the business rule classification framework mentioned above and described in greater detail below as business rules, and implemented as multi-cycle action rules and logic. The action manager 4 receives information from the exception event database 11, including the identified exception event (e.g., exception identifier, part identifier, cycle identifier), as well as rules and logic metadata 12 specific to the part identifier, which defines the pre-configured multi-cycle action rules and logic. The action manager 4 generates an activation of the relevant business components from action library 15a . . . 15n.

The auto trigger manager 5 provides an automated collaborative communication feature for the present invention. A message generated by action business components from action library 15a . . . 15n is triggered and sent to the session manager 3, and then, via the auto trigger manager 5, to the relevant party/recipients (e.g., suppliers, trading partners, internal business units or individuals). The auto trigger manager 5 receives the part identifier from the exception event database 11, including the identified event and the message to be triggered, as well as rules and logic metadata 12 specific to the part identifier. This input defines the message trigger mechanism permission settings. The auto trigger manager 5 outputs a Boolean type decision as to whether a message is to be triggered to its recipients, and performs a relay of messages to the relevant transport component of the system for extra-system communication (e.g., with suppliers).

The implication manager 6 evaluates the context and implications of an exception event. This component performs its role in the following scenarios: 1) only raw ERP information (e.g., for AOS, Projected Requirement, In-Coming Purchase Orders) and 2) raw ERP information as well as Recommended/WIP/Accepted Corrective Actions specific to the exception event. The application of the implication manager 6 is performed in (but not limited to) the context of cost, availability, responsiveness and quality issues.

As noted above, the implication manager 6 processes the implications of the Exception Event with the business and tolerance rules specified in the system. For example, but not by way of limitation, tolerances handled by the implication manager 6 related to cost (e.g., loss in production due to lack of supplies from a vendor) may be defined in the form of cost targets at component levels, forward looking costs in the form of quotations and projections, historical and current cost performance indicators. As for responsiveness, part lead times are typically used as direct proxies, message response turn around times as well as historical and current responsiveness benchmarks.

The implication manager 6 receives the part identifier, and information from the ERP raw database 9, inputs from the exception event database 11, including the identified event, and rules and logic metadata 12 specific to the part identifier, which defines the acceptable tolerance bands for different agents. This information from the data module may be sent directly, because the implication manager 6 is directly connected to the ERP raw data database 9, the exception event database 11 and the rule and logic metadata unit 12. The implication manager 6 outputs to the auto close manager 7 a Boolean type decision as to whether a message is within the tolerance bands defined as acceptable for the parts and agents that are described in greater detail below.

The auto close manager 7 is invoked on reply of messages (i.e., derived by action library 15a . . . 15n and stored in the exception event database 11) sent out by agents. The auto close manager is an event-based trigger component that monitors change which is relevant to an identified exception event, and manages the decision-making process.

The auto close manager 7 receives the part identifier information directly from the exception event database 11 including the identified event, and rules and logic metadata 12 specific to the part identifier, which defines the closure definition mechanism permission settings. This information is received directly because the autoclose manager is directly connected to the exception event database 11 and the rule and logic metadata unit 12. The auto close manager 7 then outputs a Boolean type decision as to whether a message is to be handled by resolution manager 8. Further, the auto close manager 7 may relay messages to the relevant transport component of the system (not shown), for the purpose of extra-system communication.

The resolution manager 8 functions in tandem with implication manager 6 and auto close manager 7 to achieve a closed loop resolution to an exception event. A closed-loop resolution occurs when successfully resolved exceptions are incorporated into the exception event database 11 for further use, and unsuccessfully resolved exceptions are fed back into the action manager 4 for further processing. Contextually, the messages/corrective actions derive acceptable solutions that contribute to successful validation of the event to defined tolerances as evaluated by implication manager 6.

The inputs that the resolution manager 8 receives, via the auto close manager 7, include the part identifier, information from the exception event database 11 including the identified event, and information from the rules and logic metadata 12 specific to the part identifier, which defines the closure definition mechanism permission settings. The resolution manager 8 may also receive, from the action library 15a . . . 15n, closure type messages for appropriate selection by the resolution manager 8. The resolution manager 8 then outputs outgoing closure messages to relevant recipients.

To perform the above, the resolution manager 8 employs the following steps. For the exception event, the resolution manager 8 receives the analysis outcome of the implication manager 6, and validation of management of the event from the auto close manager 7. Accordingly, the resolution manager 8, determines a suitable closure message for the corrective action message (e.g., “We have now received the requested goods. Thank you for responding to our reminder”), as well as for the rest of the relevant corrective action messages, and sends the closure messages.

The decision support frame 13 presents before correction and after correction scenarios on inventory availability. A user can view the implications of a corrective action and manually adjust the process, via a user interface referred to herein as an implication view. The implication view computes On Hand quantity based on the most current state of primary corrective actions, and allows the user to include or exclude specific corrective actions in the On Hand calculation. In the case of manually controlled parts, the user can activate a decision to hold, accept or terminate a corrective action via the implication view. The implication calculation is based on the following generic, related art equation:

OH_{—}QTY dateN=OH QTY dateN-1−GrossREQT dateN+PO QTY vendorA date N+PO QTY vendorB dateN

Both numerical or graphical presentation modes are available to communicate information.

The implication screen can be forwarded as a HTML attachment to any email account. The implication information (OH calculation) provides an absolute assessment of whether the cumulative corrective responses will resolve the exception event.

The present invention preferably provides core reports that support business decision processes. Some of the preferred forms and reports relevant to the Decision Support Frame 13 include: Exception Status (main) report; Action report, variety of inventory reports (excess, obsolescence).

Additionally, the foregoing features discussed with respect to the system illustrated in FIG. 2 are further discussed with respect to the process illustrated in FIGS. 3(a) and 3(b), below.

FIGS. 3(a) and 3(b) illustrate an exemplary embodiment of a method of managing an exception event according to the present invention. In a first step S100, a request is received, e.g., from a buyer. At step S101, the ERP raw data database 9 and the processed data database 10 are generated.

In step S102, goods-based procurement rules 21, which are received from the rules and logic metadata 12, are applied to categorize the good, based on a plurality of indicators. More specifically, the categorization manager 2 performs categorization based on inputs from the procurement rule base 21 and the ERP raw data database 9. In step S103, it is determined whether the current request is an exception event, as discussed above, requiring further management according to the present invention. If the current request is not an exception, then the exception management process is terminated.

If the current request for goods is an exception event (i.e., requires further processing by the IPA to perform a corrective action to solve a problem in the procurement process), then in step S104, the exception event is compared with exception data. For example, but not by way of limitation, in the session manager 3, data from the exception event database 11 is compared to the full IPA report 22 generated by the categorization manager 2. At step S105, it is determined whether the current exception is a new type of exception.

If the exception is new, then at step S106, the exception is identified for addition to the exception event database 11, and the process proceeds to step S109 as described below. If the exception is not new, it is determined whether the current exception is an existing exception that has been modified at step S107. If the current exception has been modified, then at step S108, the exception is identified to be modified in the exception data by the resolution manager 8, as described herein. The processing then continues at step S109, as described below. If the current exception has not been modified, then the process proceeds directly to step S109, as described below. Because there is no need to modify the exception event database 11 if the current exception has not been modified, the application of the exception data is the next step, and is performed in step S109 as described below.

In step S109, the exception data from the exception event database 11 and the procurement rules (e.g., from the procurement rule base 21 and the AOS rule base 23) are applied to determine an appropriate corrective action (i.e., to be determined by the action manager 4). At step S110, a query is made (e.g., to the action library 15a), for additional details of an action chosen by the action manager 4 based on the exception category and information received from the rules and logic metadata 12 and the exception event database 11. Next, at step S111, the appropriate action is activated, and an output is generated at step S112. More specifically, the auto trigger manager 5 generates the output (i.e., interactive communication).

At step S113, the implication of the action performed to correct the exception event is determined, in the implication manager 6. In step S114, it is determined by the implication manager 6 whether the output of the corrective action is in a prescribed tolerance band that is stored in the implication manager 6. If the output is not within the tolerance band, then a failure message is generated at step S115a by the resolution manager 8, and otherwise, a success message is generated at step S115b, by the resolution manager 8.

Next, at step S116, it is determined whether a failure (partial or complete) has been identified, in the auto close manager 7. If no failure has occurred, then it is determined whether the process is being manually managed by a user at step S117. If the process was automatically initiated using the features of the present invention, then at Step S118, the action is accepted, and at step S119, the action is closed, and as necessary, changes are made to the exception event database 11. If a user has manually initiated the process (e.g., by buyer logic 26), then the exception is marked at complete at step S120. Accordingly, the exception event has been successfully processed.

However, if it is determined at step S116 that a failure has occurred, then it is determined at step S121 whether the process was automatically triggered. If the process was automatically triggered, then at step S122, the resolution manager 8 accepts the action as having been performed, and the process proceeds back to step S109, to reactivate the action manager 4 to further attempt to correct the problem (i.e., resolve the exception event). If the process was not automatically triggered, then step S122 is skipped, and the process continued at step S109, to further attempt to close (i.e., resolve) the exception event. The process continues until the exception event has been determined to be successfully handled (i.e., indicated as resolved by the resolution manager 8).

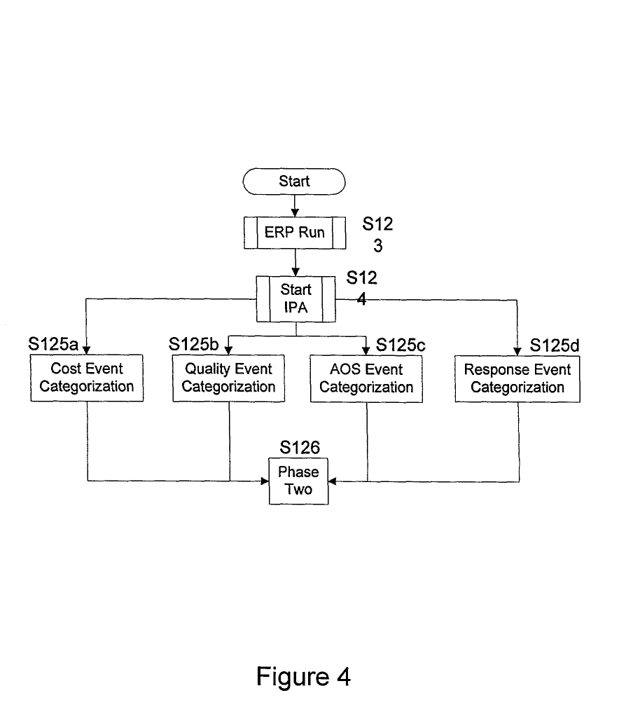

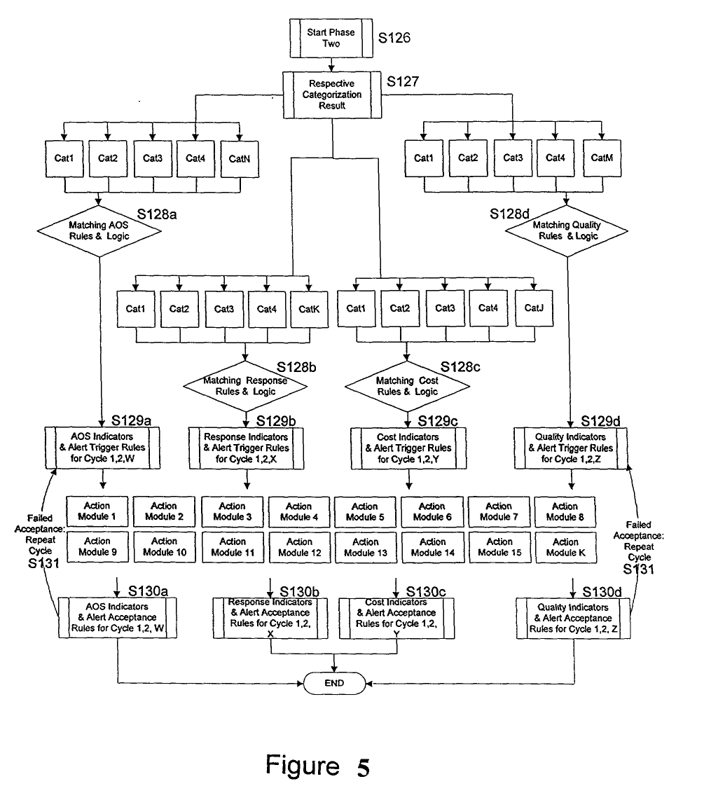

Additional details of the process are described below with respect to FIGS. 4 and 5. FIG. 4 illustrates an event categorization process that uses the agents described herein, according to the present invention. At step S123, an ERP run is performed by the ERP 17 to generate a request for a good. At step S124, the IPA is started, and then, steps S125a-d are performed simultaneously, although the present invention is not limited thereto. More specifically, in step S125a, a cost event categorization (e.g., pricing deviation) is performed, in step S125b, a quality event categorization (e.g., NCM % computation) is performed, at step S125c, an AOS event categorization (e.g., DOS computation) is performed, and at step S125d, a response event categorization (e.g., response time-content tracking and evaluation) is performed. Additional details of the processes in steps S125a-d are described in greater detail herein.

Once steps S125a-d have been completed, phase two is started at step S126, as illustrated in FIG. 5. At step S127, respective categorization results are obtained for each of processes S125a-d as Cat1 . . . CatN, Cat1 . . . CatK, Cat1 . . . CatJ, and Cat1 . . . CatM, respectively. Then, at steps S128a . . . S128d, the respective processes for matching the rules and logic from the rules and metadata unit 12 is performed, and at steps S129a . . . S129d, indicators and trigger alert rules are generated for each of the respective cycles 1 . . . W, 1 . . . X, 1 . . . Y and 1 . . . Z.

Next, the corrective action is taken, by invoking the appropriate action module 1 . . . K. Various examples of action modules are described in greater detail below. At steps S130a . . . S130d, indicators and alert acceptance rules are generated for the processes described above, and the implication manager 6 checks for success or failure. As indicated in step S131, the appropriate process is repeated in case of failure.

In the present invention, the Decision Support and Execution process is applied across various management functions, including (but not limited to): Assurance of Supply management, Response management, Cost management and Quality (that affects AOS) management, as illustrated in FIGS. 4 and 5.

The complete process flow is broadly divided into two phases, event categorization and adaptive execution. While the decision support process is deployed in both phase one and phase two, the activation process is only activated in phase two.

In event categorization, a distinct grouping of indicators represent exception procurement situations such as excess supply, poor response, shortage. The number of procurement situations can be scaled to deploy unique set of corrective actions. The primary objective of this phase is to capture the exception events that have unfavorable implication to the user's operation. The numbers of indicators can be customized and can be subjected to change as the environment evolves.

In adaptive execution, as illustrated in FIG. 5 as described above, each categorized exception event is subjected to a matching set of rules and logic in S129a-d to trigger the most appropriate corrective actions. Depending on the severity of the exception situation, the corrective actions may be simultaneously or sequentially activated. All activated corrective actions may be tracked and may progressively trigger additional corrective actions base on the response and severity of the exception.

In the present invention, a plurality of agents is employed in the above-described components illustrated in the system of FIG. 2 and the process of FIGS. 3-5. The agents may be procedures that operate independently of one another. Further, the agents may reside in the processors 35, 36 as illustrated in FIG. 12. For the features illustrated in FIG. 2 (e.g., managers) and the steps illustrated in FIGS. 3-5, the agents perform processes based on commands, to implement the tasks performed by the managers. These agents are described in greater detail below.

The assurance of supply (AOS) agent, which may reside in one of the processors 35, 36 illustrated in FIG. 12 as a software program, proactively resolves supply problems: shortage, excess and obsolescence in different market conditions. The agent retrieves information from the transactional B2B e-commerce system and information from the ERP's databases to perform evaluations and to deploy corrective actions. The AOS agent also maintains the integrity of inventory, ensuring that unwanted or obsolete materials are purged from the factory (e.g., physical part and financial liability) on a timely basis.

The response agent focuses on improving the flexibility and responsiveness of the backend supply chain. The key performance indicators are lead time and message response time. Lead-time is defined as the time lapse between purchase activation and goods delivery.

The cost agent performs two core functions. First, the cost agent ensures that purchases are made according to the RFQ agreement at the ‘right’ price. The cost agent tracks actual versus planned prices that vary according to mechanisms such as discrete volume break, time based pricing. Second, the cost agent also identifies, analyzes and facilitates efforts to deliver reduction objectives.

The quality agent tracks material fallout activates alerts and replenishes supply when the predetermined quality reject percentage has been breached.

The scenario agent studies the implications of changes in forecast or build plan at product or component level, including (but not limited to) insufficient supply and excess inventory.

The management agent aligns broad level management objectives into unit level performance target to facilitate result measurements.

The self learning agent uses statistical process to correlate analyzed data, business rules and actions to continuously refine Key Performance indicators to enhance the ‘experience’ and knowledge of the intelligent framework.

The session agent coordinates successive (IPA) sessions without replicating the corrective efforts previously invoked by Work-in-Progress (WIP) exception events. The session agent will respond dynamically to degrading conditions for all WIP exception events.

The cost agent and operation of cost management is described in greater detail below. The cost management module ensures the ‘right’ purchase price, and is triggered by events such as a change in the extracted external databases, responses from users or predefine event such as expiry of action. The cost management module also facilitates cost reduction project management by identifying, analyzing and supporting efforts to deliver lower price objectives.

Table 1 discloses a list of generic inputs (but not limited) to the cost management function of the present invention.

TABLE 1

| | |
|---|---|
| 1 | Part Number |
| 2 | Part Description |
| 3 | Controller ID |
| 4 | Standard Cost |
| 5 | PO Number |
| 6 | PO line Number |
| 7 | PO Unit Price |
| 8 | PO Quantity |
| 9 | CO Number |
| 10 | CO line Number |
| 11 | CO Unit Price |
| 12 | CO Quantity |
| 13 | RFQ Unit Price |
| 14 | RFQ Quantity |
| 15 | RFQ Mechanism |
| 16 | Invoice PO |
| 17 | Invoice QTY |
| 18 | Forecast QTY |
| 19 | BOM when required |
| 20 | Currency |

During event categorization (i.e., phase one), the cost management function operates as described below. It is noted that Unit Price is the actual sale price offered by the vendor, whereas Standard Cost is an accounting price that is established to handle part number with multiple vendors. The categorization manager 2 uses the inputs from Table 1 to analyze the cost situation of each part number.

With respect to cost, the cost management module computes pricing deviation as described below. Using Part number as reference, the cost management module retrieves Currency, Unit Price from PO, CO or Invoice (UPPO, UPCO or UPINV), quantity associated with the unit price (QTYPO, QTYCO, QTYINV), ETA or Date of Receipt (invoice) and PO, CO or Invoice document reference number, the pricing information from the RFQ (UPRFQ, QTYRFQ, MECHRFQ, EDATERFQ)

Computation of the effective Unit Price (UPRFQ) is then accomplished. The pricing mechanisms dictate the effective unit price at the point of purchase, using various methods, examples of which are listed below:

Volume break mechanism uses either discrete or cumulative volume to define price;

Time base mechanism uses time to define price.

Market based mechanism, dependent on the balance of buying versus selling forces much like the equity market. Market based price can also be based on future pricing or to be determined at the time of good delivery.

If the foregoing Discrete Volume Break is applied, the UPRFQ is retrieved with QTYRFQ that corresponds with the QTYPO. However, if the mechanism is the Cumulative Volume Break, UPRFQ is retrieved with QTYRFQ (cumulated) that corresponds with the cumulated QTYPO to date. The cumulated QTYPO to date is based on a predefined start date from which all previous QTYPOs are aggregated. Further, if the mechanism is Time Based Pricing (based on time of Document issue), the UPRFQ is retrieved with the effective date corresponding to the PO time stamp.

For the Market Based Pricing mechanism (based on time of Document issue), if the Market based Pricing method is determined by predetermined future market price, the substantially same procedure as the Time based Pricing method is used. However, if the Market Based Pricing is determine at the time of delivery, then it is necessary to calculate the price delta based on invoice (POvsINV).

Computational formulae for the above-identified items are as follows:

Pricing Delta between PO/CO and RFQ (PD POvsRFQ)=UPRFQ−UPPO;

Pricing Delta between PO/CO and Invoice (PD POvsINV)=UPPO−UPINV;

The resulting output is PD POvsRFQ and PD POvsINV.

Next, the cost management module identifies cost reduction opportunities. For inputs, using part number, OH QTY, standard cost (Std Cost) and gross requirement (GrossREQT) for the next 12 months are retrieved. Then, it is necessary to compute the average monthly GrossREQT based on x number of forward looking months (GrossREQTave). The default GrossREQTave is based on 3 month forward looking average. It is also necessary to compute the Average Monthly Purchase cost (AMP)=GrossREQTave×standard cost, and the uncommitted aggregated GrossREQT up to 12 months window (Agg_{—}12M_Uncommit_GrossREQT)=OH QTY+Aggregate of 12 months GrossREQT−all open PO QTY.

The cost reduction is calculated as Saving per unit=Standard Cost×Target Reduction %. The saving per unit is calculated over a predefined period for projected target setting purposes.

At this point, it is necessary to calculate the aggregate potential saving based on uncommitted requirement (Agg_Saving $)=Agg_{—}12M_Uncommit_GrossREQT×saving per unit. If the usage ratio of (Agg_{—}12M_Uncommit_GrossREQT)/(GrossREQTave) is more than Y or any number that signifies months worth of GrossREQT or the Agg_Saving $ is more than a predefined threshold value (e.g. $50,000), then the part is set aside as cost reduction candidates.

As an output, the foregoing calculation provides a cost report within the processed database, as described in Table 2 below.

TABLE 2

| | |
|---|---|
| 1 | Part Number |
| 2 | Part Description |
| 3 | Unit Price |
| 4 | Vendor ID |
| 5 | Ave Mthly REQT |
| 6 | Ave Monthly Purchase $ |
| 7 | Aggregate Uncommitted 12 mth GrossREQT |
| 8 | Quantity Per |
| 9 | Parent Part |
| 10 | PD PovsRFQ |
| 11 | PD PovsINV |
| 12 | Category |
| 13 | Exception |
| 14 | Create date time |
| 15 | Target Reduction % |
| 16 | Start and end date of Target Reduction % |
| 17 | Target Unit Price |

At this point, categorization logic is applied, the exception events are categorized based on selected criteria listed in the aforementioned Cost report. The primary objectives ensure improving cost of components. The categorization rules, hosted in the Rules and Logic Metadata, can be based on more than one criterion. An example of the cost categorization is listed below in Table 3. There can be infinite categories with a supporting set of rules.

TABLE 3

| | Category | Category | Category | Category | Category | Category |
|---|---|---|---|---|---|---|
| | 1 | 2 | 3 | 4 | 5 | 6 |
| Pricing Delta | WITH | WITH | WITH | NO | NO | NO |
| (PD) for | DEVIATION | DEVIATION | DEVIATION | DEVIATION | DEVIATION | DEVIATION |
| PovsRFQ/Inv | | | | | | |
| Average | Up to $10,000 | Between | More than | Up to $10,000 | Between | More than |
| Monthly | | $10,000 to | $100,000 | | $10,000 to | $100,000 |
| Purchase Cost | | $100,000 | | | $100,000 | |
| (UP × REQT) | | | | | | |

The second phase with respect to the cost management function is described below. In this phase, the session manager 3 segregates the exceptions within the Cost report into new or Work-in-Progress events. After that, the action manager 4 uses the evaluated information to extract the appropriate rules and logic to trigger corrective actions.

The objectives of the trigger logic are to detect pricing mismatch and to identify reduction opportunities for a particular part from a specific vendor. Examples of the situational checks are listed below:

Check #1: PD POvsRFQ or PD POvsINV is Positive (favorable to the buyer)

Check #2: PD POvsRFQ or PD POvsINV is Negative

Check #3: If Delta POvsFC is positive

Check #4: if EOL_Agg_Un_QTY is more than X times of Average Monthly GrossREQT

Check #5: if UPPO=UPRFQ=UPINV

Check #6: C or more Cost exceptions record over the last D months

Check #7: If part is customized or standard

Check #8: Check External Market Conditions

Check #9: If Predefined Corrective Action Failed

Check #10: If Predefined Corrective Action Expired

Check #11: If Unit Price is below Cost Reduction Target

Check #12: If Vendor Composite Risk Index is more than Mean

Once the action manager 4 has interpreted the evaluated results, specific corrective actions are activated. The interpretation logic is explained in the description of the rules and logic metadata unit 12, as listed below. However, the present invention is not limited thereto:

Reconfirm Price With Vendor

Send Reminder to Vendor

List Cost Reduction Opportunities

Send Cost Reduction Request to Vendor

Inform Vendor of Previous Similar issue

Assess Risk Profile of Vendor

Target Pricing

Benchmark Prices

Consolidate Purchasing

Add New Vendor to the AVL

Search AVL for Alternate Supply

Solicit Management Support to Negotiate

Post RFQ at B2B Exchanges

Measure External Market Indicator

The session manager 3 screens and removes any duplicate actions that were previously deployed for the same exception event.

Next, the auto trigger manager 5 determines if automatic or manual mode of exception management should be deployed for the affected part number. For parts on manual management mode, the recommended actions are published in the decision support 13 and execution 14 frames. The user then selects and activates corrective actions via the execution frame 14. For parts on automatic management mode, the auto trigger manager 5 activates actions that have been accepted by the session manager 3.

Then, implication manager 6 is triggered to check for compliance when suppliers replied or when actions have expired without a reply. There is no absolute assessment check for the cost module, as each cost event is judged independently, unlike the management of quantity exception event involving various supplies that can be aggregated. In the case of the cost management module, only the acceptance check for a secondary action is invoked.

Acceptable cost deviation is when actual unit price for current and a predefined historical period is consistently within the targeted tolerance band. Further, acceptable cost reduction request is defined by projected unit price based on acknowledged RFQ falling within the targeted tolerance band. Failing the acceptance test triggers the next cycle corrective action.

To close the process, the resolution manager 8 performs the tasks of sending acceptance message to the vendor whose primary action has been selected and sending a rejection note to the vendor whose primary action has been terminated.

For manually controlled parts, the user is expected to decide on the options of Hold, Accept or Terminate for every activated secondary action. After the user selects the option, the resolution manager 8 completes the closure process. The HOLD decision or any unselected actions will not invoke any action from the resolution manager 8.

In the case of auto-managed parts, the auto close manager 7 manages each secondary action on an individual basis. All secondary actions are closed independently.

After the corrective actions have been selected, information pertaining to the accepted action is either uploaded to the ERP system or transferred to a To-Do-List for manual system update.

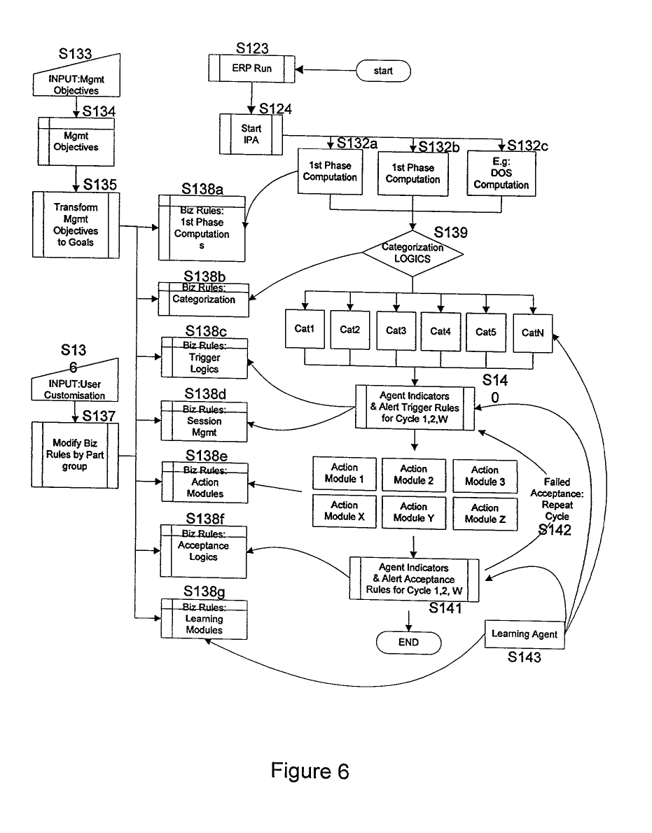

FIG. 6 illustrates a process for the rules and logic module 12 according to the present invention. The rules and logic metadata hosts quantitative parameters and guidelines for the entire invention. As discussed above, S123 and S124 are performed. The, at steps S132a-c, various computations (e.g., DOS computation) are performed. Additionally, an input of management objectives is performed at step S133, and management objectives are properly formatted and generated at step S134. At step S135, the management objectives are transformed into measurable goals. Further, at step S136, a user customization may be input, and accordingly, at step S137, the business rules may be modified by part group.

In the first phase computation of step S132a, the output is applied to the first phase computations at step S138a of the business rules, which are calculated at steps S138a-g. Additionally, the output of the categorization logic at step S139 is applied to categorization step S138b in the business rules, as well as to generate categories Cat1 . . . CatN.

At step S140, the categories Cat1 . . . CatN are used to generate agent indicators and alert trigger rules for the cycles 1 . . . W, and the output of step S140 is used in the trigger logic and session management steps S138c and S138d, respectively. The output of step S140 is also used to initiate the corrective actions from action modules 1, 2, 3, X, Y, Z, which generate agent indicators and alert acceptance rules for cycles 1 . . . W at step S141. The output of step S141 is also used at the acceptance logic step S138f of the business rules. At step S142, the process of steps S140 and S141 are repeated when failed acceptance has occurred, until successful acceptance has occurred.

Further, a learning agent operates at step S143, and provides an input to the learning module step of the business rule formulation at step S138g. Further, the learning agent step S143 also involves sending outputs to the categories Cat1 . . . CatN, as well as steps S140 and S141.

The decision support and execution frames 13, 14 of the present invention are the primary interaction points for the user. Those frames 13, 14 serve as an interface for decision support outputs and execution command inputs. The decision support frames includes at least the following reports: main report, corrective action report, obsolescence report, action detail report, action implication frame, To do List and action history report. The execution frames include the action detail frame, action implication frame (i.e., dual function view), the supplier activation frame, report generation frame, rules setting frame.

The AOS management agent, which ensures that problems and risks associated with assurance of supply is promptly resolved, is described in greater detail below. The AOS module is triggered by a change in the extracted external databases, responses from users or predefined events such as expiry of action. The first and second phase computations and logic will be discussed separately, below. Table 4 illustrates the generic inputs in terms of sources and indicators. In table 4, all acknowledged information is disclosed to be available in a connected environment.

TABLE 4

| | |
|---|---|
| 1 | Part Number |
| 2 | Part Description |
| 3 | Controller ID |
| 4 | On Hand Quantity |
| 5 | Standard Cost |
| 6 | ERP Run timestamp |
| 7 | Product Line Account ID |
| 8 | PO Number |
| 9 | PO line Number |
| 10 | PO Quantity |
| 11 | PO Expected Time of Arrival |
| 12 | PO Unit Price |
| 13 | PO Time Stamp |
| 14 | Vendor ID |
| 15 | PO Quantity Received |
| 16 | PO Date Received |
| 17 | Business Allocation % |
| 18 | Lead-time |
| 19 | Vendor Name |
| 20 | Vendor Forecast Quantity |
| 21 | Vendor Forecast ETA |
| 22 | Gross Requirement |
| 23 | Date of Requirement |
| 24 | Gross Requirement Release |
| | Date |
| 25 | Parent Product Part Number |
| 26 | Parent Product Description |
| 27 | Quantity Per |
| 28 | Part Group Name |

The discussion of the operation of the AOS in phase one (i.e., event categorization) is described below. The categorization manager 2 uses the inputs from Table 4 to analyze the supply situation of each part number. The categorization analysis includes (but is not limited to) Days of Supply (DOS) computation, Purchase Order vs Goods Receipt Notification (PO vs GRN), Forecast vs Purchase Order (FC vs PO), Forecast vs Forecast (FC vs FC), Capacity Tracking, Forecast vs Acknowledged Forecast (FC vs Ack FC) and Purchase or Change Order vs Ack Purchase or Change Order (PO/CO vs Ack PO/CO). These portions of the categorization analysis are described in greater detail below, in terms of inputs, computation, and outputs.

DOS Computation

The DOS computation is computed on a part number basis. It measures the available On Hand (OH) inventory relative to usage. This process is analogous to the evaluation of cash position in accounting. The computation framework is based on a user defined workdays per month (e.g. 20 workdays, as illustrated in the equation below).

Detail Inputs

GrossREQT is the aggregated requirement

OH_QTY is the On Hand current inventory

Std Cost is the Normalized unit price for accounting purposes

QTYnextPO is the quantity to be delivered in the next PO

ETAnextPO is the expected date of next PO delivery

Computation

The following steps are performing in the computation:

Calculate the K (user defined number) months forward looking monthly average GrossREQT. The following calculation uses a 3 month average as an example, but the present invention is not limited thereto: GrossREQT3mthave=[GrossREQT monthN+GrossREQTmonthN+1+GrossREQT monthN+2]/3

Retrieve the Target DOS from the Rules and Logic Metadata 12. Target DOS is a manually defined management goal.

Compute the DOS and OH $ (extended cost) for every part number where

DOS=[OH/GrossREQTave]×(20 workdays)

OH $=Extended cost (or price) of part in question=Std Cost×OH quantity

Compute the DOS % Delta:

DOS % Delta=[(DOS−Target DOS)/Target DOS]×100%

Calculate Days to Next Delivery (DND) to assess the risk of shortage.

DND=ETAnextPO−Date of DOS computation

If DND is less than DOS, then calculate NEXTDOS. (if DND is less, the next delivery is in time to replenish supply)

NEXTDOS=[(OH+QTYnextPO)/GrossREQT3mthave]×20 workdays

(NEXTDOS includes the next delivery in the DOS computation)

Outputs

DOS report within the processed database

DOS30 Computation

To perform this computation, utilize aggregate GrossREQT of the immediate next 30 days instead of three month average to calculate the Day of Supply. The 30 days value is referred to as DOS30. The calculation is as follows:

DOS30=[OH QTYcurrent/Agg_{—}GrossREQT next 30 days]×workdays per month.

Purchase Order vs Goods Receipt Notification (PO vs GRN)

PO vs GRN comparison validates both the timeliness and accuracy (QTY) of part delivery.

Inputs

PO reference number, PO line number, PO quantity (QTY) and Expected Time of Arrival (ETA), Good Receipt Note (GRN) received Qty, date, GRN's PO reference number and PO line number.

Computations

Using the GRN's PO ref number, get the PO's QTY and ETA records. Check GRN's received QTY & Date against the PO's QTY and ETA, and use the following calculations:

QTY Delta=GRN received QTY−PO ordered QTY;

ETA Delta=GRN's date of receipt−PO's ETA.

Outputs

DOS report within the processed database

Forecast vs Purchase Order (FC vs PO)

In the context of this document, forecast is equivalent to Gross Requirement or aggregated demand.

FC vs PO checks forecasted requirement against committed supplies. The committed supplies include On Hand (OH Qty) and all opened PO quantity (PO Qty). The evaluation time frame is based on the lead-time of the part.

Inputs

Lead-time, GrossREQT up to lead-time, OH Qty and all open PO Qty

Computations

Aggregate all open PO Qty=Agg_PO_QTY

Aggregate GrossREQT up to leadtime=Agg_GrossREQT_LT

Delta POvsFC=[Agg_GrossREQT_LT+OH QTY]−[Agg_PO_QTY]

Outputs

DOS report within the processed database

Forecast vs Forecast (FC vs FC)

FC vs FC assesses the implication of plan changes over time. Changes in GrossREQT within the procurement lead-time often result in cumulative supply imbalance in supply and demand.

Inputs

Lead-time, current and historical GrossREQT releases with appropriate rolling lead-time window. The historical record is retrieved in reverse chronological order, back dated to the start of the lead-time using current date as reference. For example, If the lead-time were 60 days, then retrieve previous 60 days worth of GrossREQT releases. Each of these releases contains GrossREQT information up to lead-time with respect to the release time stamp.

Computations

For each releases of GrossREQT plan, group all GrossREQT into the appropriate time bucket according to its ETA or requirement date. The time bucket can be in week or in month.

In reverse chronological order, starting from current GrossREQT, compute the delta of current versus the immediate previous GrossREQT plan. As the amount of information varies for each GrossREQT plans because of the rolling lead-time window, only the matching time bucket of the compared plans are calculated. Ignore the computation if there are no matching time bucket.

Computation of GrossREQT Delta in unit:

GrossREQT Delta in unit for each matching time bucket=GrossREQTrelease period N for time bucket A−GrossREQTrelease period N−1 for time bucket A

Computation of CUMULATIVE GrossREQT Delta in unit:

Sum of GrossREQT Delta in unit for ALL matching time bucket for ALL release period comparisons

Computation of GrossREQT Delta In percentage:

GrossREQT Delta in % for each matching time bucket={[GrossREQTrelease period N for time bucket A−GrossREQTrelease period N−1 for time bucket A]/GrossREQTrelease period N−1 for time bucket}×100%

Computation of CUMULATIVE GrossREQT Delta In percentage:

Sum GrossREQT Delta in % for release period N−period N−1 with matching time bucket={Sum of GrossREQT Delta release period N−release period N−1/GrossREQTrelease period N−1 for time bucket}×100%

Sum GrossREQT Delta in % for ALL release periods with matching time bucket={[Sum GrossREQT Delta in % for release period N−period (N−1)+Sum GrossREQT Delta in % for release period (N−1)−period (N−2)+ . . . /Number of Sum GrossREQT Delta in % Count}

Outputs

DOS report within the processed database

Capacity Tracking

The capacity tracking module ensures that all increase in requirements are validated against parts with capacity constraints.

Inputs

Manual input into Table 5:

TABLE 5

| | PART | Vendor | Capacity |
|---|---|---|---|
| Part Number | DESCRIPTION | ID | Per month |
| 3332-5338 | Power | A0008 | 220,000 |
| | Supply | | |
| 1003-0229 | spring | A0019 | 5000000 |

Computations

Compare the capacity constraint with cumulated PO quantity within the same time bucket (e.g., within the same month).

Capacity Delta within same time bucket=Capacity−cumulated PO quantity

Outputs

DOS report within the processed database

Forecast vs Acknowledged Forecast (FC vs Ack FC)

Forecast occurs typically once per month. This function pre-empt any potential middle to long term supply issues.

Inputs

Vendor assigned GrossREQT or forecast of future requirement. Acknowledged forecast from vendor.

Computation

Check for deviations between the sent and acknowledged forecast. Deviations are defined as:

QTY Delta=Acknowledged QTY−Requested QTY for each expected ETA line

ETA Delta=Acknowledged ETA−Requested ETA

Output

DOS report within the processed database

Purchase or Change Order vs Ack Purchase or Change Order (PO/CO vs Ack PO/CO)

PO and CO are generated frequently in the direct procurement environment. The primary objective is to detect longer term supply issues.

Inputs

The requested and acknowledged PO/CO's ordered Qty and expected time of arrival.

Computations

The delta computations are performed for all newly issued PO and CO:

QTY Delta=Acknowledged QTY−Requested QTY for each expected ETA line

ETA Delta=Acknowledged ETA−Requested ETA

Outputs

DOS report within the processed database, as disclosed in Table 6 below.

TABLE 6

| | |
|---|---|
| 1 | Part Number |
| 2 | Monthly Requirement Average |
| 3 | Extended Cost |
| 4 | DOS |
| 5 | Target DOS |
| 6 | Delta DOS |
| 7 | DND |
| 8 | NEXTDOS |
| 9 | CUM Delta in FC (ratio) |
| 10 | CUM DELTA IN FC (unit) |
| 11 | Next 4 wks |
| 12 | PO vs FC Delta (Y Month Forward) |
| 13 | Capacity Delta Per Month |
| 14 | Delivery/Shipping Performance (%) |
| 15 | Category |
| 16 | Exception |
| 17 | Create date time |

Categorization Logic

Categorize the exception events based on selected criteria listed in the DOS report. The primary criteria should be indicative of the level of assurance in supply. The categorization rules, hosted in the Rules and Logic Metadata, can be based on more than one criteria. For example, Delta DOS % can be used to categorize Assurance of Supply exception.

TABLE 7

| | Category 1 | Category 2 | Category 3 |
|---|---|---|---|
| Delta DOS | Between −20% to | Between −100% | More than +20% |
| | +20% | to −20% | |

Phase two begins after the foregoing event categorization. The session manager 3 segregates the exceptions within the DOS report into new or Work-in-Progress events. After that, the action manager 4 uses the evaluated information to extract the appropriate rules and logic to trigger corrective actions. The rules and logic set is differentiated by exception category (situation) and commodity type.

While the number of categorized situations can be infinite, the three most clear cut situations are shortage, excess and risky. Each deployment of actions for the categorized situations is tracked as cycle 1, 2, 3 and so on. The action cycle increases as additional actions are triggered in the event of unfavorable response.

Situational Evaluations

The action manager 4 performs selected additional evaluation on each categorized exception. Examples of the situational checks for the three main categories follow below.

Check #1: DND is more than DOS

Check #2: Shipping performance % is less than A %

Check #3: Cum FC Delta_% is more than +B %

Check #4: C or less shortage exceptions on record over the last D months

Check #5: Open POs are launched to more than one vendor

Check #6: DOS is equal or less than E DOS

Check #7: Qualified vendor with 0% business allocation

Check #8: DOSupdated is F days or less and

Check #9: DNDupdated is more than DOSupdated

Check #10: The number of actions triggered in cycle 1 are G or more

Check #11: If the part is a standard commodity

Check #12: Failed or Expired Action

Check #13: Extended Cost of line item is MORE than $H

Check #14: DOS is more than 999

Check #15: DOS is more than I

Check #16: DOS is less than J

Check #17: DOS30 is equal or less than K

Check #18: Cum FC Delta_% is more (negative) than −L %

Check #19: DOS % Delta is more than M %

Check #20: Delta PovsFC is less than zero

Check #21: Failed or Expired Action

Check #22: Extended Cost of line item is MORE than $O

Check #23: P or less shortage exceptions on record over the last Q months

Check #24: Shipping performance % is less than R %

Check #25: Cum FC Delta_% is more than +S %

Check #26: DOS30 is equal or less than T

Check #27: Extended Cost of line item is MORE than $O

Check #28: Delta PovsFC is less than zero

Check #29: Cum FC Delta_% is more (negative) than −N %

Check #30: Failed or Expired Action

Corrective Action Execution

Once the action manager 4 has interpreted the evaluated results, specific corrective actions will be activated. Interpretation logic is explained in the rules and logic section. The potential (but not exhaustive) corrective actions are listed below.

Activate Backup PULL IN

Activate PULL IN

Send Enquiry to ‘Second Sourced’ Vendor

Request Shipping Notification

Reconfirm Forecast and POs

Activate 2^{nd} Cycle Top Up Pull in

Seek Supply From Internal Divisions

Search AVL for Alternate Supply

Post Spot Purchase at B2B Exchange

Seek Supply From Internal Divisions

Highlight Implication to Management

Add New Vendor to AVL

Request Internal Management Participation

Optimize delivery with Production Schedule

Assess Risk Profile of Part

Assess Risk Profile of Vendor

Add New Vendor to AVL

Activate Push Out Orders

Reactivate Push Out Orders

Request Vendor to Stop All Activities

Request to Cancel Orders

Sell to Internal Division

Part Obsolescence Report

Inform vendor of Inventory Buildup

Post Spot Sale in B2B Exchanges

Rebalance PO

Escalate Attention at Vendor End

Escalate Attention to Vendor's Senior Management

Escalate Attention Internally

Send Reminder to Vendor

Send 2^{nd} Reminder to Vendor

The session manager 3 screens and removes any duplicate actions that were previously deployed for the same exception event. Next, the auto trigger manager 5 determines if automatic or manual mode of exception management should be deployed for the affected part number. For part on manual management mode, the recommended actions are published in the Decision Support 13 and Execution 14 frames. The user selects and activates corrective actions via the Execution frame 14. Activation equates to sending action request messages to the supplier's user mailbox. For part on automatic management mode, the auto trigger manager 5 activates all actions that have been accepted by the session manager 3.

Implication Evaluation on Action

The implication manager 6 will be triggered to check for compliance when suppliers replied or when actions expired without a reply. There are two types of corrective actions, primary and secondary. Primary action affects supply quantity, while secondary actions do not have direct impact in supply quantity. The implication manager 6 only performs (e.g., Absolute Assessment) checks on primary actions to determine if the exception event had been resolved or otherwise. The Absolute Assessment ascertains optimal availability of inventory (e.g., On Hand Quantity) within a predefined time window.

The acceptance zone of the Absolute Assessment is typically between a lower limit of zero unit and a predefined upper limit for a predefined time period.

Both manually or automatically managed parts are subjected to the same Absolute Assessment check. The generic methodology of performing the check is to aggregate the effects of all acknowledged or accepted primary actions from suppliers. The user may also assign preferences to supplier or action to establish priority. Two typical examples of Absolute Assessment methodologies are First in First Out (FIFO) and Weighted Acceptance (WA). Other prioritization methodologies may be deployed to enable the Absolute Assessment check.

First In First Out (FIFO): All acknowledged primary actions, regardless of whether each action is 100% or partially accepted by supplier, are aggregated in a FIFO manner to match the prevailing demand (GrossREQT).

Weighted Acceptance (WA): All acknowledged primary actions, regardless of whether each action is 100% or partially accepted by supplier, are aggregated according to a user defined preferential order. The evaluation will commence if all primary actions have been acknowledged or when the expiry time has lapsed. In the event of similar preference, the acceptance criteria will then resort to FIFO mechanism.

Assessment of Secondary Actions

Secondary actions are not subjected to the Absolute Assessment check. Each secondary action is judged on its own merit, i.e., it has to pass the acceptance criteria. Assessment is triggered by a response or by the expired action time stamp. Acceptance is defined as no deviations between the acknowledged and requested QTY and ETA. Failing the acceptance test will trigger the next cycle corrective action.

The resolution manager 8 performs the tasks of sending acceptance message to the vendor whose primary action has been selected and sending rejection note to the vendor whose primary action has been terminated.

For manually controlled parts, the user is expected to decide on the options of Hold, Accept or Terminate for every activated primary and secondary actions. After the user selects the option, the resolution manager 8 will complete the closure process. The HOLD decision or any unselected actions will not invoke any action from the resolution manager 8.

In the case of auto-managed parts, the auto close manager 7 utilizes results from the Absolute Assessment to decide. The auto close manager 7 accepts actions that are used to fulfill the Absolute Assessment. All other acknowledged actions that result in ‘out of bound’ net availability will be terminated. The termination includes all outstanding secondary actions.

After the corrective actions have been selected, information pertaining to the accepted action are either uploaded to the ERP system or transferred to the To-Do-List for manual system update.

To compute the To-Do list, changes to existing PO quantity and ETA are factored with reference to the accepted corrective action reply. Quantity for each PO is adjusted to capture the accepted corrective action replied quantity.

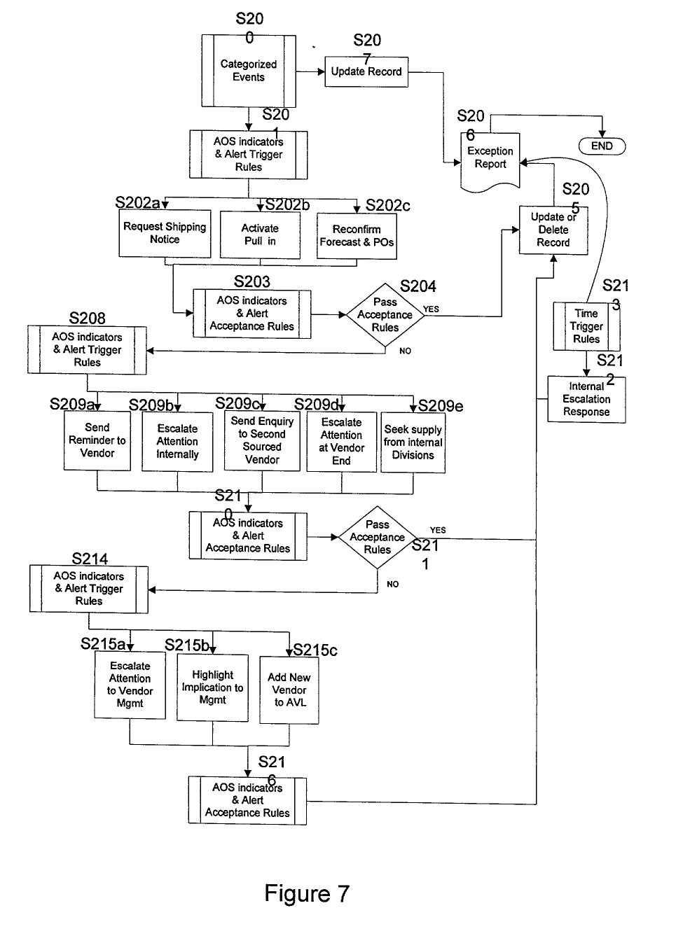

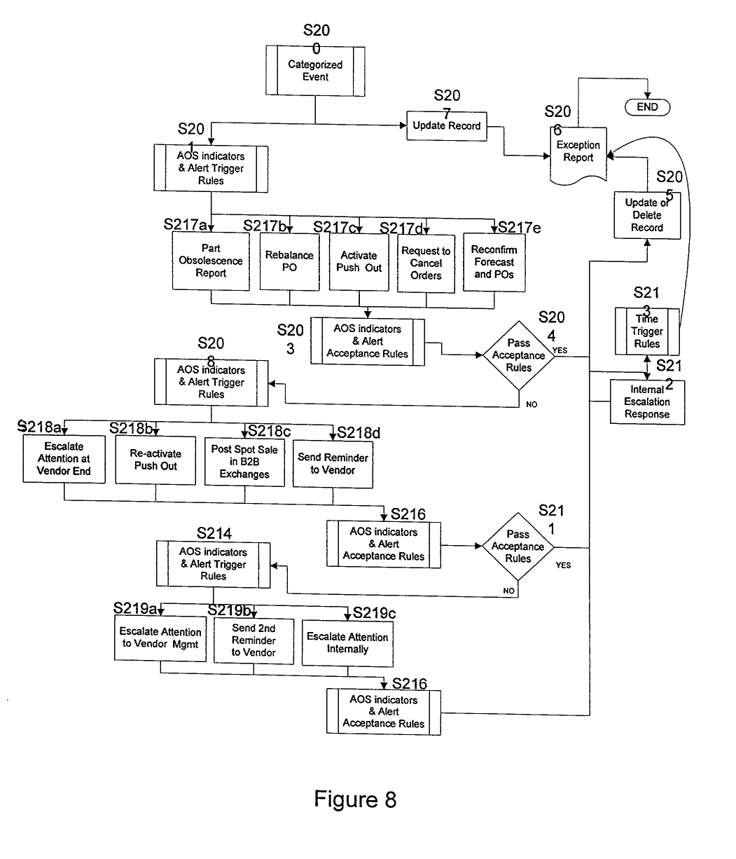

FIGS. 7 and 8 illustrate a possible version of adaptive management of a shortage and excess situation, respectively. The action manager 4 deploys specific corrective actions after interpreting the situational evaluation results. Additional cycles of actions were triggered after previous actions did not produce acceptable results.

FIG. 7 illustrates a typical situation in an industrial setting, in which there is a shortage of supply from a vendor. As illustrated in FIG. 7, at step S200, the exception events are categorized in the categorization manager 2 based on input from the databases 9, 10, 11 and the rules and logic metadata unit 12. At step S201, AOS indicators and alert trigger rules are generated at the AOS rules unit 23, for determination at the action manager 4. At steps S202a-c, the specific actions of requesting a shipping notice (i.e., to inform a vendor of the need for supplies), activating pull-in and reconfirming forecast and PO's are performed, based on being triggered by the autotrigger manager 5. Then, at step S203, the AOS indicators and alert acceptance rules are generated. These rules are used by the implication manager 6 to determine if the action has resulted in a pass or a fail of the resolution of the exception event. At step S204, it is determined whether the acceptance rules have been passed by the implication manager 6.

If the acceptance rules have been passed, then the record is updated or deleted at step S205 by the resolution manager 8, and an exception report is generated in step S206, also by the resolution manager 8, based on a record updated at step S207, after step S200, which is described above. Thus, the system database is updated.

If the acceptance rules have not been passed, then at step S208, the action manager 4 is reactivated by the resolution manager 8 to receive AOS indicators and alert trigger rules. At step S209a-e, additional corrective actions are performed from the action modules to further address the shortage exception event. As noted above, the autotrigger manager 7 triggers the release of the action 24. Steps S209a-e escalate the situation internally and externally, send the appropriate reminders, and seek alternate sources of supply internally. At step S210, the AOS indicators and alert rules are again generated for the implication manager 6, and at step S211, a comparison substantially similar to step S204 is performed to determine if the actions have resulted in the passage of the acceptance rules by the implication manager 6.

If the acceptance rules have been passed after step S211, then steps S205 and S206 are performed as described above by the resolution manager 8. However, after performing step S211 and before performing step S205, an internal escalation response is generated at step S212, and at step S213, time trigger rules are generated to trigger the generation of the exception report at step S206.

If the acceptance rules have not been passed, then at step S214, a process substantially similar to steps S208 and S201 is performed. Accordingly, steps S215a-c are performed as further corrective actions to overcome the shortage exception event. Steps S215a-c perform the escalation, and result in the adding of additional vendors (i.e., seek additional sources of supply externally). At step S216, a step substantially similar to steps S203 and S210 is performed, and then steps S212, S213, S205 and S206 are performed as described above.

FIG. 8 illustrates an exemplary excess corrective action execution according to the present invention. In this case, there is a surplus of supply good in a manufacturing facility, due to e.g., too much delivery from a vendor or too little demand from a buyer. Steps S200, S201, S203-S208, S210-S214 and S216 are performed in a substantially similar manner to that described above with respect to FIG. 7 and thus, the description of those steps is not repeated. Further, the general method is substantially similar to FIG. 7, and is thus not repeated.

In contrast to FIG. 7, however, at steps S217a-S217e, actions are taken in an attempt correct the exception event of excess supply, by generating an obsolescence report, activating push-out, requesting cancellation of orders, reconfirming forecasts, etc. If those steps do not result in the passage of the acceptance rules, then at step S218a-d, additional steps are taken. For example, attention is escalated at the vendor end, push-out is reactivated, spot sales are posted in B2B exchanges, and reminders are sent to vendors in an attempt to reduce excess supply.

If the steps of S218a-d do not work, then steps S219a-c are attempted as corrective actions. Those steps include, but are not limited to, further internal and external escalation of attention, as well as sending additional reminders to the vendor.

The remainder of the process is conducted as described above with respect to FIG. 7.

A demand change management module is deployed when the demand signal changes during the work-in-progress management of an exception event. All work-in-progress exceptions are categorized as problems unresolved, problems partially resolved, and problems resolved but yet-to-be-deleted events. It is assumed that all incident of exceptions resolution is considered as an independent event, and that any existing WIP actions forms the baseline for incremental treatment in response to a demand change, whether an acceptable solution has been derived to satisfy the absolute assessment (within the assessment period) or otherwise. Further, it is assumed that the demand change management is focus on administrating incremental fixes for mild changes, and that the user defines the threshold for mild to severe change. The Cum Delta GrossREQT % is used as the indicator to signify the RERUN threshold, based on a day by day evaluation.

As the demand management module is activated when a severe change is detected, there is no need to retrace GrossREQT information, the computation of which is described below, based on the exception start date.

If Cum Delta GrossREQT % (i.e., the rerun threshold) of any day prior to leadtime exceed +/−X %, then activate a rerun for all actions, else, proceed to incremental fixes. In the event of a rerun, the action manager 4 will re-activate all appropriate corrective actions (e.g., likely to be the same as previously triggered action). All outstanding and closed previous actions will be set to void. The implication manager 6 will utilize the absolute assessment mechanism to evaluate actions as a result of mild or severe change.

Create an Effective Supply List of Work in Progress Actions

In the present invention, updates to the databases 9, 10, 11 can be performed in real time. As a result, there is a need to identify the right WIP corrected supplies and the existing PO from the Exception Event database 11 and the ERP raw database 9. To do this, it is necessary to insert the Exception record into the Effective Supply list if the identified PO has been handled by the implication manager 6 and reflects a status of accepted or acknowledged action. Other handled POs with status such as activated or recommended will not be included in the Effective Supply list.

Also, it is necessary to insert all Non PO association quantity (Non PO QTY & ETA) with the Accepted-Not-ERP-Updated status into the Effective Supply list.

Detailed Algorithm for Incremental Fixes

To perform the incremental fixes, the following method is applied:

Establish the value of Cum Delta GrossREQT (i.e., cumulative change in gross demand) at the end of Leadtime. This value indicates the absolute cumulative increase or decrease in supply quantity at the end of the resolution window.

Also, establish the order and instants of the positive or negative Cum Delta GrossREQT zones. A positive follows by negative zone signifies demand increase follows by period of decreases with reference to existing plan.

Always establish cumulative demand reduction or excess supply first. The excess supply is indicated by period where the Cum Delta GrossREQT values are negative. Insufficient supply is indicated by positive Cum Delta GrossREQT values.

Excess Supply Identification and Management Process: Demand Decrease

This process is only invoked if the Cum Delta GrossREQT is a negative value and within the same zone (contain within 2 cross-over points). Compare the Cum Delta GrossREQT with supplies on the Effective Supply list on a day by day basis:

If the Cum Delta GrossREQT date N+PO or Non PO QTY date N is equal or less than ZERO, then set the PO/Non PO Qty aside as Excess QTY (this excess supply quantity may be used to fulfill demand increase for a earlier period).

As long as the Cum Delta GrossREQT remains a negative value on the next day, continues the excess supply check using the updated equation for subsequent checks: Cum Delta GrossREQT date N+1+PO or Non PO QTYdate N+1+Excess QTYidentified

If the updated equation yields a result of ZERO or less, then the PO or Non PO QTY date N+1 will be cumulated to the Excess QTYidentified.

Else, if the updated equation yields a result of more than ZERO, on the date when the updated equation turns positive, release the PO or Non PO QTY from the identified excess quantity for the potential shortage.

Release the excess PO/Non PO QTY using first-in-first-out method if there are no preceding period of absolute shortages (or demand increases). Else, adopt the last-in-first-out method.

Stop the computation when either lead-time is reach or a sign changes in the Cum Delta GrossREQT has occurred.

Scan for the next positive to negative cross over point (i.e., the next negative zone). Once the cross over point is detected, repeat the above mentioned excess supply identification process.

After completing the Excess process, proceed to the Shortage management process

Shortage Identification and Management Process: Demand Increase

Determine if there were at least one subsequent positive to negative Cum Delta GrossREQT cross over point. This signifies subsequent period of demand decrease, a potential excess situation.

If there were no subsequent positive to negative cross over point, new purchase has to be triggered.

The first ETA of the new purchase is set as the first day when Cum Delta GrossREQT is more than zero. All subsequent ETA date of the new purchases is according to existing ETA date or based on a regular delivery timing.

Quantity of new purchase is based on the incremental requirement between existing ETAs: Cum Delta GR next ETA−Cum Delta GR current ETA

If there were subsequent positive to negative cross over points, identify all excess quantities with ETA contain within the immediate-next-negative zone.

Compare the excess PO or Non PO QTY identified in the immediate next negative zone with the shortage identified in the current zone.

IF excess PO or Non PO QTY identified is available, compute the next ETA date using the equation: Cum Delta GR next ETA−Cum Delta GR current ETA is equal or more than the PO or Non PO QTY identified. Repeat the search for excess PO or Non PO QTY identified to be used for the next ETA if the above mentioned equation is true.

If there are no PO or Non PO QTY identified available, revert to the new purchase method.

Continue the New purchase computation until lead time.

Accordingly, incremental fixes are accomplished as described above.

The action modules according to the exemplary embodiment are described below. As noted above, the action modules implement various actions to correct the exception event. The corrective action is either dependent or independent of previous actions.

The dependent corrective action administers solution that considers the result of previous failed action. Examples include, but are not limited to, Escalate Attention at Vendor End and Reactivate Push Out. The independent corrective action triggers solution without consideration of previously activated actions. Various exemplary action modules are described in greater detail below.

Escalation Process Set Up

This process requires user set-up to execute.

The Escalation Hierarchy

The basic hierarchical structure facilitate multiple notifications at the appropriate time for the right issues. For example:

Buying organization: multiple levels of notification

Level 1: Buyer, Engineer, Planner, Production Supervisor

Level 2: Purchasing manager, Production manager, Engineering manager

Level 3: Supply Chain Manager

Level 4: Product Line Manager

Supplier: multiple levels of notifications

Level 1: Account manager or Sale Executive

Level 2: Sale manager

Level 3: Senior Sale manager

Level 4: General Manager

The first step in escalation is to find the Right role(s) to be notified. The role(s) to be notified is associated to specific corrective actions. Such relationship is predefined and customizable by the user, and an exemplary representation is shown in Table 8.

TABLE 8

| Action | Distribution | Escalation Level | Rate |
|---|---|---|---|
| Optimize Delivery with Production | To | 1 | Planner |
| Schedule | | | |
| Optimize Delivery with Production | Copy | 2 | Purchasing |
| Schedule | | | Manager |
| Send Enquiry to Second Source | To | 1 | Engineer |
| Search AVL for Alternate Supply | To | 1 | Engineer |
| Add New Vendor to AVL | To | 1 | Engineer |
| Escalate Attention at Vendor | To | 2 | Sale Manager |
| End | | (external) | |
| Escalate Attention to Vendor | Copy | 1 | Sale Manager |
| End | | (external) | |
| Escalate Attention to Vendor | To | 3 | Senior |
| Management | | (external) | Sale Manager |
| Escalate Attention to Vendor | Copy | 1 | Sale Executive |
| Management | | (external) | |
| Escalate Attention to Vendor | Copy | 2 | Sale Manager |
| Management | | (external) | |
| Escalate Attention to Vendor | Copy | 1 | Planner |
| Management | | | |
| Escalate Attention to Vendor | Copy | 2 | Purchasing |
| Management | | | Manager |

The detail escalation association is established utilizing roles and association with part group and/or parent part to retrieve the name and email contact of individuals to be notified, as shown in Table 9.

TABLE 9

| | | | Email |
|---|---|---|---|
| Roles | Association | Name | Address |
| Purchasing Manager | Part Group & Parent | | |
| | Part | | |
| Engineer | Part Group | | |
| Engineering Manager | Part Group | | |
| Production Supervisor | Parent Part | | |
| Planner or Scheduler | Parent Part | | |
| Supply Chain Manager | Parent Part | | |
| Product Line Manager | Parent Part | | |
| General Manager | Parent Part | | |

Escalation methods can be activated by default; by the N work day if an issue remains unresolved; unsatisfactory response; expired action; deviation exceeding predefined margin; manual escalation. The escalation messages, application hosted messages or emails, are automatically or manually activated.

Escalate Attention at Vendor End/Escalate Attention to Vendor Management/Escalate Attention Internally

These are dependent actions designed to work on primary actions. Using part number, vendor ID, Action ID as reference, establish the escalation distribution list.

If action had been acknowledged, re-activate the application request message from the vendor's sent folder back to the inbox folder. Attach message to request for appropriate attention and actions.

If no re-activation is required, forward a copy of the escalation message to the vendor mailbox and a copy in email format to the escalation distribution list.

Send Reminder to Vendor/Send 2^{nd} Reminder to Vendor

This is a dependent action design for secondary actions. Using part number, vendor ID, Action ID as reference, establish the distribution list.

Forward a copy of the reminder message to the vendor mailbox and a copy in email format to the distribution list.

Request Internal Management Participation

This action is designed to solicit help, active participation, from the purchasing or higher level manager.

Invoke the Decision Support implication view. Create and distribute email message with attachment or hotlink to the management personnel. The forwarded message will include information on corrective actions.

Reconfirm Forecast and Orders

Using part number and vendor ID as reference, retrieve all relevant PO and assigned to vendor forecast information. The information includes PO reference number if applicable, quantity and ETA date. The assigned to vendor forecast contain plan purchases with specific vendor based on predefined business allocation.

Forward Reconfirm Message to the relevant supplier's inbox.

Highlight Implications to Management

Using part number as reference, retrieve Vendor ID, corresponding Parent Product(s) and quantity per for each parent product. Quantity per is defined units of part require for one unit of parent product.

In a shortage situation, compute the followings:

Implication 1: Allocate All Shortages to One Parent Product

Parent product shortage 100%=Total part shortage/parent product's quantity per

Implication 2: Allocate Shortage Equally to All Parent Products

Parent product shortageequal=(Total part shortage/number of parent product)/each parent product's quantity per

Implication 3: Optimize Shortage to Achieve Lowest Lost

Invoke differential equation to find the lowest level of shipment shortfall or lost in revenue:

For example, if there are three parent products, contributing $Revenue A, $Revenue B and $Revenue C respectively. The quantity of each parent product are represented by A, B and C.

Total Rev lost=RL=A×$Rev A+B×$Rev B+C×$Rev C

Differentiate the equation and set Differentiated RL=0

Derive the corresponding value of A, B and C

If there are only one parent product, only compute implication 1

Implication 4: Apportion Shortage to Parent Demand Fluctuation

Retrieve the previous within lead-time plan fluctuation for each parent part.

Refers to the Obsolescence Action for algorithm details.

After the within lead-time Cum GrossREQT Delta for each parent has been derived, use only the positive Cum GrossREQT Delta values to apportion:

Apportioned Shortage for parent part A=(Cum GrossREQT Delta for A/Sum of Cum GrossREQT Delta for All parent parts)×Total shortage

Assess Risk Profile of Component

Using Part Number AND Vendor ID as reference, evaluate risk of component based on each vendor. The evaluation of risk is based on the following criteria (it is noted that the performance band (e.g. 95%<=SP<100%=1) for each criteria can be customized by the user):

Historical report on Delivery performance % (SP)

Historical report on Responsiveness (R) and lead-time (LT)

Historical report on Quality (Q)

Report on cost (C)

Historical exception statistics (HE)

External factors (EF)

Weighting on each performance indicator:

Default range of criteria:

Delivery or Shipping Performance SP

| SP = 100% | = 0 |
|---|---|
| 95% <= SP < 100% | = 1 |
| 90% <= SP < 95% | = 2 |
| 85% <= SP < 90% | = 3 |
| SP < 85% | = 4 |
| Responsiveness R | |
| R < 24 hr | = 0 |
| 24 hr < = R < 48 hr | = 1 |
| 48 hr < = R < 72 hr | = 2 |
| 72 hr < = R < 96 hr | = 4 |
| Leadtime LT | |
| LT < 4 wks (30 days) | = 0 |
| 4 wks <= LT < 6 wks (45 days) | = 1 |
| 6 wks <= LT < 8 wks (60 days) | = 2 |
| 8 wks <= LT < 12 wks (90 days) | = 3 |
| 12 wks < LT | = 4 |
| Quality Q | |
| Zero Quality exception during last six month | = 0 |
| One Quality exceptions during last six month | = 1 |
| Two Quality exceptions during last six month | = 2 |
| Three Quality exceptions during last six month | = 3 |
| Four Quality exception during last six month | = 4 |

Cost C

Track monthly actual price (AP) versus target price (TP) are computed for the next few quarters. Actual price includes quoted pricing commitment from supplier. Target price is defined as cost reduction pricing goals.

| Quoted price = target price | = 0 |
|---|---|
| 102% TP >= AP > 101% TP | = 1 |
| 103% TP >= AP > 102% TP | = 2 |
| 103% TP >= AP > 104% TP | = 3 |
| 104% TP >= AP | = 4 |
| Historical Exception Statistics HE | |
| Zero exception | = 0 |
| One exception | = 1 |
| Two & three exceptions | = 2 |
| Four & five exceptions | = 3 |
| Six or more exceptions | = 4 |

External Factors EF

Using a scale of 0 to 4, design a point system that awards low point for desirable and high points for undesirable situation that can be quantified from external sources. An example is the book to bill ratio of semi-conductor industry.

The composite risk index is computed as follows, where sum of all weights is equal to 100%:

Part level composite risk index=(SP×weightage+R×weightage+LT×weightage+Q×weightage+C×weightage+HE×weightage+EF×weightage)/4

Assess Risk Profile of Vendor

Using Vendor ID as reference, retrieve all part numbers that are associated with the vendor ID.

Activate the Assess Risk Profile of Component for each of the part with the same vendor ID

Report on total purchase dollar and number of parts involved

Vendor composite risk index=Aggregate of all part level composite risk index/number of parts associated with vendor

Compare the Vendor composite risk index with the mean value of the existing pool of vendor with composite indices.

Vendor is categorized as high risk if index more than mean, low risk if index<mean

Mean is computed using the data of vendors who are supplying parts within the same part group

Buy from or Sell to Internal Division (Primary Action)

Using Part number as ID, search the ERP raw database for common user of the component

If common users are available, retrieve the contact information (email address)

To Sell Excess

If DOS>999, then set the quantity to sell as the On Hand Quantity

If 15<DOS<999, then set quantity to sell as excess on hand quantity less aggregate GrossREQT up to lead-time. If there are no excess, then set the quantity to sell as zero.

To Buy Because of Shortage

Calculate the OH QTY for the entire predefined number of days using the equation:

OH_{—}QTY date 1=OH QTY date0−GrossREQT date1+PO QTY date 1 (where PO QTY date 1 is the open PO on date 1 if available)

When the OH_QTY date N is less than the purchase reorder point (a customizable re-order), set ETA to buy as the date before the re-order point is breached.

Set QTY to buy=target DOS×Average daily GrossREQT

Repeat the purchase calculation until a predefined window, for example 30 days.

Add New Vendor to AVL

Using Part Number as reference, retrieve the Specification drawing, names of qualified vendors and the corresponding business allocation to each vendor, list of vendor in the Approved Vendor List (AVL).

Compare the AVL with vendors who supply to the same part group. identifies the vendors who are not included in the AVL.

Trigger the Request for Quotation (RFQ) process to submit quotation request to predetermined B2B trading hubs. This method requires integration with sourcing software solutions.

Publish the recommendation to buyer and engineer via email or the user views.

Request Shipping Notice from Vendor

Using Part Number as reference, create a shipping Notice Request message indicating the immediate PO number and the PO quantity.

The supplier is expected to acknowledge the notice by indicating Carrier name,

Master AirWay Bill (MAWB), Departure date-time and shipped quantity.

Send Shortage Alert Message to Vendor

Using Part Number as reference, create a shipping Notice Request message for X number of the future PO deliveries that the user wishes to monitor. The future deliveries will have their respective expiry date post dated with reference to their ETA.

The supplier is expected to acknowledge the notice by indicating Carrier name, Master Air Way Bill (MAWB), Departure date-time and shipped quantity.

Send Enquiry to Second-Sourced Vendor (Primary Action)

Second sourced vendor is defined as qualified vendor who does not have any open POs. The vendor is a viable and immediate source without the need to perform qualification.

Using Part Number as reference, check for second sourced vendor(s). If second sourced vendor(s) existed, retrieve the vendor's user account ID, vendor's user email addresses, OH QTY and the GrossREQT quantity for a predefined number of days (the scan period).

Calculate ETAss and QTYss

Calculate the OH QTY for the entire predefined number of days using the equation:

OH_{—}QTY date 1=OH QTY date0−GrossREQT date1+PO QTY date 1

When the OH_QTY date N is less than the purchase reorder point, set ETAss as the date before the re-order point is breached.

Set QTYss=target DOS×Average daily GrossREQT

Repeat the computation up to the scan period.

Search AVL for Alternate Supply

The supplier from the AVL is typically not qualified. Additional activities such as request for quotation and qualification need to happen before parts from the AVL can be used.

Using Part number, search the ERP raw database for approved vendors within the AVL. If approved vendor(s) were available, then proceed to create a RFQ message.

The RFQ message contains information such as part specifications or drawing, average monthly GrossREQT, a desire pricing structure such as quantity break pricing, cumulative volume break pricing etc.

Forward the RFQ message to the vendor mailbox if mailbox is available. Otherwise, send a copy in email format to the vendor email address. The email may includes a hotlink to a temporary user screen to capture reply from non registered vendor.

Pull in (Primary Action)

Expedite PO deliveries from active vendors to prevent shortage.

Using part number, retrieve OH QTY, GrossREQT for the next X number of days, open PO reference, PO QTY and ETA, Vendor ID and user account.

Calculate ETApullin and QTYpullin

Calculate the OH QTY for the entire predefined number of days using the equation:

OH_{—}QTY date 1=OH QTY date0−GrossREQT date1+PO QTY date 1

When the OH_QTY date N is less than the purchase reorder point, set ETApullin as the date before the re-order point (quantity) is breached.

Set QTYpullin=Next Immediate open PO's ordered QTY

Factor in the pullin PO QTY and continue the OH_QTYdateN calculation. Insert the next available PO QTY when the re-order point has been breached. Continue the pullin calculation until the predefined X number of days is reached.

Create the Pull In message, segregated by vendor, indicating the derived QTYpullin1,2,3, ETA pullin1,2,3 and the corresponding PO reference number.

Backup Pull in (Primary Action)

The Backup pull in action is similar to pull in action in every aspects other than the higher safety margin. The redundant margin is incorporated to hedge against the higher risk of recurring shortage problem.

Top up Pull in (Primary Action)

This action is only applicable in cases where there are more than one active vendors. In response to a failed pullin attempt, the other vendors are asked to compensate for the short fall.

When a vendor failed to fulfill the entire requested QTY on the specified ETA date, the shortfall in QTY is calculated: QTY shortfall=QTY request−QTY ack

Send the QTYshortfall request to the vendor who has not failed or replied to any pullin request.

The Top Up Pull in message includes part number, all QTYshortfall and corresponding ETA date.

Post Spot Purchase in B2B Exchange

This action requires integration with a Business to Business (B2B) portal. Without the connection to any B2B portal, the recommendation will be published to the user in an action detail screen, which is an interface viewed by a user of the system to show details of the corrective action.

Using Part Number and Vendor ID as reference, retrieve the part specifications and the average daily GrossREQT.

Calculate the OH_QTY for the entire predefined number of days. When the OH_QTY date N is less than the purchase reorder point, set ETA to buy as the date before the re-order point is breached.

Set QTY to buy=target DOS×Average daily GrossREQT.

Repeat the purchase calculation until a predefined window.

Post the request to buy in a predefined B2B portal in an integrated environment, otherwise, publish the purchase request to the user (buyer).

Validate Capacity (Tooling and Line)

Using part number and vendor ID as reference, retrieve the capacity and the corresponding GrossREQT in the monthly bucket.

Compute Delta CAP=Monthly Capacity−Monthly GrossREQT.

If the Delta CAP is negative, (i.e., insufficient capacity) publish an alert message to the user.

Optimize Delivery with Production Schedule

This process will initiate rescheduling to mitigate the impact of shortages.

Using part number as reference, retrieve the OH QTY, accepted or acknowledged PO, NON PO QTY, ETA, Daily GrossREQT, corrective actions details.

Calculate the OH QTY for the entire predefined number of days using the equation:

OH_{—}QTY date 1=OH QTY date0−GrossREQT date1+PO/NON PO QTY date1 (where PO/NON PO QTY date1 is all supplies from any vendors on date 1).

Identified and highlight all the shortage quantities and the corresponding shortage dates. Published the Implication computation to the planner according to the distribution list.

Request Vendor to Stop All Activities

Using Part Number and vendor ID as reference, retrieve OH QTY, GrossREQT up to lead-time, all PO reference number, QTY and ETA.

Calculate Current Liability where Current Liability=(OH QTY+all PO QTYs)×standard cost/unit.

Publish the Message listing all open PO references, QTY and ETA and a request to stop all activities. The message will require the supplier to update the aggregated cost of stopping all activities.

Push Out (Primary Action)

Using part number as reference, this function retrieves all open PO QTY, ETA, PO references from the ERP raw data database 9, vendor ID, vendor's user Account ID, DOS, Target DOS, OH QTY, GrossREQT up to X month and Lead-time (LT).

Push out is disallowed within Y days from run date.

Aggregate all open PO QTY (Agg_open_PO_QTY).

Aggregate GrossREQT up to LT+M days (Agg_GrossREQT_LTM).

If OH QTY−Agg_GrossREQT_LTM is more than zero, activate Cancel PO to cancel all Pos.

There are at least two methods to calculate ETApushout1 (i.e., pushout date) and QTYpushout1 (i.e., pushout quantity).

The computation can either be using the OH QTY calculation as discussed in Pullin or the DOS approximation method.

DOS Approximation Method

First calculate Delta DOS (equals to DOS−Target DOS). Using run date as reference, set the push out date (ETApushout1) as run date+delta DOS−safety days.

If the immediate next PO's ETA is earlier than the proposed push out date ETApushout1, set the push out quantity (QTYpushout1) as the identified PO quantity.

Evaluate if after factoring the push out, liability has exceeded the cancellation threshold: If OH QTY−Agg_GrossREQT_LTM+QTYpushout1 is more than zero.

Activate Cancel Order to cancel all subsequent POs if the threshold has been exceeded.

Else, repeat the push out calculation using a new DOS, derived using the GrossREQT within the push out period.

Stop the push out calculation when all POs have been pushed out to a new date or when the cancellation threshold has been exceeded.

Re-Activate Push Out

This is a dependent action. The objective is to push out open POs that have not been successfully cancelled.

Using part number as reference, retrieves all open PO QTY, ETA, PO references, vendor ID, vendor's user Account ID, DOS, Target DOS, OH QTY, GrossREQT up to X months, Lead-time (LT), cancellation threshold date (LTM), projected OH QTY as of cancellation threshold date, requested and acknowledged POs identified for cancellation.

Check if there are GrossREQT beyond the cancellation threshold: Agg_GrossREQT (LTM) to (LTM+90)=0.

Stop Reactivate Push Out action if there are no requirement beyond cancellation threshold. Else, calculate the push date for the first unsuccessful PO cancellation.

Compute number of days to be pushed out (Days_repushout)={(OH QTY date=LTM)/Ave_GrossREQT_Daily}−Target DOS.

Where Ave_GrossREQT_Daily is the daily average GrossREQT from the threshold day (LTM) onwards.

Set ETA repushout1=Date LTM+Days_repushout−safety days.

Set QTY repushout1=earliest not cancelled PO QTY.

Repeat the reactivation computation if there were more unsuccessful cancellation that needed to be pushed out.

Stop the reactivation computation when all unsuccessful cancellations have been re-pushed out to a new date.

Cancel Orders (Primary Action)

Using part number as reference, retrieves all open PO QTY, ETA, PO references, vendor ID, vendor's user Account ID, DOS, Target DOS, OH QTY, GrossREQT up to lead-time+M days, Lead-time (LT) and Unit price.

Aggregate all open PO QTY (Agg_open_PO_QTY)

Aggregate GrossREQT up to LT+M days (Agg_GrossREQT_LTM)

Cancel all open POs if DOS is more than 999 or If OH QTY−Agg_GrossREQT_LTM is more than zero

If OH QTY−Agg_GrossREQT_LTM is less than zero, set cancel threshold=OH QTY−Agg_GrossREQT_LTM

Cumulate individual PO QTY in chronological order (from early to late delivery date) until the aggregated value exceed the cancel threshold quantity. All PO QTY not require to fulfill the cancel threshold requirement are set aside for cancellation.

Rebalance PO (Substantially Same as Pull in+Cancel Order) (Primary Action)

Using the part number as reference, this action retrieves all open PO QTY, ETA, PO references, vendor ID, vendor's user Account ID, DOS, Target DOS, OH QTY, GrossREQT up to lead-time+M days, Lead-time (LT) and Unit price.

Aggregate all open PO QTY (Agg_open_PO_QTY).

Aggregate GrossREQT up to LT+M days (Agg_GrossREQT_LTM).

If DOS is more than 999 or If OH QTY−Agg_GrossREQT_LTM is more than zero, activate Cancel Order.

Else, calculate ETApullin and QTYpullin.

Calculate the OH QTY for the entire predefined number of days using the equation:

OH_{—}QTY date 1=OH QTY date0−GrossREQT date1+PO QTY date 1.

When the OH_QTY date N is less than the purchase reorder point, set ETApullin as the date before the re-order point (quantity) is breached.

Set QTYpullin=Next Immediate open PO's ordered QTY.

Factor in the pullin PO QTY and continue the OH_QTYdateN calculation. Insert the next available PO QTY when the re-order point has been breached. Continue the pullin calculation until the predefined Y number of days is reached.

Create the Pull In message, segregated by vendor, indicating the derived QTYpullin1,2,3, ETApullin1,2,3 and the corresponding PO reference number.

Inform Vendor of Inventory Buildup

Using Part Number as reference, retrieve vendor ID and vendor user Account ID.

Create and publish a generic alert message in the vendor mailbox. The message highlight the risk of cumulating inventory.

Post Excess for Sale in B2B Exchange

This action requires integration with a Business to Business (B2B) portal. Without the connection to any B2B portal, the recommendation will be published to the user in the action detail screen.

Using Part Number and Vendor ID as reference, retrieve the part specifications, the average daily GrossREQT and OH QTY.

If DOS>999, then set the quantity to sell as the On Hand Quantity.

If 15<DOS<999, then set quantity to sell as excess on hand quantity less aggregate GrossREQT up to lead-time. If there are no excess, then set the quantity to sell as zero.

Post the request to Sell in a predefined B2B portal in an integrated environment, otherwise, publish the sale request to the user (buyer).

Part Obsolescence Report

This reporting function is used for evaluating excess or obsolete of common and unique part. The ownership of obsolescence is segregated by considering within lead-time changes and usage by parent.

Using part number as reference, retrieves all open PO QTY, ETA, PO references, vendor ID, vendor's user Account ID, DOS, Target DOS, OH QTY, GrossREQT up to lead-time+M days, Lead-time (LT) Unit price, and GrossREQTs of unique parts associated with the parent(s).

For part with more than one parent part, check the parent proxy forecast table for GrossREQT data. The proxy table presents the GrossREQT of the different Parent parts. If no data are available, derive the proxy GrossREQT data.

Computation of Proxy Gross Requirement of Parent Part

From all the associated Parent's Bill of Material (BOM), identify K number of longest-leadtime unique parts that do not have any association with other parent parts.

The user can define the unique parts instead of the algorithm searching for unique from the BOM.

Retrieve the GrossREQT of the selected unique parts from the ERP and normalize the values by dividing the GrossREQT by the quantity usage per parent (qty per).

Group all GrossREQT in accordance to the ETA into daily, weekly or monthly bucket.

Assuming that weekly bucket is used, calculate average of the selected unique parts' normalized GrossREQT in weekly bucket until lead-time.

Populate the average normalized value into the GrossREQT_proxy_table for reference. Each parent proxy table is unique to a parent.

Allocating Percentage for Each Parent

Using the part number, retrieve all the associated Parent part numbers and the corresponding quantity usage per parent (qty per).

Retrieve the GrossREQTproxy information from the appropriate GrossREQT_proxy_table. Denormalize the data by multiplying the GrossREQTproxy by the qty per.

Aggregate the denormalized GrossREQTproxy from current run date till Leadtime (Agg_GrossREQTparent A: proxy till leadtime).

Allocation %=Agg_GrossREQTparent A proxy till leadtime/Sum of all associated Agg_GrossREQTparent A,B,C . . . proxy till leadtime.

Repeat the allocation calculation for all other associated parent parts.

Liability Computation

For common parts, the Proxy Gross Requirement calculation will have to be repeated for all historical GrossREQT releases that are needed to compute the within lead-time cumulative delta. All GrossREQTproxy data needs to be denormalized (multiply by qty per) before further calculation.

For unique part, historical GrossREQT releases are extracted for immediate liability calculation.

The historical GrossREQT releases are retrieved in reverse chronological order, back dated to the start of the lead-time using current date as reference. For example, If the lead-time were 60 days, then retrieve previous 60 days worth of GrossREQT releases. Each of these releases contains GrossREQT information up to lead-time with respect to the release time stamp.

For each releases of GrossREQT plan, group all GrossREQT into the appropriate time bucket according to its ETA date. The time bucket can be in day, week or month.

In reverse chronological order, starting from current GrossREQT releases or plan, compute the delta of current versus the immediate previous GrossREQT plan. As the amount of information varies for each GrossREQT plans because of the rolling lead-time window, only the matching time bucket of the compared plans are calculated. Ignore the computation if there were no matching time bucket.

The example illustrates a rolling lead-time window of 3 weeks. The matching time buckets for GrossREQT released during period N and N−1 are week N and N+1. The matching time buckets for GrossREQT released during period N−1 and N−2 are week N−1 and N, as illustrated in Table 10, which shows an example of computation of release over a time bucket of weeks, for the foregoing calculation of liability.

TABLE 10

| | week | Week | Week | week | Week |
|---|---|---|---|---|---|
| | N − 2 | N − 1 | N | N + 1 | N + 2 |
| Period N release | | | 120 | 110 | 110 |
| Period N − 1 | | 100 | 100 | 130 | |
| release | | | | | |
| Period N − 2 | 100 | 90 | 80 | | |
| release | | | | | |

Computation of GrossREQT Delta in Unit:

GrossREQT Delta in unit for each matching time bucket=GrossREQTrelease period N for time bucket N−GrossREQTrelease period N−1 for time bucket N.

Aggregate the Delta GrossREQT for all matching time bucket and all release period chosen for comparisons (Cum_Delta_GrossREQT).

If the Cum_Delta_GrossREQT is negative, set Historical liability in unit=absolute value of Cum_Delta_GrossREQT.

If the Cum_Delta_GrossREQT is positive, set Historical liability in unit=zero.

For common parts, the liability has to be calculated for every associated parent parts.

Total, Justifiable & Unjustifiable Liability Computation

If DOS is more than X (e.g. 240, one year worth), then set Target OH Qty=0.

If DOS is less than 240, then use Target OH Qty derived from last GrossREQT release data.

Total liability in unit=OH Qty+Agg_Open_PO_Qty.

Total Justifiable liability in unit={Historical Liabilityparent A+Target OH QTYparent A+Agg_GrossREQT parent A proxy till leadtime}+{Historical Liabilityparent B+Target OH QTYparent B+Agg_GrossREQT parent B proxy till leadtime}+{Historical Liabilityparent C+Target OH QTYparent C+Agg_GrossREQT parent C proxy till leadtime}+ . . . all associated parents.

Total Unjustifiable liability in unit=Total liability−Total Justifiable liability in unit.

Total Unjustifiable liability is zero if Total liability<Total Justifiable liability.

Total Effective Liability in unit=Total liability or Total Justifiable Liability, dependent on the user setting. OEM user may set Total Effective Liability as the lower value of Total liability or Total Justifiable liability. EMS user may set Total Effective Liability as the Total liability.

Projected Obsolescence=Total liability−Agg_GrossREQTEOL.

Where Agg_GrossREQTEOL is the aggregate GrossREQT until End of Life.

Apportioning Mechanism for Common Parts

The objective is to segregate the various liability component by parent.

Apportioned Total Liability parent A,B,C . . . =Allocation % parent A,B,C . . . ×Total Liability.

The Allocation % parent A,B,C . . . is derived according to the allocation module.

Justifiable liability is always calculated by parent basis. I.e., it is already apportioned.

Apportioned Unjustifiable liability (applicable only if value>0)=Apportioned Total Liability−Justifiable Liability.

Apportioned Effective Liability=Apportioned Total liability for EMS user; lower value of Apportioned Total liability Or Justifiable Liability for OEM user.

Apportioning Projected Obsolescence

If Total Justifiable Liability is more than Total Projected Obsolescence, then the Apportioned Projected Obsolescence parent N={Justifiable Liability parent N/Total Justifiable Liability}×Total Projected Obsolescence.

If Total Justifiable Liability is Less than Total Projected Obsolescence, then the Apportioned Projected Obsolescence parent N=Justifiable Liability parent N+(Projected Obsolescence−Total Justifiable Liability)×Allocation % parent N.

Check for Obsolescence Exposure by Parent Part

This function generates obsolescence report of all Bill Of Materials (BOM) parts associated with a specific parent. The function attributes ownership of excess or obsolescence by considering leadtime and historical plan changes to unique and common parts. Unique part possesses only one parent association. Common part has more than one parent association.

Using the PARENT part number, this action retrieves the BOM, all the part numbers associated with the BOM, lead-time of all BOM parts, Qty per of all BOM parts, other parent parts with association to any of the BOM parts, standard cost (Std Cost) of all BOM parts, OH QTY of all BOM parts, Open POs of all BOM parts, GrossREQT of all BOM parts and previously released GrossREQT plan (back dated according to leadtime) for all unique BOM Parts.

The approach is first to determine if the part is in an ongoing-condition, with a requirement beyond lead-time, or an EOL-condition, with no requirement beyond lead-time. The function will then invoke full computational method or partial update depending on whether there are any existing records in the End of Life (Mark) table.

All full computation or partial Update for COMMON parts will require information from the parent proxy table to apportion liability and obsolescence.

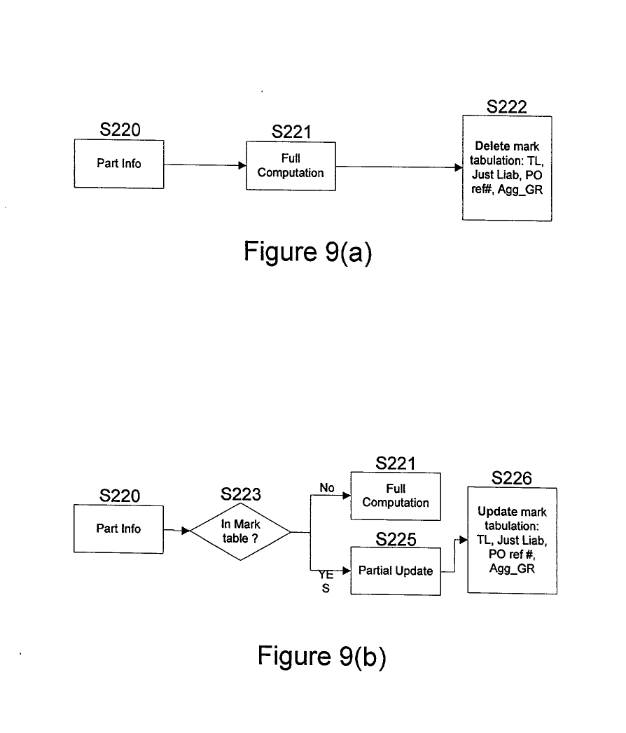

FIGS. 9(a) and 9(b) illustrate ongoing and end of life (EOL) obsolescence computation according to the present invention. At step S220 of FIG. 9(a), part information is generated, and a full computation is performed at step S221, as described below. At step S222, a delete operation is performed for mark tabulation (i.e., TL, Just Liab, PO ref#, Agg_GR).

Steps S220 and S221 of FIG. 9(b) are substantially similar to that of FIG. 9(a), and the description is not repeated here. However, after step S220, at step S223, a determination is made as to whether the part information is in the Mark table. If the part information is in the Mark table, then a partial update is performed at step S225, and the full update function is performed for mark tabulation (i.e., TL, Just Liab, PO ref#, Agg_GR) at step S226. If the part information is not in the Mark table, then a full computation is performed as described above with respect to step S221.

Process Flow of Ongoing and EOL Condition

Part is categorized as satisfying the ongoing condition if the aggregate GrossREQT between lead-time and 90 days beyond lead-time is zero. Otherwise, the part is categorized as EOL condition.

Check the Mark table (tbl_parent_obs_threshold) for data on Total liability, Total Justifiable Liability, Aggregate GrossREQT, PO reference numbers, QTY and ETA.

For an ongoing condition with or without records in the Mark table, activate a full computation and refresh the data in Mark table every run.

For an EOL condition with records in the Mark table, activate a partial update of the Mark records. For EOL condition without records in the Mark table, activate a full computation.

Full Computation for Common and Unique Parts

The computational process is similar to the previous action called Part Obsolescence Report.

Partial Update for Common and Unique Parts

Partial Update is invoked if the part remains in the EOL condition during the second or subsequent invocation of the parent obsolescence check. All data derived from the first run is suffixed as initial. When the time of generation to EOL matches the lead-time, the condition is called Mark. In the following paragraphs, the parent under evaluation is referred as parent A.

Retrieve the initial and current On Hand (OHcurrent & OHinitial), the initial and current Opened PO QTY & ETA, the initial and current gross requirement up to lead-time (GrossREQTinital to LT & GrossREQTcurrent to LT).

Compute the initial and current aggregate open POs (Agg_Open_PO_Qtyinitial and Agg_Open_PO_Qtycurrent respectively).

If there are no new POs, then compute Total Liabilitycurrent=OHcurrent+Agg_open_PO_QTYcurrent

If Total Liabilitycurrent<GrossREQTcurrent to LT, then set current Projected Obsolescence POcurrent=0

If there are new POs, proceed to the parent apportioning process and publish the following notification to the obsolescence report: “Total liability has exceeded requirement up to lead-time. The system has detected new PO(s). Please re-validate the need to launch new PO(s).”

Partial Update Process for Common Parts

Retrieve the previously calculated apportioned initial Total liability (TL parentA: initial), the previously calculated apportioned aggregate initial GrossREQT (Agg_GRparentA:initial) and the current apportioned GrossREQT (GrossREQT parentA:current).

The current apportioned GrossREQT (GrossREQT parentA:current) is derived by denormalizing data from the parent A proxy Table (i.e., multiply the GrossREQT parentA from the proxy table by the qty per of the part in question). After that, aggregate the current apportioned GrossREQT (Agg_GR parentA:current).

Compute the Agg_Delta_GrossREQT parentA: initial vs current=Agg_GR parentA: initial (initial to current LT)−Agg_GR parentA: current (initial to current LT) (both Agg_GR values contain GrossREQT information over a fixed and matching period starting from initial run date and ending on lead-time based on current run date)

Compute the current apportioned Total liability (TL ParentA: current)=TL parentA:initial−(Agg_GRparentA:initial−Agg_GRparentA:current)+Agg_Delta_GrossREQT parentA: initial vs current

Where consumption is defined as Agg_GRparent:A:initial−Agg_GRparentA:current+Agg_Delta_GrossREQT initial vs current

Retrieve the apportioned Initial Projected Obsolescence (PO parentA: initial)

Compute the apportioned current Projected Obsolescence (PO parentA: current)=TLparentA:current−Agg_GR parentA:current

Calculate Draw Down on Parent's Liability

Draw Down is defined as the liability attributed to parent A being consumed by other parent parts.

Compute the current Total liability (TL current)=(OH+Agg_open_PO_QTY) current

Compute the Other Parents' initial Total Liability (TL other: initial)=TL initial−TLparentA:initial

Compute the Other Parents current Total Liability (TL other: current)=TL current−TLparentA:current

Compute the Other Parents' aggregate GrossREQT within leadtime (Agg_GRother: current to LT)=Agg_GR current to LT−Agg_GRparentA: current to LT

Compute Other Parents' current Target OH (Target OH other: current)=(Agg_GRother:current to LT/LT in days)×Target DOS

If TL other: current>(Agg_GRother: current to LT+Target OH other:current), then set Draw down=0

If TL other: current<(Agg_GRother: current to LT+Target OH other:current), then

Draw down=Agg_GRother: current to LT+Target OH other: current−TL other: current

If Draw down>PO parentA: initial, then set Projected Obsolescence current=0

Else, set Projected Obsolescence current=PO parent: initial−Draw down

Partial Update Process for Unique Parts

Retrieve the initial Total liability, the initial Projected Obsolescence, GrossREQT until EOL or 12 months (whichever period is shorter), the Current On Hand and the Current Opened PO QTY

Calculate Total liability (TLcurrent)=OH Qty current+Agg_Open_PO_Qty current

Calculate current Projected Obsolescence (POcurrent)=Total liability current−Agg_GRcurrent to EOL (the term is same as Agg_GrossREQT within LT)

Set current Effective Liability=the lower of TL current or Justifiable liability initial

List the Exposure report, Exposure Report by Parent Part

Measure External Market Indicators

Search and consolidate relevant market information such as the Purchasing manager Index, Inventory Index, Industry growth projection, Spot Market price movement of specific components (e.g. DRAM) and Lead-time of selected components.

These external Market indicators are incorporated in the system manually (via user interface) or automatically (translating fixed format messages into data).

The selected data are transformed into a quantitative scale that is indicative of the market condition; insufficient or excessive supply of semi-conductor, growing or shrinking demand etc.

The quantitative scale can be used in the categorization or action trigger process to further qualify the risk associated with assurance of supply.

Actions are Unique to Cost Management

This list is on illustrative, and other actions may be envisioned by one of ordinary skill in the art.

List Cost Reduction Opportunities

List the potential Cost Reduction part number candidates in descending order of magnitude in Average Monthly Purchase cost (AMP).

Reconfirm Price With Vendor

Using part number and vendor ID as reference, retrieve Vendor user account ID, Vendor user email addresses, currency, document type (PO, CO or Inv), the corresponding document ID and the Unit Price.

Create the reconfirmation message listing the Unit price from the transaction document and the ERP system.

Inform Vendor of Historical Events

Using Part Number and vendor ID as reference, retrieve the Vendor user account ID,

Vendor email addresses, Part History.

Send the Message containing Part Number and Historical occurrence (date and nature of problems) to the vendor.

Request Acknowledgement of Issue.

Recommend Target Pricing

Using Part Number and Vendor ID as reference, retrieve the Cost reduction targets, currency and Unit Price (or alternately the standard cost), and the vendor composite risk index if available.

If Reduction Target for indicated period is available, set target Price for period N=UP*(100%−Reduction %). Repeat the procedure until all periods has been completed

Update the computed target prices for different period in the Cost Table. Publish the information in the Cost Reduction Table.

Publish the results to the buyer/manager.

Benchmark Prices

Using Part Number as reference, retrieve all the qualified Vendor IDs, the corresponding account ID and email information, Currency and Unit prices that correspond to each Vendor ID and the vendor composite risk index if available. The qualified vendors are approved for purchases.

Benchmark the Unit Price of different vendors and publish the result to the buyer. Compute the average unit price based on a predefined historical or future period.

Consolidate Purchasing

Using Vendor ID as reference, retrieve all part numbers associated with the vendor ID, currency, unit price, predefined X forward looking months worth of GrossREQT for each identified part number to facilitate GrossREQTave calculation, and the vendor composite risk index if available.

List all identified Part Numbers with the corresponding business allocation percentage.

Compute the estimated Total monthly purchase dollar for each identified part number regardless of business allocation. Aggregate the Total monthly purchase dollar for all the identified parts (Agg_Total_Pur$_All).

For each identified part number, compute the estimated monthly purchase dollar attributed to the reference vendor ID. Aggregate the all the attributed to reference vendor's monthly purchase dollars (Agg_Total_Pur$_Vendor).

Estimate the total available unallocated purchase dollars=Agg_Total_Pur$_All−Agg_Total_Pur$_Vendor

Publish the total available unallocated purchase dollars to the buyer/manager.

Post RFQ at B2B Exchanges

This action requires integration with a Business to Business (B2B) portal. Without the connection to any B2B, the recommendation will be published to the user in the action detail screen.

Using Part Number and Vendor ID as reference, retrieve the part number, Specifications and the average monthly GrossREQT.

Post the request to buy in a predefined B2B portal in an integrated environment, otherwise, publish the purchase request to the user (buyer).

The response agent focuses on improving the flexibility and responsiveness of the backend supply chain. The key performance indicators are leadtime and message response time. Leadtime is defined as the time lapse between order activation and good delivery (or estimated Time of Arrival, i.e., ETA). The design will cater for additional responses parameters in the future releases.

Additional detail of the management of quality issues is described in greater detail herein.

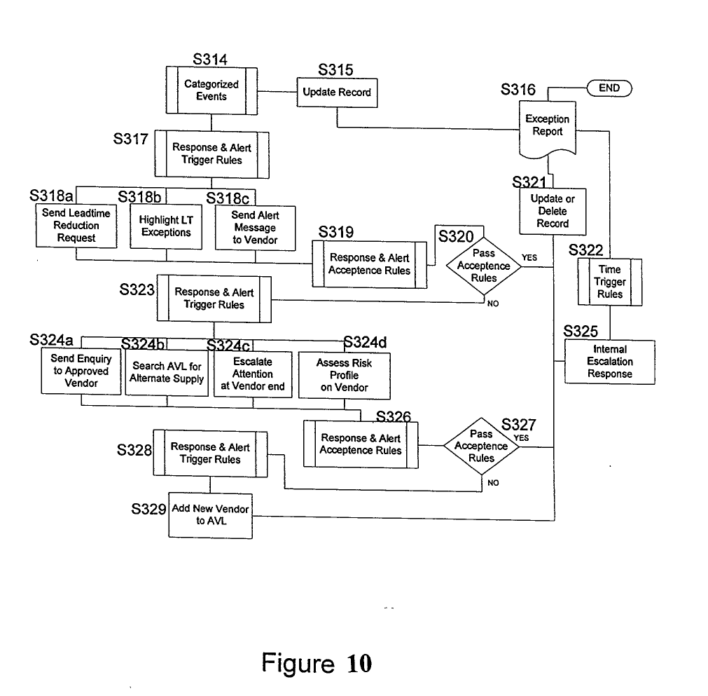

FIG. 10 illustrates the response action tree. At step S314, categorization is completed. Then, a record update step occurs at S315, to update the databases 10, 11. From the updated record information, an exception report that documents the exception and can be used to indicate responsiveness of the overall procurement process is generated at step S316.

Simultaneously with step S315, in step S317, response and alert trigger rules are activated, as described above with respect to the action module 4 and the auto trigger manager 5. After step S317, the action modules are activated, and the corrective actions are taken as described above. For example, but not by way of limitation, a lead time reduction request is sent in step S318a, leadtime exceptions are highlighted at step S318b, and in step S318c, an alert message is sent to the vendor (e.g., indicating a late response or a mismatch, and requesting action and/or reply). Steps S318a-S318c are performed simultaneously.

A step S319, response and alert acceptance rules are applied, and at step S320, it is determined whether the acceptance rules have been passed (e.g., whether the exception event has been solved by the IPA). If acceptance has occurred, then the record is updated or deleted in step S321, and step S316 is performed as described above.

However, if acceptance has not occurred and the exception event has still not been solved (e.g., there is still a responsiveness problem), then at step S323, the response and alert trigger rules are applied again by the action manager 4 and the auto trigger manager 5. Additional corrective actions are performed simultaneously at steps S324a-S324d. For example, but not by way of limitation, S324a may include sending an inquiry to an approved vendor, step S324b may include searching an approved vendor list (AVL) for an alternate supply, step S324c may include escalating attention at the vendor end, and/or step S324d may include assessing a risk profile of the vendor.

Once those actions have been completed, at step S326, response and alert acceptance rules are applied as described with respect to FIGS. 2, 3(a) and 3(b) and above, and at step S327, it is determined whether the actions have resulted in a passing acceptance. If there is acceptance, then steps S321 and S316 are performed in a manner substantially similar to that described above. Additionally, at step S322, a time trigger may result in the triggering of additional actions, such as an internal escalation response at step S325, or creation of an exception report at step S316.

If the actions of steps S324a-S324d did not result in a passing of the acceptance tests at step S327, then at step S328, the response and alert trigger rules are applied, as disclosed and discussed in greater detail above (e.g., step S323). Then, an appropriate action is taken at step S329, such as adding a new vendor to the AVL so as to overcome the response problem associated with the current vendor. Then, steps S321 and S316 are performed in a manner substantially similar to that described above.

Overall Process Logic

The Response is triggered by a change in the extracted external databases, responses from users or predefine event such as expiry of action or a time base periodic batch processing. This function track and evaluate the response time stamp, contents of response, and the target leadtime versus the actual leadtime. Leadtime is defined as the time between PO Activation and actual good delivery.

Generic Inputs

The generic inputs are provided below in Table 12. Further, the description below follows the foregoing description of FIGS. 2, 3(a) and 3(b).

TABLE 12

| | |
|---|---|
| 1 | Part Number |
| 2 | Part Description |
| 3 | PO Number |
| 4 | PO line Number |
| 5 | PO Quantity |
| 6 | PO Expected Time of Arrival |
| 7 | PO Time Stamp |
| 8 | PO Unit Price |
| 9 | PO Quantity Received |
| 10 | Acknowledged PO Quantity |
| 11 | Acknowledged PO Expected Time of Arrival |
| 12 | Acknowledged PO Time Stamp |
| 13 | Target Lead-time |
| 14 | Vendor ID |
| 15 | Vendor Name |
| 16 | Vendor Forecast Quantity |
| 17 | Vendor Forecast ETA |
| 18 | Forecast Tame stamp |
| 19 | Acknowledged Vendor Forecast Quantity |
| 20 | Acknowledged Vendor Forecast ETA |
| 21 | Acknowledged Forecast Time stamp |
| 22 | Change Order (CO) Number |
| 23 | CO Quantity |
| 24 | CO Expected Time of Arrival |
| 25 | CO Time Stamp |
| 26 | CO Unit Price |
| 27 | Acknowledged CO Quantity |
| 28 | Acknowledged CO Expected Time of Arrival |
| 29 | Acknowledged CO Time Stamp |
| 30 | Acknowledged CO Unit Price |
| 31 | Request For Quotation (RFQ) time stamp |
| 32 | Acknowledged RFQ time stamp |
| 33 | Shipping Notice (SN) time stamp |
| 34 | Acknowledged SN time stamp |
| 35 | Invoice's PO reference |
| 36 | Invoice's QTY |
| 37 | Invoice's Price |

Phase One: Event Categorization

The categorization manager 2 uses the inputs from the generic input table to analyze the response situation of each part number. The Categorization analysis are Responsiveness Evaluation and Lead-time Evaluation.

Responsiveness Evaluation

This function monitors the responsiveness of suppliers.

Inputs

The sent and acknowledged message's Time stamp and contents (QTY, ETA and Price) are inputs.

Computations

All comparisons are between acknowledged and sent document's quantity, ETA and time stamp. The documents are PO, CO, Forecast and RFQ. The Invoice document is only subjected to content validation. The following computations are performed:

Evaluate Instantaneous Performance

Time Stamp Comparison

Here, time lapse of unacknowledged messages (TLUM)=time stamp of date of evaluation minus the timestamp of message sent, and Time lapse of acknowledged messages (TLAM)=timestamp of acknowledged message minus the timestamp of message sent.

Contents Comparison is performed as follows:

Check if acknowledged Quantity is between a tolerance +/−X % of requested quantity.

Check if acknowledged ETA is equal or Y days later than sent ETA.

Compute the Mean, Maximum and Minimum of all TLAM and TLUM within a predefined time bucket. TLAM and TLUM are treated as one common population.

Evaluate cumulative performance is performed as follows. This computation provides up-to-date results in predefined time bucket, monthly or quarterly. The user will determine the maximum historical visibility of the computation.

Using the time bucket as reference, records the aggregate to date occurrences of all Cat X incidents segregated by the Category grouping.

Aggregate the occurrences of all categories (sum_all_instants_all_Cat).

Calculate the Performance percentage for each Cat X=(sum_CatX_events)/(sum_all_instants_all_Cat)

Output

The output is the response report within the processed database.

Lead-time Evaluation

Leadtime affects the flexibility and liability of a manufacturing business. Shorter lead-time enable quicker response to changes, lower inventory commitment, lower risk to eroding price trend and obsolescence.

Inputs

The inputs are the unit Price, PO time stamp, new PO ETA, the Lead-time from the ERP raw database and the Lead-time Target from the processed database.

Computations

Compute the LeadtimePrice Index (LTP index)=Lead-time×Unit Price.

This composite index amalgamates both lead-time and price to facilitate segregation of long lead-time and expensive parts from the lesser components.

Sort the index list in descending order of magnitude. Assign the category according to user's predefined percentile. For example, categorize the highest 20% as Cat 1, the next 30% as Cat 2 and so on. Within the sorted list, identifies part with lead-time equal or above the attention needed threshold.

Actual versus Target Lead-time Comparison is performed as follows:

Lead-time may be broken into components such as Order lead-time, transit lead-time, administrative lead-time and safety lead-time. The actual versus Target function compares the aggregate of all lead-time sub-components. Target lead-time is predefined by user, and is stored in the processed database.

Compute Actual Lead-time (ALT)=The first new ETA−issue date of the same PO.

Compute the delta between Actual vs Target=TarLT (days)−ActLT (days).

Output

The output is the response report within the processed database.

The Response and Lead-time report within the processed database is shown in

TABLE 13

| | |
|---|---|
| 1 | Part Number |
| 2 | Unit Price |
| 3 | Transaction Type |
| 4 | Transaction Ref # |
| 5 | Delta QTY |
| 6 | Delta ETA |
| 7 | Delta Time Stamp |
| 8 | Category |
| 9 | Exception |
| 10 | Create date time |
| 11 | Delta Lead-time |
| 12 | LTP index |
| 13 | Mean |
| 14 | Maximum |
| 15 | Minimum |
| 16 | Performance Percentage for each Cat |
| 17 | Count for each Cat |

Categorization Logic

Categorize the exception events based on criteria listed in the Response report. The primary criteria should be indicative of the level of responsiveness in supply. The categorization rules, hosted in the Rules and Logic Metadata unit 12, can be based on more than one criteria. An example of the response categorization is listed below in Table 14.

TABLE 14

| | Category 5 | Category 4 | Category 3 | Category 2 | Category 1 |
|---|---|---|---|---|---|
| Timeliness of | within 3 | 4 to 5 days | within 3 | 4 to 5 days | 6 or more |
| Acknowledgement | days | Late | days | Late | days |
| | On | response | On | response | No response |
| | time/early | | time/Early | | |
| | response | | response | | |
| Contents | Matching | Matching | Mismatched | Mismatched | No content |

The Lead-time categorization, as mentioned in the Lead-time Evaluation section, is considered on a separate basis. The criteria used is percentile of LeadtimePrice index.

Phase Two: Adaptive Execution

Overview

The second phase begins after event categorization. The session manager 3 will segregate the exceptions within the Response report into new or Work-in-Progress events. After that, the action manager 4 uses the evaluated information to extract the appropriate rules and logic to trigger corrective actions. The Rules and Logic set is differentiated by exception category (situation) and commodity type. Each deployment of actions for the categorized situations is tracked as cycle 1, 2, 3 and so on. The action cycle increases as additional actions are triggered in the event of unfavorable response.

Situational Evaluations

The objectives of the trigger logic are to detect minor ad hoc cases of poor responses and major trend of degrading responsiveness from a specific vendor. The vendor's responsiveness is a reflection of their priority assigned toward the buying organization. The ‘impact period’ of the response test is typically mid term, not immediate as in the case of Assurance of Supply. The action manager 4 performs selected additional evaluation on each categorized exception. This process deals with mid term commitment such as PO, FC and RFQ. Examples of the situational checks are listed as follows:

Check #1: C or more response exceptions on record over the last D months

Check #2: current TLUM or TLAM exceeds the Maximum

Check #3: current TLAM or TLUM exceeds the Mean

Check #4: Delta TarLT−ActLT is negative

Check #2: Current TLUM or TLAM exceeds the Expiry Threshold

Check #3: DND more than DOS

Check #4: Shipping Performance<Y %

Check #5: Cumulative Forecast Delta % (Cum_FC_Delta_%)>50%

Check #6: If Predefined Corrective Action Failed

Check #7: If Predefined Corrective Action Expired

Check #8: Delta LeadTime is negative

Check #9: If Part is a Standard Commodity

Corrective Action Execution

Once the action manager 4 has interpreted the evaluated results, specific corrective actions will be activated. Interpretation logic is explained in the foregoing Rules and Logic section. The potential but not exhaustive corrective actions are listed below.

Send Response Alert message to vendor

Escalate Attention at Vendor End

Escalation to Vendor Management

Send Reminder Message

Send Enquiry to ‘Second Sourced’ Vendor

Assess Risk Profile of Vendor

Search AVL for Alternate Supply

Add New Vendor to the AVL

Initiate Lead-time Improvement

DOS Computation

Send Pull in Request

Reconfirm Forecast and PO

Highlight Leadtime Exceptions

Benchmark Lead-time

Send Lead-time Reduction Request

The session manager 3 screens and removes any duplicate actions that were previously deployed for the same exception event.

Next, a trigger manager determines if automatic or manual mode of exception management should be deployed for the affected part number.

For part on manual management mode, the recommended actions are published in the decision support 13 and execution 14 frames. The user selects and activates corrective actions via the Execution frame 14. Activation equates to sending action request messages to the supplier's user mailbox 16.

For part on automatic management mode, the autotrigger manager 5 activates all actions that has been accepted by the session manager 3.

Implication Evaluation on Action

The implication manager 6 will be triggered to check for compliance when suppliers replied or when actions expired without a reply. The implication manager 6 performs (e.g., Absolute Assessment) checks on primary actions to determine if the exception event had been resolved or otherwise. The Absolute Assessment ascertains optimal availability of inventory (On Hand Quantity) within a predefined time window, typically between a lower limit of zero unit and a predefined upper limit for a predefined time period.

Both manually or automatically managed parts are subjected to the same Absolute Assessment check. The generic methodology of performing the check is to aggregate the effects of all acknowledged or accepted primary actions from suppliers. The user may also assign preferences to supplier or action to establish priority. Two typical examples of Absolute Assessment methodologies are First in First Out (FIFO) and Weighted Acceptance (WA). Other prioritization methodologies may be deployed to enable the Absolute Assessment check, as described below.

1. First In First Out (FIFO): All acknowledged primary actions, regardless of whether each action is 100% or partially accepted by supplier, are aggregated in a FIFO manner to match the prevailing demand (GrossREQT).

2. Weighted Acceptance (WA): All acknowledged primary actions, regardless of whether each action is 100% or partially accepted by supplier, are aggregated according to a user defined preferential order. The evaluation will commence if all primary actions have been acknowledged or when the expiry time has lapsed. In the event of similar preference, the acceptance criteria will then resort to FIFO mechanism.

Assessment of Secondary Actions

Secondary actions are not subjected to the Absolute Assessment check. Each secondary action is judged on its own merit, i.e., it has to pass the acceptance criteria. Assessment is triggered by a response or by the expired action time stamp. Acceptance is defined as no deviations between the acknowledged and requested QTY and ETA. Failing the acceptance test will trigger the next cycle corrective action.

Closure Process Flow

The resolution manager 8 performs the tasks of sending acceptance message to the vendor whose primary action has been selected and sending rejection note to the vendor whose primary action has been terminated.

For manually controlled parts, the user is expected to decide on the options of Hold, Accept or Terminate for every activated primary and secondary action. After the user selects the option, the resolution manager 8 will complete the closure process. The HOLD decision or any unselected actions will not invoke any action from the resolution manager 8.

In the case of auto-managed parts, the autoclose manager 7 utilizes results from the Absolute Assessment to decide. The autoclose manager 7 accepts actions that are used to fulfill the Absolute Assessment. All other acknowledged actions that result in ‘out of bound’ net availability will be terminated. The termination includes all outstanding secondary actions.

After the corrective actions have been selected, information pertaining to the accepted action are either uploaded to the ERP system or transferred to the To-Do-List for manual ERP's system update.

The Computation to derive to-do-list is as follows. Changes to existing PO quantity and ETA are factored with reference to the accepted change. Quantity for each PO are adjusted to capture the accepted changes.

Unique Action Modules

This section only lists relevant unique corrective actions from the action module, and is not all-inclusive.

Initiate Lead-Time Improvement

Using part number, retrieve On QTY, standard cost and 12 month worth of GrossREQT.

Use 3 or any number of future months to compute the average monthly GrossREQT (GrossREQTave).

Compute uncommitted 12 month aggregated GrossREQT (Agg_{—}12M_Uncommit_GrossREQT)=OH QTY+Aggregate of 12 months GrossREQT−All open PO QTY.

If the Usage ratio of (Agg_{—}12M_Uncommit_GrossREQT)/(GrossREQTave) is more than Y or any number that signifies months worth of GrossREQT, then set the part aside as lead-time reduction candidates.

To focus on liability reduction, the user may multiply the Usage ratio with the respective standard cost to prioritize.

Benchmark lead-time for part with multiple qualified vendors is as follows. For customized part, recommend a breakdown of lead-time component to facilitate improvement.

Days of Supply (DOS) Computation

Detail Inputs

GrossREQT is the aggregated unassigned forecast requirement

OH_QTY is the On Hand current inventory

Std Cost is the Normalized unit price for accounting purposes

QTYnextPO is the quantity to be delivered in the next PO

ETAnextPO is the expected date of next PO delivery

Computation

Calculate the three months forward looking monthly average GrossREQT: GrossREQT3mthave=[GrossREQT monthN+GrossREQTmonthN+1+GrossREQT monthN+2]/3

Retrieve the Target DOS from the Rules and Logic Metadata 12. Target DOS is a manually defined management goal.

Compute the DOS and OH $ (extended cost) for every part number where DOS=[OH/GrossREQTave]×(20 workdays) and OH $=Extended cost (or price) of part in question=unit price×OH quantity.

Compute the DOS % Delta as DOS % Delta=[(DOS−Target DOS)/Target DOS]×100%.

Calculate Days to Next Delivery (DND) to assess the risk of shortage as DND=ETAnextPO−Date of DOS computation

If DND is less than DOS, then calculate NEXTDOS. (if DND is less, the next delivery is in time to replenish supply), wherein NEXTDOS=[(OH+QTYnextPO)/GrossREQT3mthave]×20 workdays (NEXTDOS includes the next delivery in the DOS computation)

Outputs

The output is the response report within the processed database 10.

DOS30 Computation

The computation utilize aggregates GrossREQT of immediate next 30 days instead of three month average to calculate the Day of Supply. The 30 days value is referred to as DOS30, calculated as follows: DOS30=[OH QTYcurrent/Agg_GrossREQT next 30 days]×20

The quality agent tracks material fallout, activate alert and replenishment when a predetermined % of reject is reached. The rejects are referred to as Non Conformance Materials (NCM).

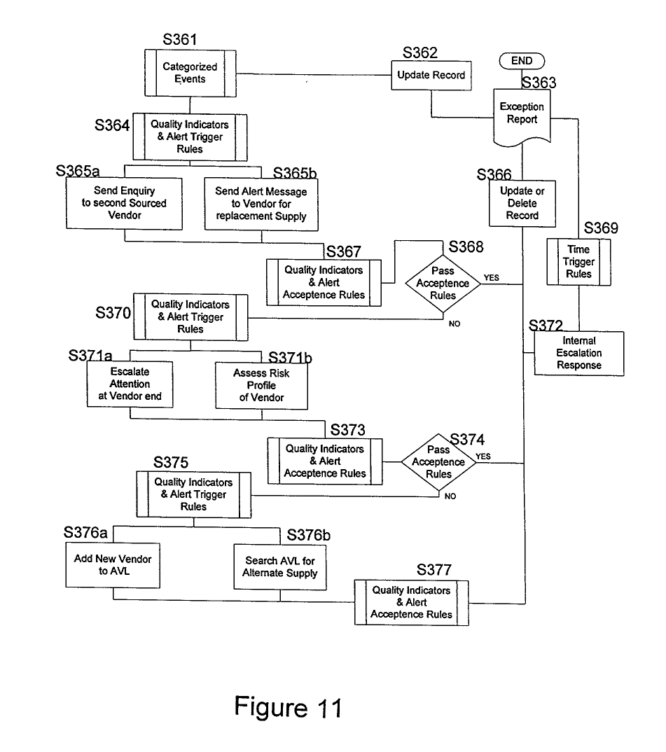

FIG. 11 illustrates the quality agent process flow. At step S361, categorization is completed. Then, and a record update step occurs at S362, to update the databases 10, 11, and indicate the presence of an exception. From the updated record information, at step S363, an exception report is generated to document the exception.

All events are then further processed to handle quality exception events. In step S364, quality indicators and alert trigger rules are activated, as described above with respect to the action module 4 and the auto trigger manager 5.

After step S364, the action modules are activated, and the corrective actions are taken at steps S365a-S365b as described above. For example, but not by way of limitation, an inquiry is sent to a ‘second sourced’ vendor at step S365a (as described herein), and in step S365b, an alert message is sent to the vendor (e.g., indicating that due to quality problems in the current supply, a replacement supply is required). Steps S365a and S365b are performed simultaneously.

At step S367, quality indicators and alert acceptance rules are applied, and at step S372, it is determined whether the acceptance rules have been passed (e.g., whether the exception event has been resolved). If acceptance has occurred, then the record is updated or deleted in step S366, and step S362 is performed as described above.

However, if acceptance has not occurred and the exception event has still not been solved (e.g., there is still a quality problem), then at step S370, the response and alert trigger rules are applied again by the action manager 4 and the auto trigger manager 5. Additional corrective actions are performed simultaneously at steps S371a-S371b. For example, but not by way of limitation, S371a may include escalating attention at the vendor end regarding the problem (e.g., email to supervisor or officer), and step S371b may include assessing a risk profile of a vendor to determine if they are too high of a quality risk.

Once those actions have been completed, at step S373, quality indicators and alert acceptance rules are applied as described with respect to FIGS. 2, 3(a) and 3(b) and above, and at step S374, it is determined whether the actions have resulted in a passing acceptance. If there is acceptance, then steps S366 and S363 are performed in a manner substantially similar to that described above. Additionally, at step S369, a time trigger may result in the triggering of additional actions, such as an internal escalation response at step S372, or creation of an exception report at step S363.

If the actions of steps S371a-S371b do not result in a passing of the acceptance tests at step S374, then at step S375, the quality indicators and alert trigger rules are applied, as disclosed and discussed in greater detail above (e.g., step S370). Then, an appropriate actions are taken at steps S376a and S376b simultaneously, such as adding a new vendor to the AVL (S376a) or searching the AVL for alternate supply source (S376b) to overcome the quality problem associated with the current vendor. Then, similar to S373, quality indicators and alert acceptance rules are applied. Then, steps S366 and S363 are performed in a manner substantially similar to that described above.

The generic inputs are shown in Table 15.

TABLE 15

| | |
|---|---|
| 1 | Part Number |
| 2 | Part Description |
| 3 | Controller ID |
| 4 | NCM reference Number |
| 5 | NCM QTY |
| 6 | Average Monthly GrossREQT |

Phase One: Event Categorization

The categorization manager 2 uses the inputs from Input Table to analyze the cost situation of each part number.

Compute NCM %

Using Part Number as reference, retrieve the NCM quantity, DOS, OH QTY, Average Monthly GrossREQT based on 3 months usage.

Compute the NCM as a percentage of DOS (NCM %)=(QTYNCM/OH)×100%

The Quality report within the processed database 10 is as shown in Table 16.

TABLE 16

| | |
|---|---|
| 1 | Part Number |
| 2 | Part Description |
| 3 | Vendor ID |
| 4 | Ave Mthly GrossREQT |
| 5 | Quantity Per |
| 6 | Parent Part |
| 7 | Category |
| 8 | Exception |
| 9 | Create date time |
| 10 | Average Monthly NCM QTY |
| 11 | NCM % based on Monthly GrossREQT |
| 12 | NCM % (based on DOS) |
| 13 | NCM number |
| 14 | NCM Vendor |

Categorization Logic

Categorize the exception events based on selected criteria listed in the Quality report. The categorization rules, hosted in the Rules and Logic Metadata unit 12, can be based on more than one criteria. An example of the cost categorization is listed below in Table 17.

TABLE 17

| | Category 1 | Category 2 | Category 3 |
|---|---|---|---|
| NCM as a | Less than 10% of | Between 10% to | More than 50% |
| Percentage | DOS | 50% of DOS | of DOS |
| of DOS | | | |
| (NCM %) | | | |

Phase Two: Adaptive Execution

Overview

The second phase begins after event categorization. The session manager 3 will segregate the exceptions within the Quality report into new or Work-in-Progress events. After that, the action manager 4 uses the evaluated information to extract the appropriate rules and logic to trigger corrective actions.

Situational Evaluations

The objectives of the trigger logic are to detect significant non conforming material fallout incidents that will endanger assurance of supply. Examples of the situational checks are listed as follows:

Check #1: C or more Quality exceptions record over the last D months

Check #2: If part is customized or standard

Check #3: If there are more than one active vendor

Check #4: If NCM % is less than 10% of DOS

Check #5: If NCM % is between 10% and 50% of DOS

Check #6: If NCM % is more than 50% of DOS

Check #7: If Predefined Corrective Action Failed

Check #8: If Predefined Corrective Action Expired

Corrective Action Execution

Once the action manager 4 has interpreted the evaluated results, specific corrective actions will be activated. Interpretation logic is explained in the Rules and Logic section above. The potential but not exhaustive corrective actions are listed below.

Send Alert Message to Vendor to Replace Supply

Send Enquiry to ‘Second Sourced’ Vendor

Escalate Attention at Vendor End

Assess Risk Profile of Vendor

Compute DOS

Search AVL for Alternate Supply

Add New Vendor to the AVL

The session manager 3 screens and removes any duplicate actions that were previously deployed for the same exception event.

Next, the autotrigger manager 5 determines if automatic or manual mode of exception management should be deployed for the affected part number.

For part on manual management mode, the recommended actions are published in the Decision Support 13 and Execution 14 frames. The user selects and activates corrective actions via the Execution frame 14.

For part on automatic management mode, the autotrigger manager 5 activates all actions that has been accepted by the session manager 3.

Implication Evaluation on Action

The implication manager 6 will be triggered to check for compliance when suppliers replied or when actions expired without a reply.

Primary action affects supply quantity. Secondary actions do not have direct impact in supply quantity. The implication manager 6 only performs (Absolute Assessment) checks on primary actions to determine if the exception event had been resolved or otherwise. The Absolute Assessment ascertains optimal availability of inventory (On Hand Quantity) within a predefined time window, between a lower limit of zero unit and a predefined upper limit for a predefined time period.

Both manually or automatically managed parts are subjected to the same Absolute Assessment check. The generic methodology of performing the check is to aggregate the effects of all acknowledged or accepted primary actions from suppliers. The user may also assign preferences to supplier or action to establish priority. Two typical examples of Absolute Assessment methodologies are First in First Out (FIFO) and Weighted Acceptance (WA). Other prioritization methodologies may be deployed to enable the Absolute Assessment check as follows.

1. First In First Out (FIFO): All acknowledged primary actions, regardless of whether each action is 100% or partially accepted by supplier, are aggregated in a FIFO manner to match the prevailing demand (GrossREQT).

2. Weighted Acceptance (WA): All acknowledged primary actions, regardless of whether each action is 100% or partially accepted by supplier, are aggregated according to a user defined preferential order. The evaluation will commence if all primary actions have been acknowledged or when the expiry time has lapsed. In the event of similar preference, the acceptance criteria will then resort to FIFO mechanism.

Assessment of Secondary Actions

Secondary actions are not subjected to the Absolute Assessment check. Each secondary action is judged on its own merit, i.e., it has to pass the acceptance criteria. Assessment is triggered by a response or by the expired action time stamp. Acceptance is defined as no deviations between the acknowledged and requested QTY and ETA. Failing the acceptance test will trigger the next cycle corrective action.

Closure Process Flow

The resolution manager 8 performs the tasks of sending acceptance message to the vendor whose primary action has been selected and sending rejection note to the vendor whose primary action has been terminated.

For manually controlled parts, the user is expected to decide on the options of Hold, Accept or Terminate for every activated primary and secondary actions. The HOLD decision or any unselected actions will not invoke any action from the resolution manager 8.

In the case of auto-managed parts, the autoclose manager 7 utilizes results from the Absolute Assessment to decide. The autoclose manager 7 accepts actions that are used to fulfill the Absolute Assessment. All other acknowledged actions that result in ‘out of bound’ net availability will be terminated. The termination include all outstanding secondary actions.

After the corrective actions have been selected, information pertaining to the accepted action are either uploaded to the ERP system or transferred to the To-Do-List for manual system update. Changes to existing PO quantity and ETA are factored with reference to the accepted change.

Unique Action Modules

Send Alert Message to Vendor to Replace Supply

Using Part Number and NCM as reference, retrieve the NCM vendor's user account ID, NCM vendor's user email addresses, NCM QTY, OH QTY and the GrossREQT quantity for a predefined number of days (the scan period).

Calculate ETAreplace and QTYreplace if NCM has been Removed from OH QTY

Calculate the OH QTY for the entire predefined number of days as follows: OH_QTY date 1=OH QTY date0−GrossREQT date1+PO QTY date 1.

When the OH_QTY date N is less than the purchase reorder point, set ETAreplace as the date before the re-order point is breached, where Set QTYreplace=NCM QTY.

Calculate ETAreplace and QTYreplace if NCM has not been Removed from OH QTY

Calculate the OH QTY for the entire predefined number of days using the equation:

OH_{—}QTY date 1=OH QTY date0−GrossREQT date1+PO QTY date 1−Reject QTY

When the OH_QTY date N is less than the purchase reorder point, set ETAreplace as the date before the re-order point is breached.

Set QTYreplace=Reject QTY

Send Response Alert Message to Vendor

Using part number and vendor ID as reference, retrieve Vendor user account ID, Vendor user email addresses, document type (PO, CO, RFQ, Inv etc.), the corresponding document ID and the sent and acknowledged time-stamp.

Create the alert message listing the sent and acknowledged time-stamp from the transaction document.

Highlight Leadtime Exceptions

Using Part number as reference, retrieve part description, vendor ID, Po number, PO line, PO QTY, PO ETA, Delta LT results.

Generate a system notification message to the user indicating the computed Delta Leadtime, part number, part description, Vendor, PO document Number and PO line that causes the Delta exception.

Benchmark Leadtime

Using Part Number as reference, retrieve all the qualified Vendor IDs, the corresponding account ID and email information, currency and Unit prices of each Vendor, the corresponding Leadtime and the vendor composite risk index if available.

Benchmark the Leadtime of different vendors and publish the result to the buyer. For customized part, recommend a breakdown of lead-time component to facilitate improvement.

The “Send Lead-time Reduction Request” action is described in greater detail below.

Using Part Number as reference, retrieve the qualified Vendor IDs, the corresponding account ID, currency, unit prices and Leadtime of each Vendor and the predefined leadtime reduction percentage over time.

Create a leadtime reduction request. The targeted leadtime can be computed based on the benchmark (shortest leadtime) or current vendor specific leadtime using reduction percentage per period.

This module is triggered by a change in the extracted external databases, responses from users or predefine event such as expiry of action. The first and second phase computations and logic will be discussed separately.

The Management Agent aligns broad level management goals into unit level performance target to facilitate result measurements. This module also performs segmented analysis and reporting: by product, by controllership, by reporting hierarchy etc. The management user utilizes this module to determine the access right and exception management guidelines of the buyer.

Management Agent Process Flow

Inputs

For Managerial Goal setting, the following inputs are provided from respective agents:

| | |
|---|---|
| AOS | |
| DOS or | (default is 10 days = 2 weeks) |
| Inventory turn | (default is 24 turns = 10 DOS) |
| Inventory holding in dollar | (no default setting) |
| Inventory liability in dollar | (no default setting) |
| Response time | |
| Target response time or expiry datetime | (default 72 hours) |
| Target leadtime | (default is 60 days = 8 weeks) |
| Target leadtime reduction % per quarter | (no default setting) |
| Cost | |
| Target cost | (no default setting) |
| Target cost reduction % per quarter | (no default setting) |
| Quality | |
| Percentage of reject | (no default setting) |
| Incident of reject or quality issue | (no default setting) |
| Session | |
| Conditions to activate new session | |
| Conditions to NOT activate new session | |
| Refers to Session Agent for | |
| default settings | |
| Exception Trigger Threshold | |
| Quantity | (default is zero) |
| Datetime | (default is −24 hrs + 0 hr) |
| Cost | (default is zero) |
| Cost Reduction % per period | (default is zero to +infinity) |
| Leadtime Reduction % per quarter | (default is zero to +infinity) |
| Other percentage or indices | (default is zero) |
| Empowerment and Designation | |
| Access Right | |
| Customization on Categorization | |
| Customization on trigger, action | |
| and acceptance by product group | |
| Escalation trigger | |
| Information retrivable by | |
| Management Agent | |
| Factory revenue | |
| AOS, Response, Cost and Quality reports | |
| Exception reports | |
| Historical archives | |
| Functions/Computations | |

The management module helps the purchasing manager to monitor and to guide performance of the department dynamically. The manager is able to promote and support consistent ‘real time’ performance measurement. Traditional periodic management method tends to encourage ‘good’ performance only during the measurement period. In other words, traditional method condones ‘sub-par performances’ during non-measurement period.

The management module analyzes and presents information from various perspectives such as individual or aggregated product line, buyer, part group or part in a real time manner. The agent also enables the manager to selectively vary the access and customization right of buyers. The manager is able to empower the experience buyers to train the IPA or utilizes IPA's best practices to guide the inexperience buyers. The key sub-modules within the management agent are discussed below.

Managerial Goal Setting

The managerial goal setting is one of the key function of the Management Agent. The managerial user is able to define broad or specific performance goals in all of the core agent modules as follows.

AOS: a measurement of ‘now’ inventory and liability

DOS There are a few levels of DOS measurement

Individual part number level

Aggregate part group level

Aggregate controller (buyer) level

Aggregate parent product level

Aggregate purchasing section (collection of buyers) level

Aggregate product line (business unit) level

All aggregated DOS computations

Compute the target inventory holding in dollar for every part number=target DOS×sumREQT (average monthly requirement)×std cost

Compute the On hand Inventory holding in dollar for each part number=OH×Std cost

DOSx=Aggregate X level

Where X represent part group, controller, parent product, purchasing section or product line level

Cumulate all the target inventory holding in dollar for all part within the X level

Cumulate all the OH inventory holding in dollar for all part within the X level DOSx=(OH Inv Holding$/target inv holding$)×target DOS

Inventory Turn

Inventory turn=sale or factory revenue $/OH inventory holding$

(e.g., an inventory turn of 12 means that the on hand inventory holding is approximately one month worth)

Assuming that there are 20 work days in a month, 12 turn means a DOS of 20=1 month.

On Hand Inventory holding in dollar

OH Inv Holding $ for every part=OH QTYx std cost

Cumulate all the OH inventory holding in dollar for all part as defined by the user: by part group, controller, parent product etc . . . .

Liability in Dollar

For every part, calculate liability in unit

Liability in unit for every part=OH+all open PO QTY

Liability in dollar=(OH+all open PO QTY)×Std cost

Cumulate the liability in dollar as defined by the user: by part group, controller, parent product etc . . . .

Response

The target parameters are manually updated by the user. There are two primary measuring indicators:

Response time (in hour)

Target response time or expiry datetime for actions

Leadtime

Target leadtime: Leadtime reduction goal or projected target per period (period is typically in quarter or 3 months)

The actual leadtime is retrieved from the ERP

Cost

The target parameters are tabulated by RFQ acknowledgement or manually updated by the user.

Target cost or reduction percentage per period

The actual cost is retrieved from the ERP

Exception Trigger Threshold

The measuring indicators are manually determined and input by the user

Tolerance, Quantity, Datetime, Cost, Index or percentage

Categorization Band

For each agent the managerial user has the ability to customize the three areas:

Number of category, Define range within each category, Define value

Empowerment and Designation

The empowerment function extend permanent rights to access and or customize trigger logic, actions and acceptance logic. The Designation function extends only temporary rights. There will be an expiry time attached to each designation or temporary right.

Access Right

The access right consist of READ and CHANGE (EDIT). Default for individual buyer is to view information by part and by controller. Access right to view by parent product is extended only to the lead buyer responsible for that particular product. Access right to view by Product line or section is normally restricted to manager

Customization on Categorization

Once the the access right has been assigned, the buyer will be able to either read or edit the number of category, define the range within each category and define the categorization criteria.

Customization on Trigger and Acceptance by Product Group

In addition to the ability to change the categorization, the user with the appropriate access rights is able to the Trigger logics and the acceptance criteria.

Outputs

Performance Measurement

| | |
|---|---|
| DOS vs Target | (unit or % − Y axis) |
| Inventory Turns | (unit − y axis) |
| Inventory Holding in Dollar | (Aggregate OH $ − Y axis) |
| PO Liability | ($ − Y axis) |
| Projected Obsolescence | ($ − Y axis) |
| Exception events | (incident − Y axis) |

Unresolved and resolved Exception event by vendor (occurrence−Y axis)

Information Analysis (Dissects from Different Angles Using X-Axis)

Analyze by single or multiple product lines over time

Analyze by single or multiple product over time

Analyze by single or multiple buyer over time

Analyze current performance (instant) by multiple product line (x axis=product lines)

Analyze current performance (instant) by multiple products (x axis=products)

Analyze current performance (instant) by buyer (x axis=buyer)

Analyze current performance (instant) by vendor (only applicable for unresolved/resolved exception event)

Business Rule Classifications

The following business rule classification illustrated in Table 18 was used as foundation concepts in the design process the Rule functionalities of the system. Examples are used to illustrate the direct application and implementation of this classification specification in the system of the present invention. The rules were referenced from Business Rules Applied, Barbara von Halle 2002, Chapter 2: Business Rule Concepts, page 34.

TABLE 18

| | | Detailed Definition of | |
|---|---|---|---|
| Business Rule | Definition of Business | Business Rule | |
| Classification | Rule Classification | Classification | Examples |
| Term | A noun or noun phrase with an | This encompasses items such as | Procurement KPI parameters |
| | agreed upon definition | Concept, object class, entity | Typically defined as operant in indicator |
| | | Property, detail, attribute | tag definitions e.g. days of supply (dos), |
| | | Values and value sets | variance between Purchase Order and |
| | | | Forecast (delta_povfc) etc. |
| | | | <indicator operant={term}> |
| Fact | A statement that connects | Entity-to-entity | {term1} is a {term2} |
| | terms, through prepositions | relationships | e.g. |
| | and verbs, into sensible | Entity-to-attribute | <term1> |

| | | |
|---|---|---|
| business-relevant observations | relationships | <indicatorSet1> . . . </indicatorSet1> |

<indicatorSet2> . . . </indicatorSet2>

| | | | </term1> |
|---|---|---|---|
| | | | In this example, the entity-to-entity |
| | | | relationship is between a variety of |
| | | | indicator sets to term1. An event that |
| | | | carries the attributes matching these |
| | | | indicator sets can be tagged as term1, and |
| | | | hence triggering an initiation of a |
| | | | business event, message or other activity. |
| Mandatory constraint | A complete statement that | | |
| | expresses an unconditional | | |
| | circumstances that must be | | |
| | true or not true for the business | | |
| | event to complete with | | |
| | integrity | | |
| Action Enabler | A complete statement that test | The sequencing and | e.g. |
| | conditions and upon finding | groupings gives the rule set | <indicatorSet1> . . . </indicatorSet1> |
| | them true, initiates another | functionalities of the system | <indicatorSet2> . . . </indicatorSet2> |
| | business event, message or | the ability to have properties | In this example, the first indicator set is |
| | other activity | such as | deem to have order priority over the |
| | | Priority | second and any content within the |
| | | Logical relationships | indicator set would have a logical AND |
| | | (AND/OR/Exclusivities) | definition. |
| Computation | A complete statement that | The Rule Set functionalities | In combination, the type and operand |
| | provides an algorithm for | provides for Boolean evaluation | attribute of the indicator tag definitions |
| | arriving at the value of a term | of computational outcomes | facilitate this functionality. |
| | where such algorithms may | where the algorithms could | Type definitions encompass value, range |
| | include sum, difference, | span comparison (=, ≠, >, <, ≧, ≦), | and even custom classes. |
| | product, quotient, count, | mathematical operators, and | |
| | maximum, minimum, | even complex formulae. | |
| | averages, etc. | | |

Business Rule Modules

The following generic IPA rules items govern the general execution of the invention:

Workdays per month in days

Target DOS in days

Cumulated forecast month in month

Number of month weighted average in month

Push Out window effective period in number of days

Push Out safety days

Push Out frozen window in number of days

Pull in window effective period in number of days

Pull in safety days

Lead-time buffer in days

Shipping Notice window for effective period in number of days

Pull in safety Margin in increment percentage versus target

Rebalance Po window effective period in days

Backup Pull in safety margin in increment percentage versus target

Trigger definition attribute defined as automatic or manual

Closure definition attribute defined as automatic or manual using First In First Out (FIFO) or Weighted Average (WA)

Action Rules and Logic

The framework of the action rule is built on a hierarchical frame as illustrated below:

Category ID

Indicator Set for Categorization

Action Tree

Action Cycle ID

Action ID and Name

Indicator Set for Action

The Indicator Set for categorization is used to differentiate the various categories of exceptions. The Action Tree level allow for further segregation of category. The Action Cycle ID differentiates early or subsequent activation of corrective action. The Action ID and name define the precise action module to be triggered. The Indicator Set for action defines the and/or logic that decide which action module to trigger. The entire hierarchical framework is replicated for other exception conditions such as shortage or severe shortage. Each collection of Action Tree can be customized for specific commodity type to capture variations for different commodity or situation.

An example of an implementation of a computer program to operate the multi-cycles action rules and logic is illustrated below.

<category id=“2” dscp=“excess”>
</action>
<action id=“20” name=“PushOut”>

<indicatorSet>

<indicator type=“value” operant1=“delta_povfc” operand=“less” value=“0”/>
<indicator type=“range” operant1=“dos” high=“80” low=“20”/>
<indicator type=“class” operant1=“com.vientity.ipa.lib.indicator.NextDos” ans=“false”>
<param name=“dos_count”>20</param>
</indicator>
<indicatorSet>
<indicator type=“value” operant1=“extended_cost” operand=“more”

value=“5000”/>

<indicator type=“range” operant1=“dos” high=“80” low=“20”/>
<indicator type=“class” operant1=“com.vientity.ipa.lib.indicator.NextDos”

ans=“false”>

<param name=“dos_count”>20</param>

</indicator>

</indicatorSet>

</action>
<action id=“22” name=“RequestToCancelOrder”>

<indicatorSet>

<indicator type=“value” operant1=“delta_povfc” operand=“less” value=“0”/>
<indicator type=“value” operant1=“dos” operand=“more” value=“80”/>
<indicator type=“value” operant1=“dos” operand=“not” value=“9999”/>

</indicatorSet>
<indicatorSet>

<indicator type=“value” operant1=“dos” operand=“more” value=“120”/>
<indicator type=“value” operant1=“dos” operand=“not” value=“9999”/>

</indicatorSet>

</action>

</cycle>
<cycle id=“2”>

<action id=“1” name=“EscalateAttentionToVendor”>

<indicatorSet>

<indicator type=“class”

operant1=“com.vientity.ipa.lib.indicator.AcceptanceCancelOrder” ans=“false”/>

</indicatorSet>
<indicatorSet>

<indicator type=“class”

operant1=“com.vientity.ipa.lib.indicator.AcceptancePushout” ans=“false”/>

</indicatorSet>
<indicatorSet>

<indicator type=“class”

operant1=“com.vientity.ipa.lib.indicator.AcceptanceStopActivities” ans=“false”/>

</indicatorSet>
<indicatorSet>

<indicator type=“class”

operant1=“com.vientity.ipa.lib.indicator.AcceptancePullInDos30” ans=“false”/>

</indicatorSet>

</action>

</cycle>
<cycle id=“3”>

<action id=“28” name=“Reactivate Pushout”>

<indicatorSet>

<indicator type=“class”

operant1=“com.vientity.ipa.lib.indicator.AcceptanceCancelOrder” ans=“false”/>

</indicatorSet>

</action>
<action id=“2” name=“EscalateAttentionInternally”>

<indicatorSet>

<indicator type=“class”

operant1=“com.vientity.ipa.lib.indicator.AcceptanceCancelOrder” ans=“false”/>

</indicatorSet>

</action>

</cycle>
<cycle id=“4”>

<action id=“1” name=“EscalateAttentionToVendor”>

<indicatorSet>

<indicator type=“class”

operant1=“com.vientity.ipa.lib.indicator.AcceptancePushout”ans=“false”/>

</indicatorSet>
<indicatorSet>

<indicator type=“class”

operant1=“com.vientity.ipa.lib.indicator.AcceptanceStopActivities” ans=“false”/>

</indicatorSet>
<indicatorSet>

<indicator type=“class”

operant1=“com.vientity.ipa.lib.indicator.AcceptancePullInDos30” ans=“false”/>

</indicatorSet>
<indicatorSet>

<indicator

type=“class”operant1=“com.vientity.ipa.lib.indicator.AcceptanceReactivate Pushout”
ans=“false”/>

</indicatorSet>

</action>

</cycle>

</actionTree>

Database specifications for the ERP raw database 9 on supply and demand are provided below. However, this disclosure is not intended to be limiting.

Information on the fields and descriptions of various tables in the present database is provided below. However, the following list of tables is not intended to be exclusive, and other tables and fields as would be envisioned by one of ordinary skill in the art may be used.

Database Specifications for ERP Raw Database on Supply & Demand

Part Information

Specific information about the individual parts extracted from ERP is listed below. The left column is the field, and the right column is the description of the field for this table.

ID Unique identifier for the part

Part Description Description of the part

Controller ID Unique identifier for the part's controller

Quantity OH Number of parts bring held

Standard Cost Unit price of the part

Vendor ID Unique identifier for vendor

Parent Product ID Unique identifier for parent product

Parent Product Dscp Description of the parent product

Quantity Per Number of parts used in parent

Leadtime Lead-time for this part

Business RatioPercentage of business of this part that's allocated to this vendor

Currency Currency

Invoice Information

Specific information about the part's invoice extracted from ERP is listed below.

ID Invoice's unique identifier

Quantity Number of parts that is delivered

Price Price of a part

Timestamp Timestamp

Currency Currency

Purchase Order Information

Specific information about the purchase order for a part extracted from ERP is listed below.

ID Unique identifier for purchase order

Part ID Unique identifier for part

PO Line No Purchase order line No.

Quantity PO Number of ordered parts

Eta PO Estimated time of arrival for the purchase order

Unit Price PO Unit price of part

Timestamp Timestamp

Currency Currency

Forecast Information

Specific information about the forecast of a part supplied by a vendor is listed below.

ID Unique identifier for a part

Quantity Forecast Forecast's quantity

ETA Forecast Forecast's estimated time of arrival

Vendor ID Unique identifier of a vendor

Request for Quotation Information

Specific information about the Request For Quotation is listed below.

ID Unique identifier for RFQ

Type Pricing mechanism

Time-stamp Time-stamp

Price Unit price for part

Quantity Quantity for part

Timestamp Timestamp

Currency Currency

Change Order Information

Specific information about the change order for a part extracted from ERP is listed below.

ID Unique identifier for change order

Part ID Unique identifier for part

PO ID Unique identifier for purchase order

PO Line No Purchase order line No.

CO Line No Change order line no.

Quantity CO Number of ordered parts

Eta COEstimated time of arrival of change order

Unit Price CO Unit price of part

Timestamp Timestamp

Currency Currency

Bill of Material Information

Engineering BOM description of the product including the components extracted from ERP is listed below.

Parent Part ID Unique identifier of Parent Part

Description Description of Parent Part

Part ID Unique identifier of all associated parts

Part Description Description of the associated parts

Quantity Per Quantity used per unit of parent product

Timestamp Timestamp

Shipping Notice Information

Specific information about the shipping notice for a part extracted from ERP is listed below.

ID Unique identifier of a shipping notice

Part ID Unique identifier of a part

Part Description Description of a part

Bill No. Master airway bill no.

Carrier Carrier Name

Quantity Shipped quantity of the part

Date Date of departure

Timestamp Time stamp

Non-Conformance Materials Information

Specific information about the non-conformance materials (NCM) for a part extracted from ERP is listed below.

NCM ID Unique identifier of a non-conformance document

Part ID Unique identifier of a part

Part Description Description of a part

Quantity Non-conformance quantity

Database Specifications for ERP Processed Database on Synthesized Raw Data

AOS Agent Processed Information

Processed information from the extracted ERP raw database and a list of non-exhaustive key performance index (KPI) is listed below.

Part ID Unique identifier for Part

KPIs Key Performance Indexes

e.g.

Days of Supply Days

Delta PO Vs Forecast Quantity

Cost Agent Processed Information

Processed information from the extracted ERP raw database and a list of non-exhaustive key performance index (KPI) is listed below.

Part ID Unique identifier for Part

KPIs Key Performance Indexes

e.g.

Target Reduction % Ratio

$ PO Vs Inv Price difference between PO and Invoice

Response Agent Processed Information

Processed information from the extracted ERP raw database and a list of non-exhaustive key performance index (KPI) is listed below.

Part ID Unique identifier for Part

KPIs Key Performance Indexes

e.g.

Delta Leadtime Leadtime difference between planner & actual

Leadtime Price Index Ratio

Quality Agent Processed Information

Processed information from the extracted ERP raw database and a list of non-exhaustive key performance index (KPI) is listed below.

Part ID Unique identifier for Part

KPIs Key Performance Indexes

e.g.

NCM % Quantity based on days of supply

NCM Quantity Average monthly non-conformance materials quantity

Management Agent Processed Information

Processed information from the extracted ERP raw database and a list of non-exhaustive key performance index (KPI)

Part ID Unique identifier for Part

KPIs Key Performance Indexes

e.g.

Inventory Inventory holding in dollars

PO Liability Liability of purchase order

Database Specifications for ERP Exception Event Database on Activities Deployed

AOS Agent Exception Event Information

Information about deployed activities triggered by exception events is listed below.

ID Unique identifier for exception event

Part ID Identifier for a part

Action ID Identifier for the action triggered

Action Description Description for the action triggered

Vendor ID Identifier for the vendor

Cost Liability Cost

Currency Currency

Quantity User Quantity recommended by user

ETA User Estimated time of arrival recommended by user

Quantity Reply Replied quantity

ETA Reply Replied estimated time of arrival

Message Message of the triggered action

Remark Remark contained in the triggered action

Cost Agent Exception Event Information

Information about deployed activities triggered by exception events is listed below.

ID Unique identifier for exception event

Part ID Identifier for a part

Action ID Identifier for the action triggered

Action Description Description for the action triggered

Vendor ID Identifier for the vendor

Cost Extended Cost

Quantity User Quantity recommended by user

ETA User Estimated time of arrival recommended by user

Quantity Reply Replied quantity

ETA Reply Replied estimated time of arrival

Message Message of the triggered action

Remark Remark contained in the triggered action

Unit Price Unit price of a part

Currency Currency

RFQ price Unit price of request for quotation

Response Agent Exception Event Information

Information about deployed activities triggered by exception events is listed below.

ID Unique identifier for exception event

Part ID Identifier for a part

Action ID Identifier for the action triggered

Action Description Description for the action triggered

Vendor ID Identifier for the vendor

Cost Extended Cost

Currency Currency

Quantity User Quantity recommended by user

ETA User Estimated time of arrival recommended by user

Quantity Reply Replied quantity

ETA Reply Replied estimated time of arrival

Message Message of the triggered action

Remark Remark contained in the triggered action

Timestamp Document

Leadtime System Default system leadtime

Leadtime Target Target leadtime set by user

Quality Agent Exception Event Information

Information about deployed activities triggered by exception events is listed below.

ID Unique identifier for exception event

Part ID Identifier for a part

Action ID Identifier for the action triggered

Action Description Description for the action triggered

Vendor ID Identifier for the vendor

Cost Extended Cost

Currency Currency

Quantity User Quantity recommended by user

ETA User Estimated time of arrival recommended by user

Quantity Reply Replied quantity

ETA Reply Replied estimated time of arrival

Message Message of the triggered action

Remark Remark contained in the triggered action

Ncm Non-conformance materials quantity

Ncm % Non-conformance materials ration based on daily/monthly usage

The present invention has various advantages. For example, but not by way of limitation, the present invention overcome the above-noted problems and disadvantages of the related art. Further, the present invention adapts to different situations and to retains procurement knowledge.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A system for managing a supply of a good based on a request for said good, comprising:
a decision support module that evaluates said request against a plurality of indicators and determines whether said request involves an exception that is indicative of a procurement problem in accordance with exception data; and
an execution module that, if said request involves said exception, receives said determination from said decision support module, triggers an action that is configured to correct said exception and generates an interactive output to an external entity, wherein said exception is incorporated into said exception data if said exception is of a new type, and said exception data is modified if said exception is not of said new type and has changed, to adjust said exception data in real-time to incorporate said exception.

2. The system of claim 1, said decision support module comprising:
an agent controller that receives said request and generates an output that is sent to a data module that stores first, second and third types of data comprising raw data, processed data and said exception data, respectively;
a categorization manager that retrieves said first type of data from said data module and categorizes said good in accordance with at least one of said indicators that comprise at least one of a plurality of procurement rules, to generate a categorization output that identifies a category of said exception based on said good; and
a session manager that receives said categorization output from said categorization manager and said second and third data types of data, and if said exception is of said new type, identifies said exception category for addition to said third data of said data module, wherein said session manager generates a first output and a second output.

3. The system of claim 2, said execution module comprising:
an action manager that, in response to said first output of said session manager, receives said third data and determines, in accordance with said plurality of procurement rules, said third data and said exception category, an action to be taken;
an auto trigger manager that receives said second and third types of data, activates said action and generates said interactive output;
an implication manager that determines an implication of said action performed in response to said exception, in accordance with a subset of said procurement rules that define at least one tolerance band specific to said execution category, and generates an output indicative of whether said message is within said at least one tolerance band;
an auto close manager that monitors said action in relation to said exception and in accordance with said output of said implication manager, determines whether a resolution action is required, and outputs an auto close message; and
a resolution manager that receives said auto close message and indicates one of: (a) automatic management resolution, (b) manual management resolution and (c) automatic management non-resolution of said exception, wherein said data module is updated in accordance with said automatic management resolution of said exception, and said action manager is reactivated for additional processing when said automatic management non-resolution or a manual management non-resolution occurs.

4. The system of claim 3, wherein said session manager receives an input from said action library that comprises an identified exception and a corrective action, and identifies said corrective action for storage in said data module.

5. The system of claim 1, wherein said request comprises an initiation signal from an external source, and wherein said interactive output is transmitted to a relevant entity and is indicative of said corrective action.

6. The system of claim 1, wherein said at least one of said indicators can be modified based on at least one of a category of said good and at least one an external factor.

7. The system of claim 1, wherein if said exception is in said exception data, said at least one corrective action is taken immediately.

8. The system of claim 1, wherein said plurality of indicators can be reassessed based on a response from said external entity.

9. The system of claim 1, wherein a plurality of indicators are applied in said decision support module across a plurality of time periods to perform said evaluation.

10. The system of claim 9, wherein said time periods comprise past, present and future time periods.

11. The system of claim 1, wherein said evaluation performed by said decision support module has qualitative and quantitative components.

12. The system of claim 1, said interactive output comprising at least one of a supplier message, a message activating an online auction directly in an external B2B portal and a message launching a new transaction such as purchase order directly in an Enterprise Resource Planning (ERP) system.

13. The system of claim 11, wherein said qualitative component comprises at least one of: (a) a historical support level of a supplier; (b) market supply conditions; (c) a result of an analysis of relative buyer power and seller power, and (d) an analysis of the relationship between individuals in at least one of said buying organization and said selling organization.

14. The system of claim 1, wherein said plurality of indicators are used to categorize a procurement environment, analyze relevant conditions and assign risk.

15. The system of claim 14, wherein said assigned risk is handled by selecting said action by evaluating said indicators based on past, current and future time period analysis.

16. The system of claim 1, wherein said exception comprises at least one of excess supply, poor responses, inaccurate pricing, shortage of supply and shortage due to a quality failure.

17. The system of claim 1, wherein said corrective action is performed one of sequentially and simultaneously.

18. The system of claim 3, wherein after said request, said agent controller loads said procurement rules, initializes said categorization manager and said session manager, and calculates agent-specific key performance indicators (KPIs), and
after said determination that said request is said exception, initializes said action manager, and prevents reporting of said exception if said action manager indicates that no action corresponds to said exception.

19. The system of claim 18, wherein said categorization manager applies said KPIs to generate said categorization.

20. The system of claim 3, wherein said session manager monitors said request for relevance and consistency when said request is not of said new type.

21. The system of claim 3, further comprising an action library that selects said action based on requests from said action manager and invokes said selected action based on a request from said auto trigger manager.

22. The system of claim 3, wherein said implications comprise cost, availability, responsiveness and quality.

23. The system of claim 3, wherein said business rules are classified based on at least one of a term, a fact, a mandatory constraint, an action enabler, a computation and an inference, to provide an intelligent decision system for said system.

24. The system of claim 3, wherein said exception data comprises (a) extracted raw data related to external supply chain information, (b) a processed version of said raw data as processed by said categorization manager, and (c) exception data generated by said resolution manager.

25. The system of claim 1, further comprising:
an assurance of supply (AOS) agent that resolves supply problems;
a response agent that improves flexibility and supply of a back-end supply chain;
a cost agent that ensures proper pricing of purchases and manages delivery of reduction objectives;
a quality agent that generates an alert replenishes supply when a prescribed lower quality threshold has been reached; and
a session agent that responds to a response from interacting parties based on said action when said exception is being processed by said system, wherein a self-learning agent correlates statistical data with a plurality of business rules to refine said at least one indicator in accordance with a change in said exception.

26. The system of claim 3, wherein said action comprises one of a primary action that affects supply quantity, and a secondary action that does not directly impact supply quantity.

27. The system of claim 3, wherein said action comprises integrating at least one of a sale and a purchase of said good in a business to business (B2B) portal.

28. The system of claim 3, wherein said interactive output is channeled through an application interface module to deliver at least one transactional output.

29. The system of claim 28, wherein said at least one transaction output comprises a post B2B purchase request.

30. The system of claim 5: wherein said initiation signal is raw data and said external source is an Enterprise Resource Planning (ERP) system.

31. A method for managing a supply of a good based on a request for said good, comprising:
(a) evaluating said request against a plurality of indicators and determining whether said request involves an exception, said exception being indicative of a procurement problem, in accordance with exception data, in a decision support module;
(b) if said request involves an exception, receiving said determination from said decision support module, triggering an action that is configured to resolve that exception, and generating an interactive output to an external entity, in an execution module; and
(c) incorporating said exception into said exception data if said exception is of a new type and modifying said exception data if said exception is not of said new type and has changed, to adjust said exception data in real-time.

32. The method of claim 31, said step (a) comprising:
(d) receiving said request in an agent controller, and generating an output that is sent to a data module that stores first, second and third types of data;
(e) receiving said first type of data from said data module and categorizing said good, in a categorization manager, in accordance with at least one of said indicators that comprise a plurality of procurement rules, to generate a categorization output that identifies said good based on a category of exception; and
(f) receiving said categorization output, in a session manager, from said categorization manager and said second and third types of data, and determining whether said exception is of said new type, and if said exception is of said new type, identifying said exception category for addition to said data module, wherein said session manager generates a first output and a second output.

33. The method of claim 32, said steps (b) and (c) comprising:
(g) in response to said first output of said session manager, receiving said third data output in an action manager, and determining, in accordance with said plurality of procurement rules and said exception category, an action to be taken;
(h) receiving said second and third types of data in an auto trigger manager, and activating said action and generating said interactive output;
(i) determining the implications of said action performed in response to said exception in an implication manager, in accordance with a subset of said procurement rules that define at least one tolerance band specific to said execution category, and generating an output indicative of whether said message is within said at least one tolerance band;
(j) in an auto close manager, monitoring said action in relation to said exception, determining whether a resolution action is required, and outputting an auto close message; and
(k) receiving said auto close message in a resolution manager, and indicating one of automatic management resolution, manual management resolution and automatic management non-resolution of said exception, wherein said data module is updated in accordance with said automatic management resolution of said exception, and said action manager is reactivated for additional processing when said automatic management non-resolution or a manual management non-resolution occurs.

34. The method of claim 33, further comprising said session manager receiving an input from said action library, said input including an identified exception and a corrective action, and identifying said corrective action for storage in said data module.

35. The method of claim 31, wherein said request is received as an initiation signal received from an external source, and said interactive output, indicative of said corrective action, is transmitted to a relevant entity.

36. The method of claim 31, further comprising modifying said at least one of said indicators based on at least one of a category of said good and at least one an external factor.

37. The method of claim 31, wherein if said exception is in said exception data, said action is taken immediately.

38. The method of claim 31, further comprising reassessing said plurality of indicators based on a response from said external entity.

39. The method of claim 31, further comprising applying said plurality of indicators across a plurality of time periods to perform said steps (b) and (c).

40. The method of claim 31, further comprising:
categorizing a procurement environment in accordance with said plurality of indicators, analyzing relevant conditions and assigning risk, wherein said assigned risk is handled by selecting said action by evaluating said indicators based on past, current and future time period analysis.

41. The method of claim 31, wherein said corrective action is performed one of sequentially and simultaneously.

42. The method of claim 33, wherein after said request, said agent controller loads said procurement rules, initializes said categorization manager and said session manager, and calculates agent-specific key performance indicators (KPIs), and
after said determination that said request is said exception, initializes said action manager, and prevents reporting of said exception if said action manager indicates that no action corresponds to said exception.

43. The method of claim 42, wherein said categorization manager applies said KPIs to generate said categorization.

44. The method of claim 33, wherein said session manager monitors said request for relevance and consistency when said request is not of said new type.

45. The method of claim 33, further comprising selecting said action in an action library based on requests from said action manager, and invoking said selected action based on a request from said auto trigger manager.

46. The method of claim 33, wherein said implications comprise cost, availability, responsiveness and quality.

47. The method of claim 33, wherein said business rules are classified based on at least one of a term, a fact, a mandatory constraint, an action enabler, a computation and an inference, to provide an intelligent decision system for said system.

48. The method of claim 33, wherein said exception data is generated by extracting raw data related to external supply chain information, said categorization manager processing a version of said raw data, and said resolution manager generating exception data.

49. The method of claim 31, further comprising:
(d) resolving supply problems in an assurance of supply (AOS) agent;
(e) improving flexibility and supply of a back-end supply chain by using a response agent;
(f) ensuring proper pricing of purchases and managing delivery of reduction objectives via a cost agent;
(g) in a quality agent, generating an alert replenishes supply when a prescribed lower quality threshold has been reached; and
(h) using a session agent, responding to a response from interacting parties based on said action when said exception is being processed by said system, wherein a self-learning agent correlates statistical data with a plurality of business rules to refine said at least one indicator in accordance with a change in said exception.

50. The method of claim 33, wherein said action comprises one of a primary action that affects supply quantity, and a secondary action that does not directly impact supply quantity.

51. The method of claim 33, wherein said action comprises integrating at least one of a sale and a purchase of said good in a business to business (B2B) portal.

52. The method of claim 33, further comprising channeling said interactive output through an application interface module to deliver at least one transactional output.

53. The method of claim 35, wherein said initiation signal is raw data and said external source is an Enterprise Resource Planning (ERP) system.

54. A computer program product for enabling a computer to operate, and so comprising software instructions for enabling the computer to perform predetermined operations, and a computer readable medium bearing the software instructions, the predetermined operations comprising the steps of:
(a) evaluating said request against a plurality of indicators and determining whether said request involves an exception, said exception being indicative of a procurement problem, in accordance with exception data, in a decision support module;
(b) if said request involves said exception, receiving said determination from said decision support module, triggering an action that is configured to correct said exception, and generating an interactive output to an external entity, in an execution module; and
(c) incorporating said exception into said exception data if said exception is of a new type and modifying said exception data if said exception is not of said new type and has changed, to adjust said exception data in real-time.

55. The computer program product of claim 54, said computer readable medium bearing said software instructions to further perform said predetermined operations, said step (a) comprising:
(d) receiving said request in an agent controller, and generating an output that is sent to a data module that stores first, second and third types of data;
(e) receiving said first type of data from said data module and categorizing said good, in a categorization manager, in accordance with at least one of said indicators that comprise a plurality of procurement rules, to generate a categorization output that identifies said good based on a category of exception; and
(f) receiving said categorization output, in a session manager, from said categorization manager and said second and third data types of data, and determining whether said exception is of said new type, and if said exception is of said new type, identifying said exception category for addition to said data processing subsystem, wherein said session manager generates a first output and a second output.

56. The computer program product of claim 55, said computer readable medium bearing said software instructions to further perform said predetermined operations, said steps (b) and (c) comprising:
(g) in response to said first output of said session manager, receiving said third data output in an action manager, and determining, in accordance with said plurality of procurement rules and said exception category, an action to be taken;
(h) receiving said second and third data types of data in an auto trigger manager, and activating said action and generating said interactive output;
(i) determining the implications of said action performed in response to said exception in an implication manager, in accordance with a subset of said procurement rules that define at least one tolerance band specific to said execution category, and generating an output indicative of whether said message is within said at least one tolerance band;
(j) in an auto close manager, monitoring said action in relation to said exception, determining whether a resolution action is required, and outputting an auto close message; and
(k) receiving said auto close message in a resolution manager, and indicating one of automatic management resolution, manual management resolution and automatic management non-resolution of said exception, wherein said data module is updated in accordance with said automatic management resolution of said exception, and said action manager is reactivated for additional processing when said automatic management non-resolution or a manual management non-resolution occurs.

57. The computer program product of claim 56, said computer readable medium bearing said software instructions to further perform said predetermined operations, further comprising said session manager receiving an input from said action library, said input including an identified exception and a corrective action, and identifying said corrective action for storage in said data processing subsystem.

58. The computer program product of claim 54, wherein said request is received as an initiation signal received from an external source, and said interactive output, indicative of said corrective action, is transmitted to a relevant entity.

59. The computer program product of claim 54, said computer readable medium bearing said software instructions to further perform said predetermined operations, further comprising modifying said at least one of said indicators based on at least one of a category of said good and at least one an external factor.

60. The computer program product of claim 54, wherein if said exception is in said exception data, said action is taken immediately.

61. The computer program product of claim 54, said computer readable medium bearing said software instructions to further perform said predetermined operations, further comprising reassessing said plurality of indicators based on a response from said external entity.

62. The computer program product of claim 54, said computer readable medium bearing said software instructions to further perform said predetermined operations, further comprising applying said plurality of indicators across a plurality of time periods to perform said steps (b) and (c).

63. The computer program product of claim 54, said computer readable medium bearing said software instructions to further perform said predetermined operations, further comprising:
categorizing a procurement environment in accordance with said plurality of indicators, analyzing relevant conditions and assigning risk, wherein said assigned risk is handled by selecting said action by evaluating said indicators based on past, current and future time period analysis.

64. The computer program product of claim 54, wherein said corrective action is performed one of sequentially and simultaneously.

65. The computer program product of claim 56, wherein after said request, said agent controller loads said procurement rules, initializes said categorization manager and said session manager, and calculates agent-specific key performance indicators (KPIs), and
after said determination that said request is said exception, initializes said action manager, and prevents reporting of said exception if said action manager indicates that no action corresponds to said exception.

66. The computer-readable medium of claim 65, wherein said categorization manager applies said KPIs to generate said categorization.

67. The computer program product of claim 56, wherein said session manager monitors said request for relevance and consistency when said request is not of said new type.

68. The computer program product of claim 56, said computer readable medium bearing said software instructions to further perform said predetermined operations, further comprising selecting said action in an action library based on requests from said action manager, and invoking said selected action based on a request from said auto trigger manager.

69. The computer program product of claim 56, wherein said business rules are classified based on at least one of a term, a fact, a mandatory constraint, an action enabler, a computation and an inference, to provide an intelligent decision system for said system.

70. The computer program product of claim 56, wherein said exception data is generated by extracting raw data related to external supply chain information, said categorization manager processing a version of said raw data, and said resolution manager generating exception data.

71. The computer program product of claim 54, said computer readable medium bearing said software instructions to further perform said predetermined operations, further comprising:
(d) resolving supply problems in an assurance of supply (AOS) agent;
(e) improving flexibility and supply of a back-end supply chain by using a response agent;
(f) ensuring proper pricing of purchases and managing delivery of reduction objectives via a cost agent;
(g) in a quality agent, generating an alert replenishes supply when a prescribed lower quality threshold has been reached; and
(h) using a session agent, responding to a response from interacting parties based on said action when said exception is being processed by said system, wherein a self-learning agent correlates statistical data with a plurality of business rules to refine said at least one indicator in accordance with a change in said exception.

72. The computer program product of claim 56, wherein said action comprises one of a primary action that affects supply quantity, and a secondary action that does not directly impact supply quantity.

73. The computer program product of claim 56, wherein said action comprises integrating at least one of a sale and a purchase of said good in a business to business (B2B) portal.

74. The computer program product of claim 54, said computer readable medium bearing said software instructions to further perform said predetermined operations, further comprising channeling said interactive output through an application interface module to deliver at least one transactional output.

75. The computer program product of claim 58, wherein said initiation signal is raw data and said external source is an Enterprise Resource Planning (ERP) system.

76 A system for managing a supply of a good based on a request for said good, comprising:
means for evaluating said request against a plurality of indicators and determining whether said request involves an exception that is indicative of a procurement problem in accordance with exception data; and
means for receiving said determination from said decision support module, triggering an action that is configured to resolve said exception and generating an interactive messaging means to an external entity,
wherein said exception is incorporated into said exception data if said exception is of a new type, and said exception data is modified if said exception is not of said new type and has changed, to adjust said exception data in real-time.

77. The system of claim 76, said means for evaluating comprising:
means for generating an output that is sent to a data processing means for storing first, second and third types of data, in accordance with said request;
means for generating a categorization output that identifies said good based on a category of exception by categorizing said good in accordance with at least one of said indicators that comprise a plurality of procurement rules, and further based on said first type of data received from said data processing means; and
means for determining whether said exception is of said new type, and if said exception is of said new type, identifying said exception category for addition to said data processing means, based on said categorization output received from said means for generating said categorization output and said second and third types of data, wherein said means for determining generates first and second determination result outputs.

78. The system of claim 77, said execution module comprising:
means for generating an action to be taken in response to said first determination result output and said third data output, in accordance with said plurality of procurement rules and said exception category, an action to be taken;
means for generating said interactive messaging means in accordance with said second and third types of data;
means for determining the implications of said action performed in response to said exception, in accordance with a subset of said procurement rules that define at least one tolerance band specific to said execution category, said means for determining said implications generating an output indicative of whether said message is within said at least one tolerance band;
means for monitoring said action in relation to said exception and determining whether a resolution action is required, and outputting an auto close message; and
means for indicating one of: (a) automatic management resolution, (b) manual management resolution and (c) automatic management non-resolution of said exception event, in accordance with said auto close message, wherein said data processing means is updated in accordance with said automatic management resolution of said exception, and said means for generating said action is reactivated for additional processing when said automatic management non-resolution or a manual management non-resolution occurs.

79. The system of claim 78, wherein said means for determining whether said exception is of said new type receives an input that comprises an identified event and a corrective action, and identifies said corrective action for storage in said data processing subsystem.

80. The system of claim 76, wherein said at least one of said indicators can be modified based on at least one of a category of said good and at least one an external factor.

81. The system of claim 76, wherein if said exception is in said exception data, said at least one corrective action is taken immediately.

82. The system of claim 76, wherein said plurality of indicators can be reassessed based on a response from said external entity.

83. The system of claim 76, wherein a plurality of indicators are applied in said means for evaluating said request across a plurality of time periods to perform said evaluation.

84. The system of claim 76, wherein said evaluation performed by said decision support module has qualitative and quantitative components.

85. The system of claim 84, wherein said qualitative component comprises at least one of: (a) a historical support level of a supplier; (b) market supply conditions; (c) a result of an analysis of relative buyer power and seller power, and (d) an analysis of the relationship between individuals in at least one of said buying organization and said selling organization.

86. The system of claim 76, wherein said plurality of indicators are used to categorize a procurement environment, analyze relevant conditions and assign risk.

87. The system of claim 86, wherein said assigned risk is handled by selecting said action by evaluating said indicators based on past, current and future time period analysis.

88. The system of claim 76, wherein said exception comprises at least one of excess supply, poor responses, inaccurate pricing, shortage of supply and shortage due to a quality failure.

89. The system of claim 76, wherein said corrective action is performed one of sequentially and simultaneously.

90. The system of claim 78, wherein after said request, said means for generating said output loads said procurement rules, initializes said means for generating said categorization output and said means for determining whether said exception is of said new type, and calculates agent-specific key performance indicators (KPIs), and after said determination that said request is said exception, initializes said means for generating said action, and prevents reporting of said exception if said means for generating said action indicates that no action corresponds to said exception.

91. The system of claim 90, wherein said means for generating said categorization output applies said KPIs to generate said categorization.

92. The system of claim 78, wherein said means for determining whether said exception is of said new type monitors said request for relevance and consistency when said request is not of said new type.

93. The system of claim 78, further comprising means for selecting said action based on requests from said means for generating said action, and invoking said selected action based on a request from said means for generating said interactive messaging means.

94. The system of claim 78, wherein said business rules are classified based on at least one of a term, a fact, a mandatory constraint, an action enabler, a computation and an inference, to provide an intelligent decision system for said system.

95. The system of claim 78, wherein said exception data comprises (a) extracted raw data related to external supply chain information, (b) a processed version of said raw data as processed by said means for generating said categorization output, and (c) exception event data generated by said means for indicating.

96. The system of claim 76, further comprising a management means that includes,
means for resolving supply problems;
means for improving flexibility and supply of a back-end supply chain;
means for ensuring proper pricing of purchases and manages delivery of reduction objectives;
means for generating an alert replenishes supply when a prescribed lower quality threshold has been reached; and
means for responding to a response from interacting parties based on said action when said exception is being processed by said system, wherein a self-learning means correlates statistical data with a plurality of business rules to refine said at least one indicator in accordance with a change in said exception.

97. The system of claim 78, wherein said action comprises one of a primary action that affects supply quantity, and a secondary action that does not directly impact supply quantity.

98. The system of claim 78, wherein said action comprises integrating at least one of a sale and a purchase of said good in a business to business (B2B) portal.

99. The system of claim 78, wherein said interactive output is channeled through a means for interfacing with a user to deliver at least one transactional output.

100. The system of claim 99, wherein said at least one transaction output comprises a post B2B purchase request.

101. The system of claim 1, further comprising a message formatting component configured to map actions generated with said interactive output that comprises a B2B compliant process message.

102. The system of claim 101, further comprising a listener that enables the system to translate and interpret an incoming message.
